(19) United States
(12) Patent Application Publication
(10) Pub. No.: US 2021/0150423 A1
(43) Pub. Date: May 20, 2021

(54) RESOURCE RESERVATION SYSTEM AND INFORMATION DISPLAY METHOD

(71) Applicants: Ryoh TOMOSUGI, Kanagawa (JP); Ryuichi SAITO, Tokyo (JP); Natsumi FUJIMURA, Kanagawa (JP)

(72) Inventors: Ryoh TOMOSUGI, Kanagawa (JP); Ryuichi SAITO, Tokyo (JP); Natsumi FUJIMURA, Kanagawa (JP)

(73) Assignee: Ricoh Company, Ltd., Tokyo (JP)

(21) Appl. No.: 17/095,968

(22) Filed: Nov. 12, 2020

(30) Foreign Application Priority Data
Nov. 18, 2019 (JP) 2019-208226
Jun. 9, 2020 (JP) 2020-100326

(51) Int. Cl. G06Q 10/02; G06Q 10/06; G06K 7/10; G06K 19/06; G06F 21/44

(52) U.S. Cl. CPC G06Q 10/02; G06Q 10/06315; G06Q 10/1095; G06K 19/06112; G06F 21/44; G06K 7/1095

(57) ABSTRACT

A resource reservation system includes an information processing apparatus configured to retain reservation information of resources, and an information processing terminal. The information processing terminal includes a memory and a processor coupled to the memory and configured to receive reservation information of one or more resources among the resources from the information processing apparatus, display the reservation information of the one or more resources, and receive an operation for each of the one or more resources.

### CROSS-REFERENCE TO RELATED APPLICATIONS

The present application claims priority under 35 U.S.C. § 119 to Japanese Patent Application No. 2019-208226, filed on Nov. 18, 2019, and Japanese Patent Application No. 2020-100326, filed on Jun. 9, 2020, the entire contents of which are incorporated herein by reference.

### BACKGROUND OF THE INVENTION

### 1. Field of the Invention

The disclosures herein relate to a resource reservation system and an information display method.

### 2. Description of the Related Art

A technique for causing an information processing terminal installed in a meeting room (hereinafter may be referred to as a “resource”) to display information related to reservations for the meeting room is known. When a user starts using the meeting room, the user performs an operation to start using the meeting room on the information processing terminal, and when the user finishes using the meeting room, the user performs an operation to finish using the meeting room on the information processing terminal.

A technique that utilizes such an information processing terminal to collect information is devised (see Patent Document 1, for example). Patent Document 1 describes an information processing terminal that conducts a questionnaire survey on meetings held in a reserved meeting room.

However, in the related-art, one information processing terminal is required for one resource. For example, if there are a large number of meeting rooms and one information processing terminal is required for one meeting room, there may be inconveniences such as insufficient power supplies, insufficient connection interfaces for a local area network (LAN), an increase in cost, or difficulties in securing installation locations.

### RELATED-ART DOCUMENTS

### Patent Documents

### Patent Document 1: Japanese Unexamined Patent Application Publication No. 2018-190414

### SUMMARY OF THE INVENTION

It is a general object of the described embodiments to provide a resource reservation system that provides an information processing terminal shared by a plurality of resources.

According to at least one embodiment, a resource reservation system includes an information processing apparatus configured to retain reservation information of resources, and an information processing terminal. The information processing terminal includes a memory and a processor coupled to the memory and configured to receive reservation information of one or more resources among the resources from the information processing apparatus, display the reservation information of the one or more resources, and receive an operation for each of the one or more resources.

### BRIEF DESCRIPTION OF THE DRAWINGS

Other objects and further features of the present invention will be apparent from the following detailed description when read in conjunction with the accompanying drawings, in which:

FIG. 1 is a diagram illustrating an overview of the operation of a resource reservation system;

FIG. 2 is a diagram illustrating an example of the arrangement of a plurality of meeting rooms and a reception terminal;

FIG. 3 is a diagram illustrating an overview of the initial settings for the reception terminal using an image code;

FIG. 4 is a diagram illustrating an example of a system configuration of the resource reservation system;

FIG. 5 is a diagram illustrating an example of a hardware configuration of a meeting management server;

FIG. 6 is a diagram illustrating an example of a hardware configuration of the reception terminal;

FIG. 7 is a functional block diagram illustrating functions of a reservation management server, a chat server, the meeting management server, and a registration terminal;

FIG. 8 is a functional block diagram illustrating functions of a terminal apparatus, a meeting room terminal, and the reception terminal;

FIG. 9 is a functional block diagram illustrating functions of an initial setting unit;

FIG. 10 is a sequence diagram illustrating an example of a process for storing a group ID by the reception terminal;

FIG. 11 is a diagram illustrating an example of a login screen displayed by the registration terminal;

FIG. 12 is a diagram illustrating an example of an initial screen displayed by the registration terminal;

FIG. 13 is a diagram illustrating an example of a groups list screen displayed by the registration terminal;

FIG. 14 is a diagram illustrating an example of a new group creation screen displayed by the registration terminal;

FIG. 15 is a diagram illustrating an example of a meeting rooms list screen displayed by the registration terminal;

FIG. 16 is a diagram illustrating an example of a group registration confirmation screen displayed by the registration terminal;

FIG. 17 is a diagram illustrating an example of a groups list screen displayed by the registration terminal;

FIGS. 18A and 18B are diagrams illustrating examples of image code display screens displayed by the registration terminal;

FIG. 19 is a diagram illustrating an example of a startup screen displayed by the reception terminal;

FIG. 20 is a diagram illustrating an example of a group settings screen displayed by the reception terminal;

FIG. 21 is a diagram illustrating an example of a standby screen displayed by the reception terminal;

FIG. 22 is a diagram illustrating an example of the standby screen on which a meeting identification information input field is displayed;

FIG. 23 is a diagram illustrating an example of the standby screen on which the status of a meeting room is changed to “in use”;

FIG. 24 is a diagram illustrating an example of the standby screen displayed when a “use now” button of a vacant meeting room is pressed;

FIG. 25 is a diagram illustrating an example of a confirmation screen displayed when a “leave” button is pressed;

FIG. 26 is a diagram illustrating an example of the confirmation screen on which a meeting identification information input screen is displayed;

FIG. 27 is a diagram illustrating an example of the standby screen after a leaving process is performed;

FIG. 28 is a sequence diagram illustrating an example of a process for storing a group ID by the reception terminal;

FIG. 29 is a diagram illustrating an example of an URL display screen displayed by the registration terminal;

FIG. 30 is a diagram illustrating an example of a URL input screen displayed by the reception terminal;

FIG. 31 is a functional block diagram illustrating functions of the terminal apparatus, the meeting room terminal, and the reception terminal;

FIG. 32 is a sequence diagram illustrating an example of a process for storing one or more meeting room IDs by the reception terminal;

FIG. 33 is a diagram illustrating an example of a meeting rooms list screen displayed by the registration terminal;

FIGS. 34A and 34B are diagrams illustrating examples of image code display screens displayed by the registration terminal;

FIG. 35 is a diagram illustrating an example of a startup screen displayed by the reception terminal;

FIG. 36 is a diagram illustrating an example of a standby screen displayed by the reception terminal;

FIG. 37 is a flowchart illustrating an example of a process for storing a meeting room ID by the reception terminal;

FIG. 38 is a diagram illustrating an example of the meeting rooms list screen;

FIG. 39 is a diagram illustrating an example of a bulk edit screen;

FIG. 40 is a diagram illustrating an example of the standby screen;

FIG. 41 is a sequence diagram illustrating an example of a process for storing one or more meeting room IDs by the reception terminal;

FIG. 42 is a functional block diagram illustrating functions of the terminal apparatus, the meeting room terminal, and the reception terminal (third embodiment);

FIG. 43 is a sequence diagram illustrating an example of a process for storing a group ID by the reception terminal;

FIG. 44 is a diagram illustrating an example of an image code display screen displayed by a web browser;

FIG. 45 is a sequence diagram illustrating a process for storing a group ID by the reception terminal;

FIG. 46 is a diagram illustrating an example of a download screen displayed by the web browser;

FIG. 47 is a functional block diagram illustrating functions of the terminal apparatus, the meeting room terminal, and the reception terminal (fourth embodiment); and

FIG. 48 is a sequence diagram illustrating a process for storing a group ID and displaying reservation information by the reception terminal.

### DESCRIPTION OF THE EMBODIMENTS

According to at least one embodiment, a resource reservation system that provides an information processing terminal shared by a plurality of resources can be provided.

In the following, a resource reservation system and an information display method performed by the resource reservation system according to embodiments will be described with reference to the accompanying drawings.

### <Overview of Resource Reservation System>

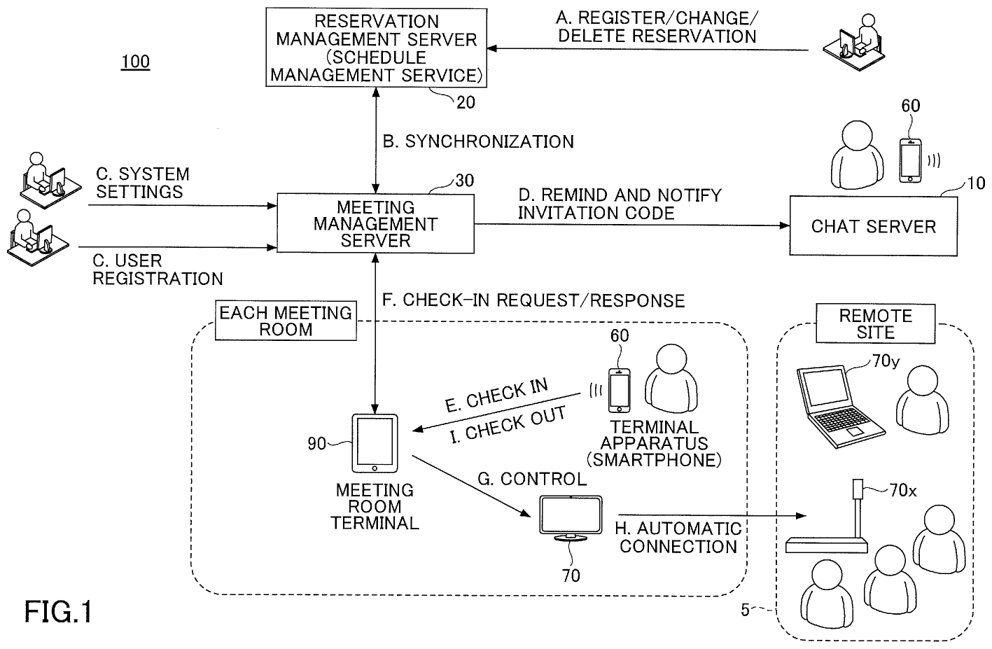

First, an overview of a resource reservation system 100 will be described with reference to FIG. 1. FIG. 1 is a diagram illustrating an overview of the operation of the resource reservation system 100.

A. A user, who wishes to reserve a meeting room, operates his/her terminal apparatus 60 to communicate with a reservation management server 20 and reserve the meeting room. The reservation management server 20 is a general-purpose cloud service (such as Office 365 (registered trademark) or G Suite (registered trademark)). In the reservation management server 20, meeting rooms of an organization such as a company to which the user who made the reservation belongs are registered.

B. A meeting management server 30 is a server that controls the entire resource reservation system 100 based on the reservation status of a meeting room. The meeting management server 30 communicates with the reservation management server 20 as appropriate to acquire reservation information. Thus, the reservation information is synchronized with the reservation management server 20.

C. The resource reservation system 100 or an administrator on the organization side can register users and perform various settings for the meeting management server 30. User registration means the registration of a user who receives a notification from a chat server 10 (such as slack, Line, or Microsoft Teams, which are all registered trademarks). In addition, since the notification is made via a bot that transmits a message as the meeting management server 30, the bot provided by the chat server 10 is also registered. Examples of the various settings include the registration (initial settings as will be described below) of a meeting room terminal 90 and timing settings for reminders.

D. When the current time is a predetermined time before the start time of a meeting defined in reservation information, the meeting management server 30 sends a reminder of the scheduled meeting to the user who made the reservation. Accordingly, the number of meeting rooms that have been reserved but are not actually used can be reduced. In addition, the meeting management server 30 notifies the user of an invitation code as necessary. In response to receiving the reminder, the user who made the reservation stores information (meeting identification information) for checking in to a meeting room in the terminal apparatus 60. The “check-in” refers to the start of use of a meeting room.

E. In each meeting room, a meeting room terminal 90 is provided (in the following embodiments, a meeting room terminal 90 is not necessarily installed in each meeting room), and the meeting room terminal 90 regularly downloads reservation information for a meeting held in a corresponding meeting room. The meeting room terminal 90 can display a schedule of a meeting on that day or a most recent meeting, and allow a meeting participant to check the schedule. Shortly before the start time of the meeting, the user who made the reservation enters the corresponding meeting room and checks in. For example, meeting identification information is input into the meeting room terminal 90, or the terminal apparatus 60 is held over the meeting room terminal 90 (such that the meeting identification information is read or communicated).

F. The meeting room terminal 90 transmits a check-in request to the meeting management server 30. Thus, when the meeting identification information is authenticated, the meeting room terminal 90 receives a response, from the meeting management server 30, indicating that the check-in has been completed. The meeting room terminal 90 displays that the meeting room is in use (the meeting is being held). If the check-in is not confirmed by a predetermined time before the start time of the meeting, the meeting management server 30 cancels the reservation of the meeting room (cancels the reservation information when the use of the meeting room is not started by the predetermined time), and indicates the cancellation of the meeting room to the meeting room terminal 90 as a status included in the reservation information. In this case, the meeting room terminal 90 displays that the meeting room is vacant, and thus any user can use the meeting room.

G. The meeting room terminal 90 controls an electronic device 70 in response to a request from the meeting management server 30. For example, the electronic device 70 is turned on at the start time of the meeting and turned off at the end time of the meeting. In this way, the operation of the electronic device 70 by a meeting participant can be facilitated.

H. If the electronic device 70 includes a teleconference function, for example, the electronic device 70 can communicate with an electronic device (such as a teleconference terminal 70x) at a remote site 5 and have the meeting with the remote site. A personal computer (PC) 70y, on which an application runs, can also communicate with the electronic device 70. Destination information (a communication ID of a destination) indicating the remote site 5 is included in the reservation information in advance, and the electronic device 70 can automatically communicate with the teleconference terminal 70x and the PC 70y.

I. When the user who made the reservation ends the meeting, the user presses a button on the meeting room terminal 90 to check out. The meeting room terminal 90 displays the next reservation status, thereby allowing any user to check the reservation status of the meeting room.

### First Embodiment

<When there are Plurality of Meeting Rooms>

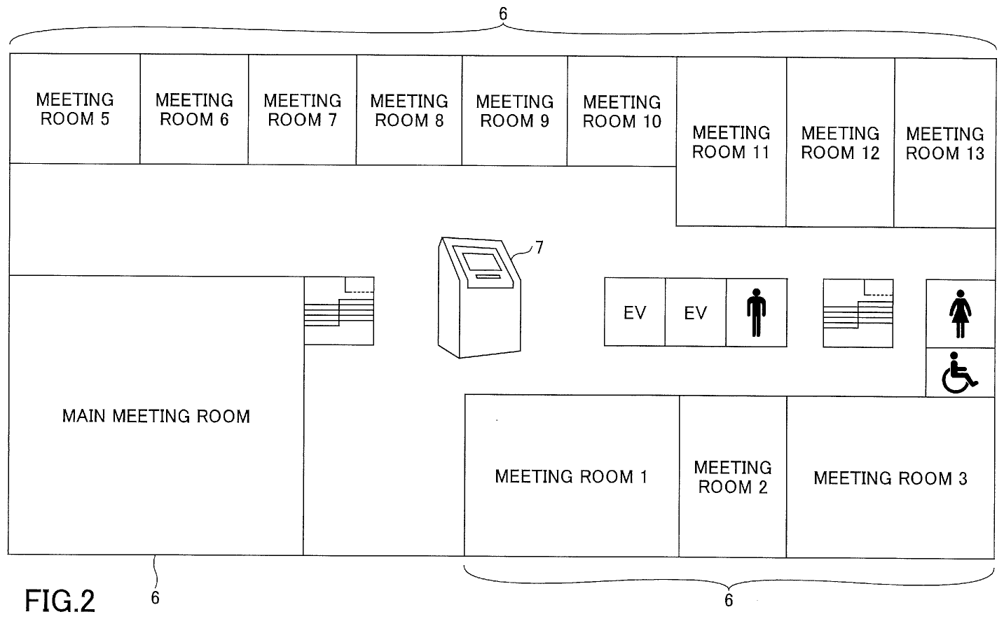

FIG. 2 is a diagram illustrating an example of the arrangement of a plurality of meeting rooms 6 and a reception terminal 7. As illustrated in FIG. 2, if the plurality of meeting rooms 6 are located near each other, it may be difficult to install a meeting room terminal 90 at the entrance of each of the meeting rooms 6 due to insufficient power supplies, insufficient connection interfaces for a LAN, an increase in cost, or difficulties in securing installation locations.

In view of the above, in the present embodiment, the reception terminal 7 shared by the plurality of meeting rooms 6 is provided as illustrated in FIG. 2. The one reception terminal 7 is shared by the one or more meeting rooms 6. There is no upper limit on the number of meeting rooms 6 that share the reception terminal 7. In the example of FIG. 2, the one reception terminal 7 can receive operations for starting to use fourteen meeting rooms 6. Accordingly, the reception terminal 7 shared by the plurality of meeting rooms 6 can be provided. In addition to solving the above-described inconveniences, users can operate the same reception terminal 7 regardless of which meeting rooms are used.

Similar to the meeting room terminal 90 illustrated in FIG. 1, the reception terminal 7 displays reservation information of respective meeting rooms, and receives check-in operations and check-out operations for the respective meeting rooms (that is, operations to start/finish using the meeting rooms). In addition, the reception terminal 7 can receive an “extend” operation or a “use now” operation, which will be described later. Further, initial settings are configured for the reception terminal 7 such that the reception terminal 7 receives check-in operations and check-out operations for a group of meeting rooms 6, as will be described later.

In FIG. 2, only a single reception terminal 7 is provided, but a plurality of reception terminals 7 may be provided. If the plurality of reception terminals 7 are provided, any of the plurality of reception terminals 7 can be used to check in to or check out of a meeting room 6. For example, if the floor is large, the user can operate a nearby reception terminal 7 to check in or check out.

The appearance of the reception terminal 7 is merely an example. The reception terminal 7 may be a large display, an electronic whiteboard, or a projector. If the reception terminal 7 is a projector, a laser pointer may be used to receive an input.

### <Initial Settings for Reception Terminal>

The reception terminal 7 may be a terminal dedicated to the resource reservation system 100 of the present embodiment, or may be a general-purpose information processing terminal implemented by executing an application. In the resource reservation system 100 in which a dedicated reception terminal is provided, the initial settings for the dedicated reception terminal are configured at the time of shipment. Therefore, no initial settings are required or only the minimum settings are required by the administrator. However, the dedicated reception terminal is unable to be used for other purposes.

Recently, the bring your own device (BYOD) approach has been adopted. By allowing users to use their own smart devices as reception terminals 7, the resource reservation system 100 can be implemented at reduced cost. In light of the above, in the following embodiments, the resource reservation system 100 will be described, in which the reception terminal 7 captures image data such as an image code (e.g., a QR code (registered trademark)) to complete the initial settings.

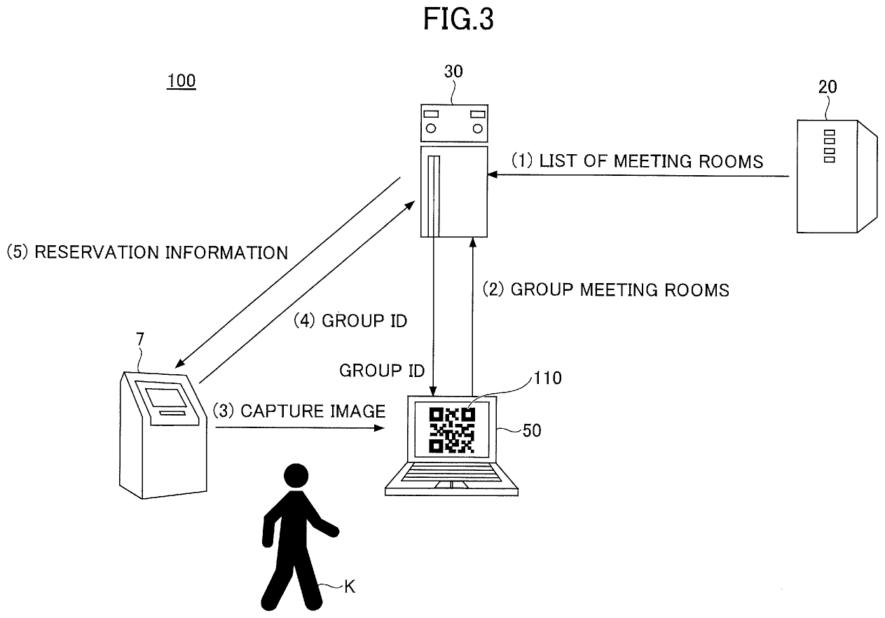

FIG. 3 is a diagram illustrating an overview of the initial settings for the reception terminal 7 using an image code.

(1) A provider of the resource reservation system 100 register meeting rooms of a customer in the reservation management server 20 in advance. The reservation management server 20 receives reservations of the registered meeting rooms from users, and retains reservation information. The meeting management server 30 receives the list of meeting rooms from the reservation management server 20 to communicate with the reservation management server 20. Further, the management server 30 receives newly registered or updated reservation information on a per meeting room basis.

(2) As one of the initial settings for the reception terminal 7, an administrator K groups meeting rooms together. First, the administrator K operates a registration terminal 50 to display a list of meeting rooms received from the meeting management server 30, and selects meeting rooms to be grouped together. Note that the administrator K may select one meeting room. The “group” refers to one or more meeting rooms that are gathered together. The meeting management server 30 assigns a group ID to the group, and transmits the group ID to the registration terminal 50. The group ID is identification information of the group. The group ID may be transmitted in the form of an image code, or may be transmitted in the form of a URL, as will be described later. The initial settings for the reception terminal 7 may include some other settings. For example, the initial settings include storing the group ID by the reception terminal 7.

(3) The administrator K operates the reception terminal 7 to capture an image code 110 displayed on the registration terminal 50. A reception application is installed on the reception terminal 7, and the reception terminal 7 decodes the image code 110 to acquire the group ID. In addition, the reception terminal 7 stores the group ID.

(4) The registration terminal 50 transmits the group ID to the meeting management server 30 in order to acquire reservation information of the meeting rooms 6 belonging to this group.

(5) The meeting management server 30 transmits reservation information of the meeting rooms 6 identified by the group ID to the reception terminal 7. The reception terminal 7 displays the reservation information of the meeting rooms 6 belonging to the group. In this manner, the one reception terminal 7 can display the reservation information of the plurality of meeting rooms 6. The reception terminal 7 periodically transmits the group ID to the meeting management server 30, and repeatedly acquires and displays the latest reservation information. Further, the reception terminal 7 receives a check-in operation and a check-out operation for each meeting room.

Accordingly, in the present embodiment, the resource reservation system 100 can use a general-purpose information processing terminal as the reception terminal 7. Further, the administrator can readily configure the initial settings by using an image code. Further, the reception terminal 7 can display reservation information of a plurality of meeting rooms, and users can use the one reception terminal 7 to check in to and check out of the meeting rooms.

### Terms

The term “resource” as used herein refers to a resource such as a meeting room, or equipment, a device, a person (receptionist), or a mechanism that can be used in the meeting room. From among the resources, a resource that is difficult to be moved is referred to as a “facility”. In the present embodiment, for convenience of description, the term “meeting room” is used as an example of the resource.

The term “initial settings” as used herein refers to any settings configured by a person to allow a device to provide at least minimum functions. For example, the initial settings may include communication settings. Information required for communication is set at the time of initial settings.

A user who makes a reservation is a user who reserves a meeting room. Participants are people who participate in a meeting. The user who made the reservation is often included in participants, but is not necessarily included in the participants. In the present embodiment, work performed by the user who made the reservation may be performed by a participant. All persons who use the meeting room are simply referred to as users.

In order for the meeting room terminal 90 to start to communicate with the meeting management server 30, the administrator is required to configure the initial settings and store communication setting information in the meeting room terminal 90. In addition, the reception terminal 7 is required to store a group ID. Then, the meeting room terminal 90 starts to request reservation information periodically. However, whether the meeting room terminal 90 can acquire the requested reservation information depends on the settings for the meeting management server 30.

When a management start flag of a meeting room, which will be described later, of the meeting management server 30 is set to “true”, the meeting management server 30 is ready to manage the meeting room. In response to receiving a request for reservation information from the meeting room terminal 90 or the reception terminal 7 with the management start flag being set to “true”, the meeting management server 30 starts to manage the meeting room. Then, the meeting management server 30 starts to transmit reservation information to the meeting room terminal 90 or the reception terminal 7 when the meeting room terminal 90 or the reception terminal 7 requests the reservation information.

The meeting room terminal 90 or the reception terminal 7 starts to work with the meeting management server 30 in response to acquiring the reservation information from the meeting management server 30. Accordingly, when the meeting room terminal 90 or the reception terminal 7 starts to work with the meeting management server 30 or the meeting management server 30 starts management, the following processes are performed.
Displaying reservation information (“check in”, “check out”, “extend”, and “use now”)
Controlling an electronic device associated with a check-in and a check-out
Automatic cancellation of a reservation

The “extend” refers to extending a reservation beyond the end time of the reservation of the meeting room. The “use now” refers to using a vacant meeting room by any user without a reservation.

The meeting room terminal 90 or the reception terminal 7 can receive a user's operation after displaying reservation information. Screens on which to receive operations are automatically switched depending on the situation of a meeting room. As described above, the meeting room terminal 90 or the reception terminal 7 receives operations such as “check in”, “check out”, “extend”, and “use now”.

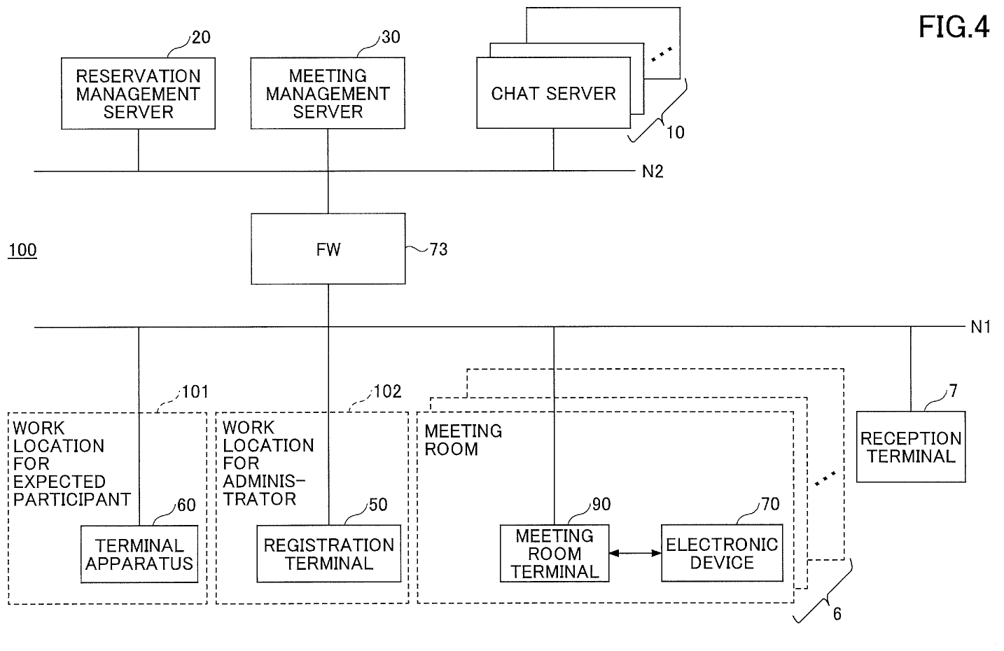

FIG. 4 is a diagram illustrating an example of a system configuration of the resource reservation system 100. The resource reservation system 100 can be mainly divided into an external network N2 and an internal network N1. The internal network N1 refers to a network inside a firewall 73. The external network N2 is a network such as the Internet, through which an unspecified number of communications are transmitted.

The reservation management server 20, the meeting management server 30, and one or more chat servers 10 are communicably connected to the external network N2. Further, the terminal apparatus 60 operated by a meeting participant may be connected to the external network N2 as necessary.

The reservation management server 20 is implemented by one or more information processing apparatuses (computer systems) each including a general-purpose server operating system (OS). A system for reservations for facilities provided by the reservation management server 20 is referred to as a reservation management system. The reservation management server 20 includes a calendar system and provides a web application that manages various schedules. Specifically, the web application provides the following functions.
Receiving schedule registration, and allowing a user who made a reservation to confirm the reservation anywhere at any time;
Sending a notification by email at a set date and time, such as 30 minutes before the schedule;
Allowing one person to manage schedules with multiple calendars (for business, for private, and the like);
Sharing calendars with people in the same group

The reservation management server 20 manages a user with an account. The account is the right that the user uses a service. In many systems, the user uses the account to log in to the systems. For this reason, the account includes a function (identification information function) that allows the systems to uniquely identify the user. In the present embodiment, the reservation management server 20 transmits reservation information of a preregistered account (domain) to the meeting management server 30. Alternatively, the meeting management server 30 can request reservation information by specifying the account of the reservation management server 20, thereby acquiring the reservation information of a meeting room 6 from the reservation management server 20. Note that the account may be any information that can uniquely identify the user, such as an email, an ID, or a telephone number.

In the present embodiment, reservations for meeting rooms 6 are managed as schedules; however, the present embodiment is not limited thereto, and the reservation management server 20 can manage various schedules. In addition to the meeting rooms 6, the reservation management server 20 can be used to reserve various facilities, such as various rental electronic devices, parking lots, rental offices, rental studios, rental cycles, rental cars, accommodation facilities such as hotels, and rental spaces such event venues and lockers.

Examples of the reservation management server 20 include G Suite (registered trademark) and Office 365 (registered trademark). However, any reservation management system including the functions described in the present embodiment may be used.

In addition, in the present embodiment, information on the meeting rooms 6 within the internal network N1 is preregistered in the reservation management server 20. That is, the web application of the reservation management server 20 is customized according to the meeting room name, the meeting room ID, the available reservation time, the capacity, and the reservation unit of each of the meeting rooms 6 in the internal network of the company that uses the resource reservation system 100. Therefore, reservation information is associated with a corresponding meeting room 6 of the company that uses the resource reservation system 100.

The chat server 10 may be implemented by one or more information processing apparatuses (computer systems) each including a general-purpose server OS. A real-time system that shares information such as text, voice, and video of a plurality of users provided by the chat server 10 is referred to as a chat system. The chat server 10 indicates information related to a meeting room 6 to the terminal apparatus 60. In the present embodiment, a plurality of chat servers 10 operated by different entities may be included.

The information shared in the chat system is not limited to texts, and includes images and voices. In the present embodiment, for convenience of description, it is assumed that a text is mainly used for notification. For example, the chat system may provide a voice call function between groups. A voice call may be a one-to-one voice call or a one-to-N voice call (N≥2). Therefore, in the present embodiment, the chat system may indicate information related to a meeting room 6 by outputting a voice message, instead of displaying a text. Examples of the chat system include LINE (registered trademark), Slack (registered trademark), and Microsoft Teams (registered trademark; hereinafter omitted). However, any chat system that can notify one or more users using a bot (a program that executes a predetermined process) may be used.

The chat server 10 also manages a user with an account (that is different from the account of the reservation management server 20). The meeting management server 30 basically does not need to recognize the account of the chat server 10. However, the meeting management server 30 can specify an account of the chat server 10 to send a notification.

The meeting management server 30 may be implemented by one or more information processing apparatuses (computer systems) each including a general-purpose server OS. As a process relating to the external network N2, the meeting management server 30 acquires reservation information of each of the meeting rooms 6 from the reservation management server 20. Further, the meeting management server 30 acquires expected participants set in the reservation information, and transmits a notification to a group (or an individual user such as a user who made a reservation), in the chat server 10, associated with the acquired expected participants at a preset time. In addition, as a process relating to the internal network N1, a check-in to and a check-out from each of the meeting rooms 6 are managed, and a power supply of the electronic device 70 is controlled on the basis of the reservation information of each of the meeting room 6 acquired from the reservation management server 20.

The meeting rooms 6, a work location 101 for expected participants, and a work location 102 for an administrator are located in the internal network N1. The expected participants can access the external network N2 from various sites via the internal network N1. For example, the internal network N1 may be a local area network (LAN). Note that the meeting rooms 6, the work location 101 for the expected participants, and the work location 102 for the administrator are not necessarily located in a LAN in the same company.

A meeting room terminal 90 and an electronic device 70 are installed in a corresponding meeting room 6. The meeting room terminal 90 and the electronic device 70 may communicate with each other via a small LAN or a dedicated line. The electronic device 70 may be connected to the internal network N1 and the external network N2 without going through the meeting room terminal 90. The meeting room terminal 90 and the electronic device 70 may communicate with each other in a wireless manner or in a wired manner. Because the internal network N1 is located inside the firewall 73, direct communication from the external network N2 to the internal network N1 is difficult.

The meeting room terminal 90 is an information processing apparatus (a facility terminal) operated by a meeting participant such as a user who reserved the meeting room 6. For example, the meeting room terminal 90 may be provided on a desk in the meeting room 6 or provided at an entrance of the meeting room 6. A plurality of meeting room terminals 90 may be provided in the one meeting room 6. The meeting room terminal 90 is implemented by one or more information processing apparatuses (computer systems) each including a general-purpose OS.

For example, the meeting room terminal 90 transmits the meeting room ID of the meeting room 6 to the meeting management server 30, and displays reservation information of the meeting room 6 on that day. In addition, the meeting room terminal 90 acquires control information such as turning on or off of the electronic device 70 from the meeting management server 30. The meeting room terminal 90 turns on or off the electronic device 70 using the acquired control information.

The meeting room terminal 90 displays a standby screen for check-in and check-out. Further, the meeting room terminal 90 communicates with the meeting management server 30 and indicates a check-in and a check-out to the meeting management server 30. At check-in, the meeting room terminal 90 transmits, to the meeting management server 30, meeting identification information that is input by a user who made a reservation together with the meeting room ID that is set for the meeting room terminal 90. Based on the meeting identification information and the meeting room ID transmitted from the meeting room terminal 90, the meeting management server 30 can confirm that the user who made the reservation for the meeting room 6 uses the reserved meeting room 6.

The electronic device 70 may be any type of office equipment that can be used in the meeting room 6. Examples of the electronic device 70 include an electronic whiteboard, a multifunction peripheral, a projector, digital signage, and a digital camera. The electronic whiteboard includes a large-sized display with a touch panel, detects the coordinates of a position on the panel indicated by the user, and connects the coordinates to display a stroke. In addition, the electronic whiteboard can display an image of a connected PC and communicate with another electronic whiteboard at a remote site to synchronize the stroke. The electronic whiteboard may be sometimes referred to as an electronic information board or an electronic blackboard.

The multifunction peripheral includes functions such as a copier, a scanner, a printer, and facsimile transmission/reception, and is used to print materials, copy materials, digitize materials, and transmit materials during a meeting. The projector is an apparatus that projects images. For example, the terminal apparatus 60 projects an image onto a screen, thereby allowing participants to share the projected image. The digital signage is a large display and is used to display any still image or video. The digital camera is used by each participant to capture and store a paper material and a material displayed on the electronic whiteboard.

The reception terminal 7 is connected to the internal network N1. The reception terminal 7 is shared by one or more meeting rooms. A plurality of reception terminals 7 may be connected to the internal network N1. The functions of the reception terminal 7 may be similar to the functions of the meeting room terminal 90. That is, the reception terminal 7 displays reservation information and receives check-ins and check-outs.

The terminal apparatus 60 that can be connected to the internal network N1 is installed in the work location 101 for an expected participant. The terminal apparatus 60 may perform wired communication or wireless communication. The terminal apparatus 60 is an information processing apparatus used by an expected participant (such as a user who makes a reservation) to reserve a meeting room. However, it is also assumed that the expected participant may bring the terminal apparatus 60 to the meeting room. In this case, the terminal apparatus 60 is an information processing apparatus carried by the expected participant.

The terminal apparatus 60 may be implemented by one or more information processing apparatuses (computer systems) each including a general-purpose OS. For example, the terminal apparatus 60 may be a smartphone, a tablet terminal, a personal computer (PC), a personal digital assistant (PDA), or a wearable device (eyeglasses type, wristwatch type, or the like). However, the terminal apparatus 60 may be any apparatus on which browser software having a communication function or application software dedicated to the chat server 10 or the reservation management server 20 can operate. For example, the terminal apparatus 60 may be a car navigation, a game console, or a television receiver.

Application software dedicated to the chat server 10 (hereinafter referred to as a chat application) operates on the terminal apparatus 60, and also application software dedicated to the resource reservation system 100 (hereinafter referred to as a meeting application) operates on the terminal apparatus 60. The above application software may be substituted with browser software.

The registration terminal 50 that can be connected to the internal network N1 is installed in the work location 102 for the administrator. The registration terminal 50 may perform wired communication or wireless communication. The registration terminal 50 is a terminal used by the administrator to configure the initial settings for the meeting room terminal 90.

The registration terminal 50 may be an information processing apparatus similar to the terminal apparatus 60. However, because the registration terminal 50 is mainly used by the administrator to configure settings for the meeting room terminal 90, the registration terminal 50 is not required to use the chat application and the meeting application. The registration terminal 50 mainly uses browser software to communicate with the meeting management server 30.

### <Hardware Configuration>

### <<Hardware Configuration of Meeting Management Server>>

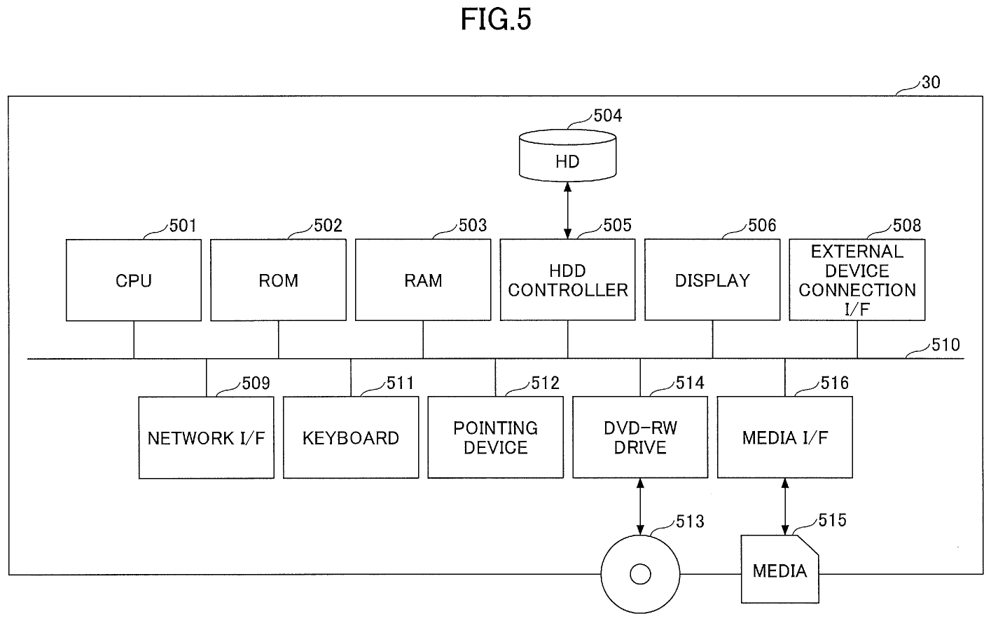

FIG. 5 is a diagram illustrating an example of a hardware configuration of the meeting management server 30. The meeting management server 30 is configured by a computer. As illustrated in FIG. 5, the meeting management server 30 includes a CPU 501, a read-only memory (ROM) 502, a random-access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, a digital versatile disk rewritable (DVD-RW) drive 514, and a media I/F 516.

The CPU 501 controls the overall operation of the meeting management server 30. The ROM 502 stores a program used to drive the CPU 501, such as an IPL. The RAM 503 is used as a work area for the CPU 501. The HD 504 stores various data such as a program. The HDD controller 505 controls reading and writing of various data from and to the HD 504 according to the control of the CPU 501. The display 506 displays various information such as cursors, menus, windows, characters, or images. The external device connection I/F 508 is an interface for connecting various external devices. In this case, the external device may be a universal serial bus (USB) memory or a printer. The network I/F 509 is an interface for performing data communication using a communication network. The bus line 510 is an address bus, a data bus, or the like for electrically connecting components such as the CPU 501 illustrated in FIG. 5.

The keyboard 511 is a type of an input unit having a plurality of keys for inputting characters, numbers, and various instructions. The pointing device 512 is a type of an input unit for selecting and executing various instructions, selecting a processing target, and moving a cursor. The DVD-RW drive 514 controls the reading and writing of various data from and to the DVD-RW 513, which is an example of a removable recording medium. The DVD-RW 513 is not limited to a DVD-RW, and may be a DVD-R. The media I/F 516 controls the reading and writing (storage) of data from and to a recording medium 515 such as a flash memory.

### <<Reception Terminal>>

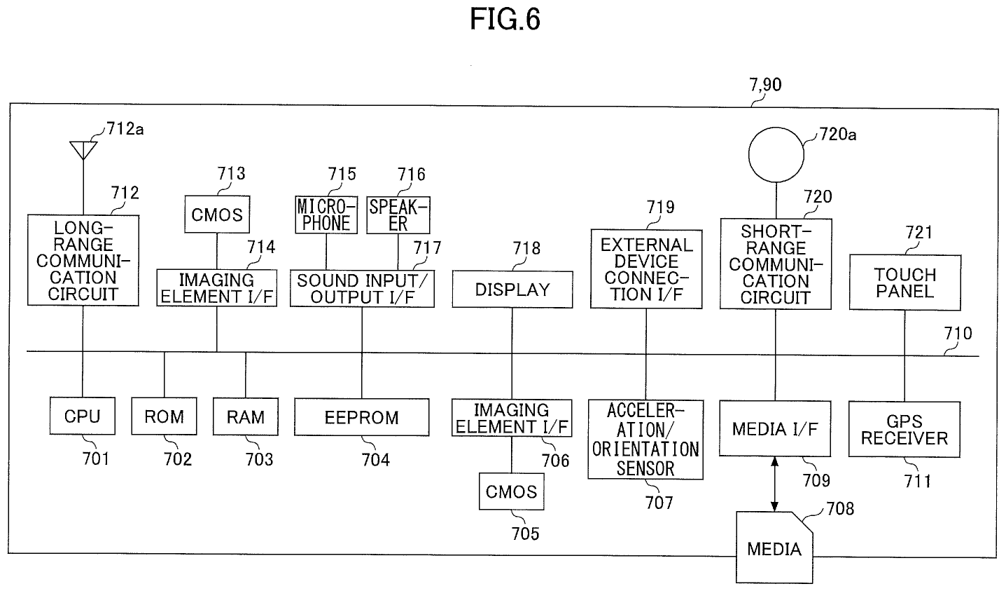

FIG. 6 is a diagram illustrating an example of a hardware configuration of the reception terminal 7. Note that the meeting room terminal 90 has a hardware configuration similar to that of FIG. 6. As illustrated in FIG. 6, the reception terminal 7 includes a CPU 701, a ROM 702, a RAM 703, an electrically erasable programmable read-only memory (EEPROM) 704, a complementary metal-oxide semiconductor (CMOS) sensor 705, an imaging element interface (I/F) 706, an acceleration/orientation sensor 707, a media I/F 709, and a GPS receiver 711.

The CPU 701 controls the overall operation of the reception terminal 7. The ROM 702 stores a program used to drive the CPU 701, such as an IPL. The RAM 703 is used as a work area for the CPU 701. The EEPROM 704 reads and writes various data such as applications according to the control of the CPU 701. The CMOS sensor 705 is a type of a built-in imaging unit that captures a subject (mainly an image of a user his/herself) according to the control of the CPU 701 to acquire image data. Note that the CMOS sensor 705 may be any other imaging unit such as a charge-coupled device (CCD) sensor, instead of a CMOS sensor. The imaging capturing element I/F 706 is a circuit that controls the driving of the CMOS sensor 705. The acceleration/orientation sensor 707 is a sensor that detects the geomagnetic field, such as an electromagnetic compass, a gyrocompass, or an acceleration sensor. The media I/F 709 controls the reading and writing (storage) of data from and to a recording media 708 such as a flash memory. The GPS receiver 711 receives a GPS signal from a GPS satellite.

Further, the reception terminal 7 includes a long-range communication circuit 712, a CMOS sensor 713, an imaging element I/F 714, a microphone 715, a speaker 716, a sound input/output I/F 717, a display 718, an external device connection I/F 719, a short-range communication circuit 720, an antenna 720a of the short-range communication circuit 720, and a touch panel 721.

The long-range communication circuit 712 is a circuit that communicates with other devices via a communication network. The CMOS sensor 713 is a type of a built-in imaging unit that captures a subject according to the control of the CPU 701 to acquire image data. The imaging element I/F 714 is a circuit that controls the driving of the CMOS sensor 713. The microphone 715 is a built-in circuit that converts sound to an electrical signal. The speaker 716 is a built-in circuit that converts an electrical signal into physical vibrations to produce sounds, such as music and voices. The sound input/output I/F 717 is a circuit that processes the input and output of a sound signal between the microphone 715 and the speaker 716 according to the control of the CPU 701. The display 718 is a type of a display unit such as a liquid crystal display or an organic electroluminescence (EL) display that displays an image or various icons of a subject. The external device connection I/F 719 is an interface for connecting various external devices. The short-range communication circuit 720 is a communication circuit such as near-field communication (NFC) or Bluetooth (registered trademark). The touch panel 721 is a type of an input unit for operating the reception terminal 7 by a user pressing the display 718.

In addition, the reception terminal 7 includes a bus line 710. The bus line 710 is an address bus, data bus, or the like for electrically connecting components such as the CPU 701 illustrated in FIG. 6.

### <Functions>

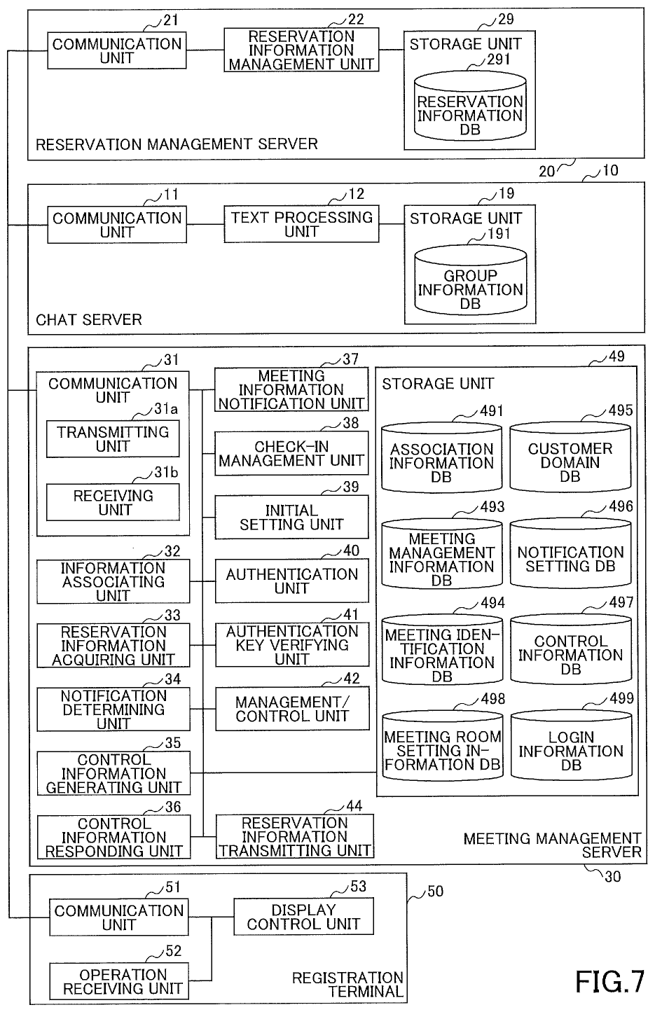

FIG. 7 is a functional block diagram illustrating functions of the reservation management server 20, the chat server 10, the meeting management server 30, and the registration terminal 50.

### <<Reservation Management Server>>

The reservation management server 20 includes a communication unit 21 and a reservation information management unit 22. Each of the functional units included in the reservation management server 20 is a function that is implemented by causing one or more components illustrated in FIG. 5 to operate in response to a command from the CPU 501 in accordance with the program loaded from the HD 504 to the RAM 503.

The communication unit 21 transmits and receives various information to and from the meeting management server 30 and the terminal apparatus 60. The communication unit 21 transmits screen information of a reservation setting screen to the terminal apparatus 60, and receives reservation settings from the terminal apparatus 60. In addition, the communication unit 21 transmits reservation information to the meeting management server 30.

The reservation information management unit 22 manages reservation information registered by a user. The reservation information management unit 22 reads out reservation information of a meeting room 6, which has been requested from the meeting management server 30, from a reservation information database (DB) 291, and transmits the reservation information to the meeting management server 30 through the communication unit 21. Alternatively, when reservation information is registered (or changed), the registered (or changed) reservation information is transmitted to the meeting management server 30 without a request. A typical web application is used by the user to reserve a meeting room 6 in the reservation management server 20.

The reservation management server 20 includes a storage unit 29. The storage unit 29 is implemented by the RAM 503 and the HD 504 of FIG. 5. The reservation information DB 291 is stored in the storage unit 29.

TABLE 1
RESERVATION INFORMATION DB

| | ACCOUNT | | | | | |
|---|---|---|---|---|---|---|
| RESER- | OF USER | | | | | ACCOUNT |
| VATION | WHO MADE | MEETING | MEETING | START | END | OF EXPECTED |
| ID | RESERVATION | NAME | ID | TIME | TIME | PARTICIPANT |
| 001 | a@xfood.com | PRODUCT Z | A101 | 2017 Jul. 7 | 2017 Jul. 7 | b@xfood.com |
| | | DEVELOPMENT | | 10:00 | 12:00 | c@xfood.com |
| | | MEETING | | | | d@xfood.com |
| 002 | e@xfood.com | PRODUCT Y | A101 | 2017 Jul. 7 | 2017 Jul. 7 | f@xfood.com |
| | | DEVELOPMENT | | 13:00 | 14:00 | g@xfood.com |
| | | MEETING | | | | |
| . . . | . . . | . . . | . . . | . . . | . . . | . . . |

Table 1 indicates an example of reservation information stored in the reservation information DB 291. The reservation information is information for managing the reservation status of a meeting room 6. The reservation information includes items such as an account of a user who made a reservation, a meeting name, a meeting room ID, a start time, an end time, and an account of an expected participant. The reservation ID is identification information for identifying one record of reservation information. The ID is an abbreviation for identification and means an identifier or identification information. The ID is a name, a code, a character string, a numeric value, or one or more combinations thereof used to uniquely distinguish a particular object from multiple objects. The same applies to IDs other than the reservation ID. The account of the user who made the reservation is an account of an expected participant who made the reservation for the meeting room 6. The meeting name is the name of a meeting given by the expected participant. The meeting room ID is identification information for identifying the meeting room 6 in the internal network. The start time is the start of a period of time during which the meeting room 6 is reserved (a time when the meeting starts), and the end time is the end of the period of time during which the meeting room 6 is reserved (a time when the meeting ends). The account of the expected participant is the account of the participant who is scheduled to participate in the meeting. All the accounts indicated in Table 1 are issued by the reservation management server 20.

### <<Chat Server>>

The chat server 10 includes a communication unit 11 and a text processing unit 12. These functional units of the chat server 10 are functions that are implemented by causing one or more components illustrated in FIG. 5 to operate in response to a command form the CPU 5201 in accordance with the program loaded from the HD 504 to the RAM 503.

The communication unit 11 transmits and receives various information to and from the meeting management server 30. In the present embodiment, from the meeting management server 30, the communication unit 11 receives information related to a reservation for a meeting room 6, information identifying a bot (a token as will be described later), and information identifying a notification destination group. The information identifying the bot is indicated in advance by the chat server 10 as bot identification information when the bot of the meeting management server 30 is created. Further, the communication unit 11 may receive information specifying an account of an individual such as the user who made the reservation. In addition, the communication unit 11 transmits a message indicating that an expected participant has read the information related to the reservation for the meeting room 6 or a response from the expected participant regarding the displayed reservation information of the meeting room 6, to the meeting management server 30.

The text processing unit 12 transmits the information related to the reservation for the meeting room 6 to expected participants belonging to the group, based on the information identifying the bot received from the meeting management server 30 and the information identifying the notification destination group. When an account of one expected participant belonging to the group is specified as a notification destination by the meeting management server 30, the information related to the reservation for the meeting room 6 is transmitted to the one expected participant. Therefore, the number of notifications transmitted by the text processing unit 12 may be equal to the number of the expected participants, or a notification may be transmitted only to a specific user such as the user who made the reservation.

The text processing unit 12 can perform what is known as a push notification. For example, a mechanism of the push notification may be as follows. A chat application 60a receives an ID (a token) for a push notification from a server operated by the manufacturer of the operating system (OS). In the server, the token is associated with the device (the terminal apparatus 60). The chat application 60a stores the token associated with the account of the chat application 60a in the chat server 10. When the chat server 10 performs a push notification, the chat server 10 identifies the account of the chat application 60a, thus identifying the token to which the chat application 60a is associated. The chat system sends a notification to the server operated by the manufacturer of the OS by specifying the token. The server sends a push notification to the device (terminal apparatus 60) associated with the token.

The chat server 10 includes a storage unit 19. The storage unit 19 is implemented by the RAM 503 and the HD 504 of FIG. 5. A group information DB 191 is stored in the storage unit 19.

TABLE 2
GROUP INFORMATION DB

| | | MEMBER | MEMBER | MEMBER | MEMBER | BOT |
|---|---|---|---|---|---|---|
| WORKSPACE | CHANNEL | ACCOUNT 1 | ACCOUNT 2 | ACCOUNT 3 | ACCOUNT 4 | ACCOUNT |
| http://sample.com/1 | #marketing | a@chat.com | b@chat.com | c@chat.com | d@chat.com | robo@chat.com |
| http://sample.com/2 | #team1 | b@chat.com | d@chat.com | | | |
| http://sample.com/3 | #ip | f@chat.com | g@chat.com | h@chat.com | | robo@chat.com |
| . . . | . . . | . . . | . . . | . . . | . . . | . . . |

Table 2 indicates an example of group information stored in the group information DB 191. The group information is information in which the accounts of members belonging to the same group are registered. Member accounts 1 to n (n=4 in Table 2) and a bot account are registered in the group information in association with workspaces and channels.

A workspace is identification information for identifying an organization such as a company or a department. In the present embodiment, a plurality of members belong to the workspace (such as Company A). The workspace may be a URL, but may be any identification information as long as it is unique. Moreover, the workspace includes a plurality of channels according to the purpose of a chat. A channel is a group of members between which common information is exchanged, such as a group for a product A and a group for a product B, for example. One or more of members belonging to the workspace belong to the channel. In other words, a notification destination is specified by the workspace and the channel. However, a method for specifying a notification destination varies depending on the chat system. Thus, if there is identification information that can uniquely identify a group, a notification destination may be specified by the identification information alone. Alternatively, a notification destination may be specified by more than two pieces of information.

The channels are guaranteed to be unique. The member accounts 1 to n are channel member accounts, and are issued by the chat server 10. In the present embodiment, the bot is registered as a member for indicating information related to a reservation for a meeting room 6. The bot can be referred to as an agent of the meeting management server 30 or a fictitious member. The hot's utterance (text) is transmitted to terminal apparatuses 60 of the member accounts 1 to n.

The workspaces and the channels are managed by the meeting management server 30, and serve as information for identifying groups to which participants belong.

### <<Meeting Management Server>>

The meeting management server 30 includes a communication unit 31, an information associating unit 32, a reservation information acquiring unit 33, a notification determining unit 34, a control information generating unit 35, a control information responding unit 36, a meeting information notification unit 37, a check-in management unit 38, an initial setting unit 39, an authentication unit 40, an authentication key verifying unit 41, a management/control unit 42, a terminal ID verifying unit 43, and a reservation information transmitting unit 44. Each of the above functional units of the meeting management server 30 is a function that is implemented by causing one or more components illustrated in FIG. 5 to operate in response to a command from the CPU 501 in accordance with the program loaded from the HD 504 to the RAM 503. The program may be distributed from a program distribution server, or may be stored in a memory medium and distributed.

The communication unit 31 transmits and receives various information to and from the reservation management server 20, the chat server 10, the registration terminal 50, and the terminal apparatus 60. The communication unit 31 includes a transmitting unit 31a and a receiving unit 31b. The receiving unit 31b receives reservation information from the reservation management server 20, and receives a request for the reservation information from the meeting room terminal 90. In addition, the receiving unit 31b receives a check-in request from the meeting room terminal 90. Moreover, the receiving unit 31b receives the association between a group and accounts of a chat system from the meeting room terminal 90 or the reception terminal 7 operated by the administrator. The transmitting unit 31a transmits information related to a reservation for a meeting room 6 to the chat server 10, and transmits the reservation information to the meeting room terminal 90 or the reception terminal 7.

The information associating unit 32 mainly performs a process related to a prior registration work. That is, the information associating unit 32 receives the registration of a domain from the registration terminal 50 operated by the administrator, and registers the domain in a customer domain DB 495. A workspace and a channel of the chat system transmitted from the registration terminal 50 are associated with accounts of the reservation management server 20 and registered in an association information DB 491.

The reservation information acquiring unit 33 specifies the account of a customer who uses the resource reservation system 100, acquires reservation information from the reservation management server 20, and registers the reservation information as meeting management information in a meeting management information DB 493.

Alternatively, the reservation information acquiring unit 33 receives changes in the reservation information. Accordingly, at least some of reservation information held by the reservation management server 20 is stored in the meeting management information DB 493. The reservation information acquiring unit 33 acquires the reservation information for a predetermined period of time from the current time, from among the reservation information held by the reservation management server 20. The predetermined period of time is determined by how far ahead reservations for a meeting room 6 is to be included in the reservation information.

The notification determining unit 34 determines whether a reservation whose start time fulfills a notification condition is included in the meeting management information DB 493. For example, the notification determining unit 34 refers to a notification setting DB 496, and determines to send a notification when a set date and time, which is calculated backward from the start time, is reached. For example, if bots are divided by role, such as a bot for reminder and a bot for receiving a reservation, a bot may be specified in accordance with the process.

When the notification determining unit 34 determines that a notification is to be sent, the meeting information notification unit 37 specifies information for identifying a bot (for example, a token in Slack) and information for specifying a notification destination group, and requests the chat server 10 to notify information related to a reservation for a meeting room 6. The notification is sent several times, and at least one notification includes meeting identification information. The meeting identification information is information for the meeting management server 30 to confirm that the participant has the right to use the reserved meeting room 6 during the reserved time. The meeting information notification unit 37 generates the meeting identification information at least before a final notification. The meeting identification information is registered in a meeting identification information DB 494.

The control information generating unit 35 refers to the meeting management information to generate control information for the electronic device 70, and registers the control information in a control information DB 497. For example, at a few minutes before the meeting start time, the control information generating unit 35 generates control information to turn on the power of the electronic device 70, and generates control information to turn off the power of the electronic device 70 when detecting a check-out. The control information is stored in the control information DB 497.

The control information responding unit 36 receives an inquiry about control information from the meeting room terminal 90 installed in a meeting room 6, refers to the control information DB 497, and transmits the control information corresponding to the meeting room 6 to the meeting room terminal 90.

The check-in management unit 38 manages a check-in to and a check-out of the meeting room 6. In addition, the check-in management unit 38 registers a meeting status mainly associated with a check-in/check-out in the meeting management information DB 493. A check-in is allowed 5 to 10 minutes (the time can be varied by changing the settings) before the start time of a meeting specified by the reservation ID. Further, a check-in is allowed when a set of a meeting room ID and meeting identification information transmitted from the meeting room terminal 90 is registered in the meeting identification information DB 494.

The initial setting unit 39 mainly performs a process for configuring the initial settings for the meeting room terminal 90 or the reception terminal 7. For example, in the case of the initial settings for the meeting room terminal 90, the initial setting unit 39 provides a list of meeting rooms to the registration terminal 50 of the resource reservation system 100, identifies the meeting room ID and meeting room name of a meeting room selected by the administrator, generates an authentication key, and transmits a URL (uniform resource locator, address information of the meeting management server 30) of the meeting management server 30 to the registration terminal 50. That is, the initial setting unit 39 transmits communication setting information to the registration terminal 50.

In the case of the initial settings for the reception terminal 7, the initial setting unit 39 groups meeting rooms selected by the administrator together. Then, the initial setting unit 39 transmits authentication keys for the meeting rooms and the URL of the meeting management server 30 to the registration terminal 50. In addition, the initial setting unit 39 transmits a group ID to the registration terminal 50, associates the meeting rooms with the group ID, and registers the meeting rooms associated with the group ID in a meeting room setting information DB 498.

The authentication unit 40 authenticates the administrator based on a login password and a user ID stores in a login information DB 499.

The authentication key verifying unit 41 authenticates the meeting room terminal 90 based on whether an authentication key transmitted from the meeting room terminal 90 matches an authentication key registered in the meeting room setting information DB 498. Accordingly, only the meeting room terminal 90 having a valid authentication key can acquire reservation information.

The management/control unit 42 checks whether a management start flag registered in the meeting room setting information DB 498 is set to “true” and whether reservation information is requested. As will be described later, the “management start flag” is a flag indicating whether the management of a meeting room can be started.

In response to a request from the meeting room terminal 90, the reservation information transmitting unit 44 transmits reservation information (meeting management information) stored in the meeting management information DB 493 to the meeting room terminal 90. However, the reservation information is transmitted only when authentication with an authentication key is succeeded, and the management start flag is set to “true”. The reservation information transmitting unit 44 may transmit the reservation information in a JSON format, an XML format, or a comma-separated values (CVS) format. The reservation information is transmitted repeatedly, and thus a format with less capacity is advantageous.

In addition, the meeting management server 30 includes a storage unit 49. The storage unit 49 is implemented by the RAM 503 and the HD 504 of FIG. 5. The storage unit 49 stores the association information DB 491, the meeting management information DB 493, the meeting identification information DB 494, the customer domain DB 495, the notification setting DB 496, the control information DB 497, the meeting room setting information DB 498, and the login information DB 499.

TABLE 3
ASSOCIATION INFORMATION DB

| | | MEMBER | MEMBER | MEMBER | MEMBER |
|---|---|---|---|---|---|
| WORKSPACE | CHANNEL | ACCOUNT 1 | ACCOUNT 2 | ACCOUNT 3 | ACCOUNT 4 |
| http://sample.com/1 | #marketing | a@xfood.com | b@xfood.com | c@xfood.com | d@xfood.com |
| | | a@chat.com | b@chat.com | c@chat.com | d@chat.com |
| http://sample.com/2 | #team1 | f@xfood.com | g@xfood.com | h@xfood.com | |
| | | f@chat.com | g@chat.com | h@chat.com | |
| . . . | . . . | . . . | . . . | . . . | . . . |

Table 3 indicates an example of association information stored in the associating information DB 491. The association information is information that associates accounts of the reservation management system with a group of a chat system. The association information includes items such as a workspace, a channel, and member accounts 1 to n (n=4 in the table). The workspace and channel are as described above. The accounts of participants issued by the reservation management server 20 are registered as the member accounts 1 to n. In addition, as illustrated in Table 3, accounts of the chat system may be registered. In order to notify a group, an account of the reservation management server 20 of a user who reserved a meeting and information for specifying the group and a channel to be notified (in the present embodiment, a workspace name and a channel name) are required. There is no need to register accounts of all members belonging to the group. However, when notifying an individual user, account information of each chat system is required. Thus, account information may be registered as illustrated in Table 3.

TABLE 4
MEETING MANAGEMENT INFORMATION DB

| | ACCOUNT | | | | | | |
|---|---|---|---|---|---|---|---|
| RESER- | OF USER | | MEETING | | | ACCOUNT | |
| VATION | WHO MADE | MEETING | ROOM | START | END | OF EXPECTED | |
| ID | RESERVATION | NAME | ID | TIME | TIME | PARTICIPANT | STATUS |
| 001 | a@xfood.com | PRODUCT Z | A101 | 2017 Jul. 7 | 2017 Jul. 7 | b@xfood.com | CHECKED |
| | | DEVELOPMENT | | 10:00 | 12:00 | c@xfood.com | IN |
| | | MEETING | | | | d@xfood.com | |
| 002 | e@xfood.com | PRODUCT Y | A101 | 2017 Jul. 7 | 2017 Jul. 7 | f@xfood.com | NOTIFIED |
| | | DEVELOPMENT | | 13:00 | 14:00 | g@xfood.com | |
| | | MEETING | | | | | |
| . . . | . . . | . . . | . . . | . . . | . . . | . . . | . . . |

Table 4 indicates an example of meeting management information stored in the meeting management information DB 493 of the meeting management server 30. Because part of the meeting management information stored in the meeting management information DB 493 is reservation information, differences from the reservation information DB 291 in Table 1 will be described with reference to Table 4. The meeting management information in Table 4 includes an item “status”. The “status” indicates the status of a reservation. For example, the “status” indicates that information related to a reservation for a meeting room 6 has been notified, the reservation has been confirmed, the meeting room 6 has been checked in, the meeting room 6 has been checked out, or the meeting room 6 has been canceled.

TABLE 5
MEETING IDENTIFICATION INFORMATION DB

| | | MEETING |
|---|---|---|
| RESERVATION | MEETING | IDENTIFICATION |
| ID | ROOM ID | INFORMATION |
| 001 | A101 | 1234 |
| 002 | A102 | 5678 |
| . . . | . . . | . . . |

Table 5 indicates an example of meeting identification information management information stored in the meeting identification information DB 494. The meeting identification information management information is information for managing meeting identification information for each reservation. The meeting identification information management information includes items such as a reservation ID, a meeting room ID, and meeting identification information. These items are the same as reservation information (reservation information received from the reservation management server 20) except for the meeting identification information, and have already described above. Thus, a description thereof will be omitted. The reservation ID is registered to identify a reservation for the same meeting room 6.

TABLE 6
CUSTOMER DOMAIN DB

| CUSTOMER | CUSTOMER |
|---|---|
| DOMAIN NAME | ADMINISTRATOR ACCOUNT |
| xfood.com | a@xfood.com |
| ycar.com | f@ycar.com |
| . . . | . . . |

Table 6 indicates an example of customer domain information stored in the customer domain DB 495. The customer domain information is information for managing a customer domain and a customer administrator account. The customer domain and the customer administrator account are associated with each other, and registered in the customer domain information. The customer domain in Table 6 is the domain of an account (email address) issued by the reservation management server 20. In addition, the administrator account is an account of a customer administrator (representative). The accounts in Table 6 are issued by the reservation management server 20.

TABLE 7
NOTIFICATION SETTING DB

| CUSTOMER | |
|---|---|
| DOMAIN NAME | NOTIFICATION SETTING |
| xfood.com | ONE DAY BEFORE |
| ycar.com | 12 HOURS BEFORE |
| . . . | . . . |

Table 7 indicates an example of notification setting information stored in the notification setting DB 496. The notification setting information retains a notification setting for each customer. The customer domain and the notification setting are associated with each other, and registered in the notification setting information. The notification setting indicates how long before a meeting start time information related to a reservation for a meeting room 6 is to be notified. Alternatively, a fixed date and time may be set. In addition, the notification setting is not limited to one, and a plurality of notification settings may be registered for one customer.

TABLE 8
CONTROL INFORMATION DB

| MEETING ROOM ID | CONTROL INFORMATION |
|---|---|
| A101 | POWER ON |
| A102 | POWER OFF |
| . . . | . . . |

Table 8 indicates an example of control information stored in the control information DB 497. The control information is information for controlling an electronic device 70 in a meeting room 6. The control information includes items such as a meeting room ID and control information. The control information indicates a method for controlling the electronic device 70. The meeting management server 30 can set detailed control information on a per electronic device basis. The reason why a control timing is not registered is because it is difficult to transmit control information from the meeting management server 30 in the external network to the meeting room terminal 90. Therefore, when the meeting room terminal 90 accesses the meeting management server 30, control information is transmitted, if generated.

TABLE 9

| CUS- | MEETING | MEETING | CONNEC- | AUTHEN- | MANAGEMENT | RE- | OPER- | | |
|---|---|---|---|---|---|---|---|---|---|
| TOMER | ROOM | ROOM | TION | TICATION | START | SOURCE | ATION | GROUP | GROUP |
| ID | NAME | ID | STATE | KEY | FLAG | GROUP | RULE | ID | NAME |
| C-001 | A-1 | A101 | CONNECTED | ***** | TRUE | MEETING | DEFAULT | | |
| | | | | | | ROOM IN | | | |
| | | | | | | BUILDING A | | | |
| | A-2 | A102 | CONNECTED | ***** | FALSE | MEETING | DEFAULT | | |
| | | | | | | ROOM IN | | | |
| | | | | | | BUILDING A | | | |
| | A-3 | A103 | BEFORE | ***** | FALSE | MEETING | GUEST | | |
| | | | SETUP | | | ROOM IN | | | |
| | | | | | | BUILDING A | | | |
| | A-4 | A104 | DIS- | ***** | TRUE | MEETING | EXECUTIVE | | |
| | | | CONNECTED | | | ROOM IN | | | |
| | | | | | | BUILDING A | | | |
| | B-1 | B101 | CONNECTED | **** | FALSE | MEETING | DEFAULT | G-001 | 1ST FLOOR |
| | | | | | | ROOM IN | | | OF BUILDING |
| | | | | | | BUILDING B | | | B |
| | B-2 | B102 | CONNECTED | **** | FALSE | MEETING | DEFAULT | G-001 | 1ST FLOOR |
| | | | | | | ROOM IN | | | OF BUILDING |
| | | | | | | BUILDING B | | | B |
| | B-3 | B103 | CONNECTED | **** | FALSE | MEETING | DEFAULT | G-001 | 1ST FLOOR |
| | | | | | | ROOM IN | | | OF BUILDING |
| | | | | | | BUILDING B | | | B |
| | B-4 | B104 | CONNECTED | **** | FALSE | MEETING | DEFAULT | | |
| | | | | | | ROOM IN | | | |
| | | | | | | BUILDING B | | | |

Table 9 indicates an example of meeting room setting information stored in the meeting room setting information DB 498. The meeting room setting information is setting information for each meeting room. The meeting room setting information includes items such as a meeting room name, a meeting room ID, a connection state, an authentication key, a management start flag, resource group, an operation rule, a group ID, and a group name, in association with a customer ID.
The meeting room name indicates a general name of a meeting room recognized by meeting participants. For example, the meeting room name is a name presented at the entrance of the meeting room.
The meeting room ID indicates identification information for uniquely identifying the meeting room as described above. For simplicity, the meeting room ID can be shared with the reservation management server 20. Alternatively, by providing a conversion table, the administrator can set a meeting room ID separately from the reservation management server 20.
The connection state indicates whether the initial settings for the meeting room terminal 90 or the reception terminal 7 has been completed and whether communication is possible. A “connected” state indicates that communication is confirmed within a certain period of time. A “before setup” state indicates a state before the initial settings. A “disconnected” state indicates that there is no communication for a certain period of time.
The authentication key indicates authentication information for authenticating the meeting room terminal 90 or the reception terminal 7 by the meeting management server 30. The authentication key is transmitted to the meeting room terminal 90 or the reception terminal 7 at the initial settings. The authentication key is a combination of numbers, alphabets, and symbols, which is long enough to be unspecified by a brute force method. The authentication key may be determined by the meeting management server 30 or by the administrator.
The management start flag is a flag indicating whether the meeting management server 30 starts to manage a meeting room associated with the meeting room terminal 90 or the reception terminal 7 after the initial settings for the meeting room terminal 90 or the reception terminal 7 are completed (“true” indicates that the meeting management server 30 start management, and “false” indicates that the meeting management server 30 does not start management). By setting the “management start flag”, inconveniences (such as an automatic cancellation of a reservation) caused by a time lag between the completion of the initial settings and the installation of the meeting room terminal 90 can be minimized.
The resource group is a group of meeting rooms under management, and indicates an office or a building where the meeting rooms are located. The resource group is not necessarily required.
The operation rule indicate which rules are used to operate a meeting room. The operation rule includes a check-in time, an automatic cancellation time, and whether an electronic device is automatically started. For example, “default” indicates rules for employees, “guest” indicates rules for visitors, and “executive” indicates rules for officers.
The group ID indicates identification information of a group of a plurality of meeting rooms selected by the administrator. For example, it can be seen that meeting rooms B-1 to B-3 belong to G-001. Group IDs are not set for meeting rooms not belonging to any groups.
The group name indicates the name of a group set by the administrator. Group names are not set for meeting rooms not belonging to any groups.

Among the above items, the meeting room name, the meeting room ID, the management start flag (“false” is set by default), the resource group, and the operation rule may be transmitted from the reservation management server 20. Alternatively, the meeting room name, the meeting room ID, the management start flag, the resource group, and the operation rule may be set by the administrator for the meeting management server 30. The initial connection state (immediately after the settings are configured by the provider) is “before setup”. The connection state changes in accordance with the communication state. The authentication key is assigned and set by the meeting management server 30 at the initial settings. The management start flag is set by the administrator. The group ID is set by the meeting management server 30 at a timing when meeting rooms are grouped by the administrator. The group name is set by the administrator.

TABLE 10
LOGIN INFORMATION DB

| CUSTOMER | LOGIN | | |
|---|---|---|---|
| ID | PASSWORD | USER ID | SERVER URL |
| C-001 | ********* | a@xfood.com | http://kaigi.xfood.com/ |

Table 10 indicates an example of login information stored in the login information DB 499. The login information is information allowing the administrator to log in to the meeting management server 30. The login information includes items such as a customer ID, a login password, a user ID, and a server URL. The administrator logs in to the meeting management server 30 with the login password and the user ID, and displays various screens on the registration terminal 50. When the administrator logs in, a customer for which the administrator installs the meeting room terminal 90 or the reception terminal 7 in a meeting room is identified. In addition, the server URL assigned to the customer is registered in the login information DB 499, thereby allowing the meeting room terminal 90 or the reception terminal 7 of the customer to communicate with the meeting management server 30. The server URL is a URL, of the meeting management server 30, assigned to the customer. The meeting room terminal 90 can acquire reservation information by accessing the server URL. Note that a common server URL may be used by a plurality of customers.

### <<Registration Terminal>>

The registration terminal 50 includes a communication unit 51, an operation receiving unit 52, and a display control unit 53. The functional units of the registration terminal 50 are functions that are implemented by causing one or more hardware components illustrated in FIG. 5 to operate in response to a command from the CPU 501 in accordance with the program loaded from the HD 504 to the RAM 503. The program (such as a browser) may be distributed from a program distribution server, or may be stored in a storage medium and distributed.

The registration terminal 50 is a terminal on which the administrator configures various settings related to a meeting room via a web page provided by the meeting management server 30. The various settings include the initial settings. The terminal apparatus 60 may be used for the initial settings.

The communication unit 51 transmits and receives various information to and from the meeting management server 30 and the reservation management server 20. In the present embodiment, the communication unit 51 transmits information related to a group of meeting rooms to the meeting management server 30.

The operation receiving unit 52 receives various operations performed by a participant with respect to the terminal apparatus 60. The display control unit 53 interprets screen information of various screens, and displays the screens on the display 506. The operation receiving unit 52 and the display control unit 53 may include browser functions and execute web applications. For example, the display control unit 53 displays screens based on screen information received from the meeting management server 30, and the operation receiving unit 52 receives meeting rooms to be grouped.

### <<Terminal Apparatus>>

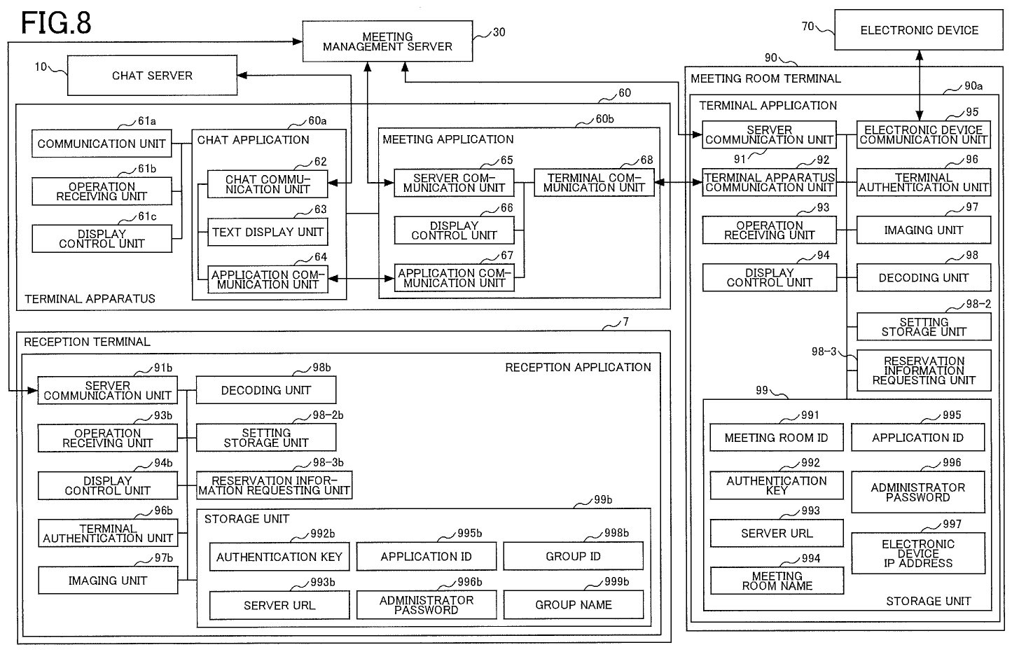

FIG. 8 is a functional block diagram illustrating functions of the terminal apparatus 60, the meeting room terminal 90, and the reception terminal 7. The functions of the electronic device 70 will be described as necessary.

The terminal apparatus 60 includes a communication unit 61a, an operation receiving unit 61b, a display control unit 61c, a chat communication unit 62, a text display unit 63, an application communication unit 64, a server communication unit 65, a display control unit 66, an application communication unit 67, and a terminal communication unit 68. The functional units of the terminal apparatus 60 are functions that are implemented by causing one or more hardware components illustrated in FIG. 5 to operate in response to a command from the CPU in accordance with the program loaded from the HD 504 to the RAM 503. The program may be distributed from a program distribution server, or may be stored in a storage medium and distributed. Because the chat application 60a and a meeting application 60b are operated in the terminal apparatus 60, the program includes the chat application 60a and the meeting application 60b.

The communication unit 61a transmits and receives various information to and from the meeting management server 30 and the reservation management server 20. The operation receiving unit 61b receives various operations performed by a participant with respect to the terminal apparatus 60. The display control unit 61c interprets screen information of various screens, and displays the screen information on the display 506. The operation receiving unit 61b and the display control unit 61c may include browser functions and execute web applications. For example, the display control unit 61c displays a reservation setting screen received from the reservation management server 20, and the operation receiving unit 61b receives reservation information set by the user who made a reservation.

The chat communication unit 62 of the chat application 60a transmits and receives various information to and from the chat server 10. In the present embodiment, the chat communication unit 62 receives information related to a reservation for a meeting room 6 from the chat server 10, and indicates the information has been read to the chat server 10. In addition, the chat communication unit 62 indicates whether the meeting room 6 is used or cancelled to the chat server 10.

The text display unit 63 of the chat application 60a displays a text (information related to a reservation for a meeting room 6) transmitted from the chat server 10. For example, the source of an utterance is bot, and the text display unit 63 displays the text as if the bot inputs the text.

The application communication unit 64 of the chat application 60a calls the meeting application 60b, and transmits meeting identification information to the meeting application 60b. The chat server 10 transmits information for identifying the meeting application 60b to the terminal apparatus 60, when indicating the information related to the reservation for the meeting room 6. Accordingly, the chat application 60a specifies the meeting application 60b to the OS, and requests a notification of the meeting identification information. The OS can start the meeting application 60b.

The server communication unit 65 of the meeting application 60b communicates with the meeting management server 30. The server communication unit 65 acquires image code including the meeting identification information from the meeting management server 30. The server communication unit 65 is implemented by the CPU 501 of FIG. 5 executing the meeting application 60b. The image code is used for authentication at check-in, and may be a few digits for authentication.

The display control unit 66 of the meeting application 60b displays the image cod including the meeting identification information, on the display 506. The application communication unit 67 of the meeting application 60b acquires various information (such as the meeting identification information included in the information related to the reservation for the meeting room 6) from the chat application 60a through the OS.

The terminal communication unit 68 communicates with the meeting room terminal 90, and transmits the meeting identification information. The terminal communication unit 68 detects the presence of the meeting room terminal 90 by short-range wireless communication such as Bluetooth (registered trademark), and transmits the meeting identification information in response to detecting the meeting room terminal 90. In addition, the terminal communication unit 68 provides the meeting room terminal 90 with a function to display the image code.

### <<Meeting Room Terminal>>

The meeting room terminal 90 includes a server communication unit 91, a terminal apparatus communication unit 92, an operation receiving unit 93, a display control unit 94, an electronic device communication unit 95, a terminal authentication unit 96, an imaging unit 97, a decoding unit 98, a setting storage unit 98-2, and a reservation information requesting unit 98-3. The functional units of the meeting room terminal 90 are functions that are implemented by causing one or more hardware components illustrated in FIG. 6 to operate in response to a command from the CPU 701 in accordance with the program loaded from the EEPROM 704 to the RAM 703. The program may be distributed from a program distribution server, or may be stored in a storage medium and distributed.

The server communication unit 91 communicates with the meeting management server 30, with a server URL 993 as a destination. Because the meeting room terminal 90 is located in the internal network, it is difficult for the meeting management server 30 to communicate with the meeting room terminal 90. Therefore, the server communication unit 91 communicates with the meeting management server 30 by using a communication technology such as polling (communicating with the meeting management server 30 periodically) or WebSocket. When there is no communication from the server communication unit 91, the connection state “disconnected” is registered in the meeting room setting information DB 498. The server communication unit 91 may communicate using a communication protocol such as HTTP, and the communication protocol is not particularly limited.

The server communication unit 91 of the preset embodiment receives reservation information, and transmits meeting identification information, received by the terminal apparatus communication unit 92 from the terminal apparatus 60 or manually input at the time of check-in, to the meeting management server 30. In addition, the server communication unit 91 receives control information from the meeting management server 30.

The terminal apparatus communication unit 92 communicates with the terminal apparatus 60. In the present embodiment, the terminal apparatus communication unit 92 receives the meeting identification information. The electronic device communication unit 95 communicates with the electronic device 70. In the present embodiment, the electronic device communication unit 95 transmits the control information, received by the server communication unit 91, to the electronic device 70.

The display control unit 94 displays a screen generated by a terminal application 90a on the display 718. The screen is a standby screen that allows a check-in and a check-out. The operation receiving unit 93 receives various operations on the meeting room terminal 90.

The terminal authentication unit 96 authenticates an administrator login to the terminal application, based on whether an entered administrator password is correct. Because the meeting room terminal 90 installed in a meeting room can be operated by any participant, there may be a possibility that the initial settings may be changed if the authentication function is not equipped. The terminal authentication unit 96

The imaging unit 97 mainly captures an image code. When the administrator operates the meeting room terminal 90 such that an image code is within the angle of view of the CMOS sensor 713, the imaging unit 97 identifies the image code, and automatically generates image data. The decoding unit 98 decodes the image code captured by the imaging unit 97 to restore communication setting information.

The setting storage unit 98-2 stores, in a storage unit 99, the communication setting information (a meeting room ID, an authentication key, a server URL, and a meeting room name) decoded by the decoding unit 98.

The reservation information requesting unit 98-3 repeatedly transmits the meeting room ID and the authentication key to the meeting management server 30 via the server communication unit 91 to acquire reservation information at periodic intervals. As a response, the reservation information requesting unit 98-3 acquires the reservation information via the server communication unit 91. The reservation information requesting unit 98-3 may acquire the reservation information only when the reservation information is changed. For example, the reservation information requesting unit 98-3 may transmit the meeting room ID and the authentication key at intervals of few seconds to few minutes. The shorter the interval is, the sooner the reservation information is updated. However, the communication load increases. Accordingly, the periodic interval is determined by taking into account the update frequency of the reservation information and the communication load. In the present embodiment, the reservation information requesting unit 98-3 may acquire the reservation information at intervals of 30 seconds. In addition, the reservation information requesting unit 98-3 can receive at least meeting management information (reservation information) of the meeting room 6 on that day via the server communication unit 91.

In addition, the meeting room terminal 90 includes the storage unit 99. The storage unit 99 is implemented by the ROM 702 and the EEPROM 704 of FIG. 6. A meeting room ID 991, an authentication key 992, the server URL 993, a meeting room name 994, an application ID 995, an administrator password 996, and an IP address 997 of the electronic device 70 are stored in the storage unit 99.

The meeting room ID 991, the authentication key 992, the server URL 993, and the meeting room name 994 are stored at the initial settings. The application ID 995 is identification information of the terminal application 90a running on the terminal application 90a. The application ID 995 is used to indicate the type of an information processing terminal (for example, either the meeting room terminal 90 or the reception terminal 7) to the meeting management server 30. The application ID is a number unique to the terminal application 90a, or a part of the application ID includes a number unique to the terminal application 90a. The application ID may be a universally unique identifier (UUID) of the terminal application 90a. The UUID is a unique identifier in which two or more items do not have the same value in the world without specific management.

The administrator password 996 is set by the administrator when the terminal application 90a is installed or at an initial startup. The IP address 997 of the electronic device 70 is set by the administrator as necessary.

### <<Reception Terminal>>

The reception terminal 7 includes a server communication unit 91b, an operation receiving unit 93b, a display control unit 94b, a terminal authentication unit 96b, an imaging unit 97b, a decoding unit 98b, a setting storage unit 98-2b, and a reservation information requesting unit 98-3b. The functional units of the reception terminal 7 are functions that are implemented by causing one or more hardware components illustrated in FIG. 6 to operate in response to a command from the CPU 701 in accordance with the program loaded from the EEPROM 704 to the RAM 703. The program may be distributed from a program distribution server, or may be stored in a storage medium and distributed. Further, the functions of the reception terminal 7 are similar to the functions of the meeting room terminal 90, and a duplication thereof will be omitted.

Further, the reception terminal 7 includes a storage unit 99b. The storage unit 99b is implemented by the ROM 702 and the EEPROM 704 of FIG. 6. The storage unit 99b stores a group ID 998b, one or more authentication keys 992b, a server URL 993b, an application ID 995b, an administrator password 996b, and a group name 999b. That is, the storage unit 99b of the reception terminal 7 stores the group ID 998 and the group name 999b, instead of the meeting room ID and the meeting room name. In addition, the storage unit 99b does not store the IP address of the electronic device 70.

### <Initial Setting Unit of Meeting Management Server>

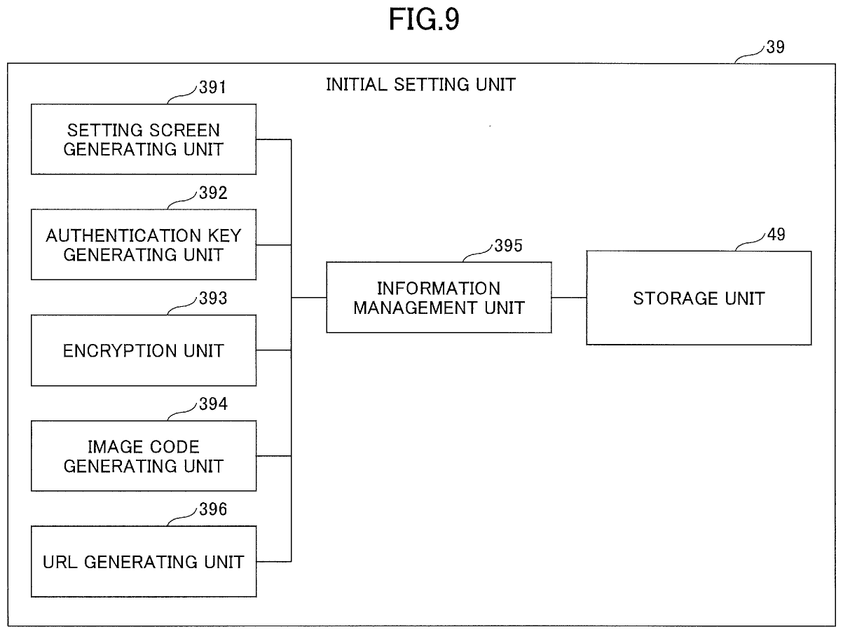

FIG. 9 is a functional block diagram illustrating functions of the initial setting unit 39. The initial setting unit 39 includes a setting screen generating unit 391, an authentication key generating unit 392, an encryption unit 393, an image code generating unit 394, a URL generating unit 396, and an information management unit 395. The storage unit 49 is the same as that of FIG. 7. The initial setting unit 39 control the functions such that necessary processes are performed.

The information management unit 395 reads out information stored in the storage unit 49, and sends the information to any of the functions (the setting screen generating unit 391, the authentication key generating unit 392, the encryption unit 393, the image code generating unit 394, and the URL generating unit 396) requiring the information.

The setting screen generating unit 391 generates screen information of various screens, and transmits the screen information to the registration terminal 50 through the communication unit 31. The screen information is created by HTML, XML, cascade style sheet (CSS), or JavaScript (registered trademark). The various screens are provided as screens of a web application that runs on a browser by JavaScript (registered trademark).

In the case of the initial settings for the meeting room terminal 90, the encryption unit 393 encrypts communication setting information. In the case of the initial settings for the reception terminal 7, the encryption unit 393 encrypts information including a group ID and a group name (authentication keys and a server URL may be included). However, encryption is not necessarily required.

The image code generating unit 394 encodes the encrypted information into an image code. The URL generating unit 396 creates a URL including the group ID or a URL associated with the group ID.

Briefly, the communication setting information (a meeting room ID, an authentication key, a server URL, and a meeting room name) is information necessary for the meeting room terminal 90 to communicate with the meeting management server 30. The server URL is information for identifying a communication destination. The authentication key is information for authentication. The meeting room ID is information for indicating which meeting room is performing communication. The meeting room name is information displayed by the meeting room terminal 90, and is not necessarily required to be included in the communication setting information. Further, the server URL is not required to be included in the communication setting information, as long as the server URL is set in the terminal application or the reception application.

### <Screen Transitions and Process for Storing Group ID by Reception Terminal>

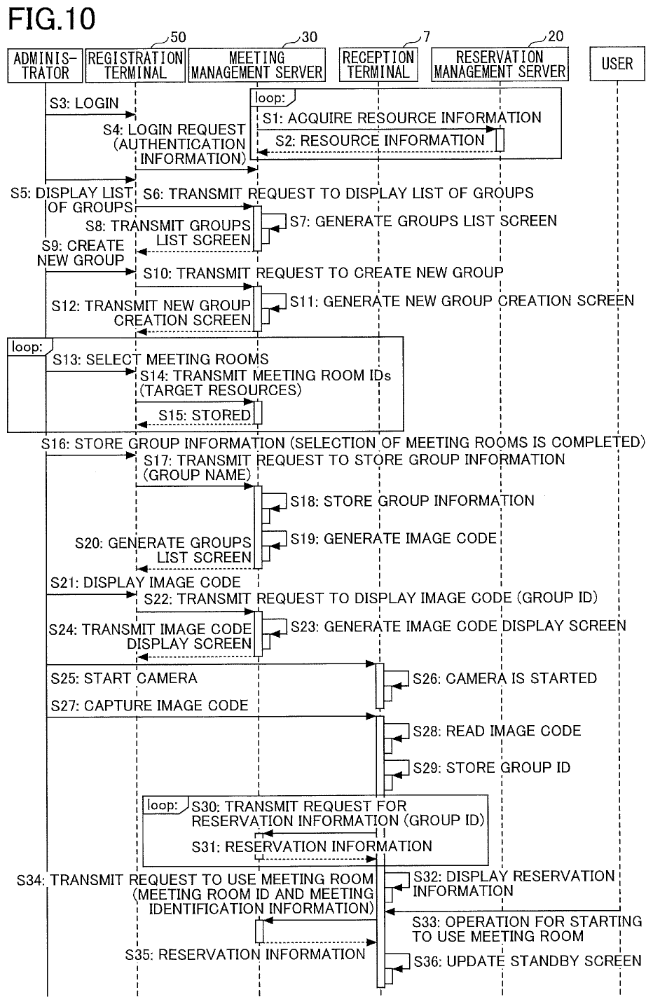

Next, screen transitions and a process for storing a group ID by the reception terminal 7 will be described with reference to FIG. 10 through FIG. 28. FIG. 10 is a sequence diagram illustrating an example of a process for storing a group ID by the reception terminal 7.

In S1 and S2, the reservation information acquiring unit 33 of the meeting management server 30 acquires information of all meeting rooms (resources) for each customer from the reservation management server 20 in advance. Accordingly, the acquired information of the meeting rooms is stored in the meeting room setting information DB 498. The information of the meeting rooms is not frequently changed. Thus, the reservation information acquiring unit 33 may acquire the information of the meeting rooms less frequently, for example, once a day. Further, the reservation information acquiring unit 33 acquires the information of the meeting rooms periodically from the reservation management server 20. Alternatively, if the information of the meeting rooms is changed, the reservation information acquiring unit 33 acquires the changed information of the meeting rooms from the reservation management server 20.

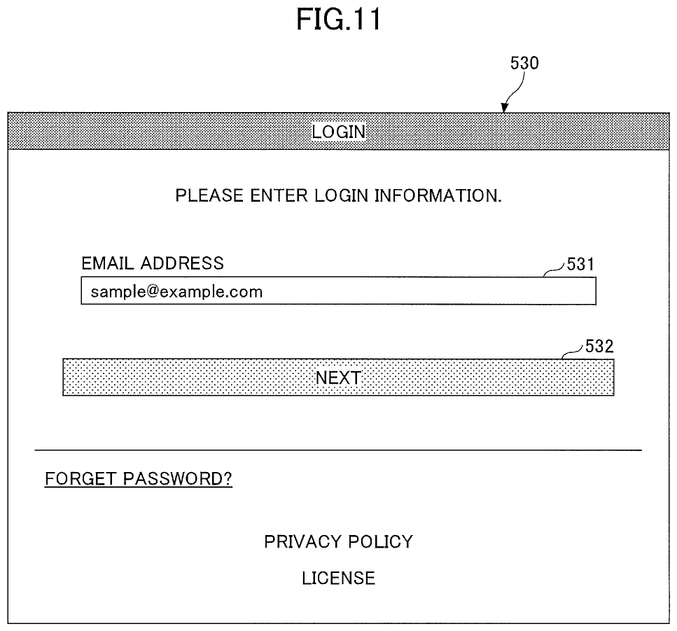

In S3, the administrator who configures the initial settings for the reception terminal 7 starts a browser of the registration terminal 50 (or the administrator may start a dedicated application), and performs an operation to log in to the meeting management server 30. FIG. 11 is a diagram illustrating an example of a login screen 530. For example, the administrator inputs a user ID and a password as authentication information.

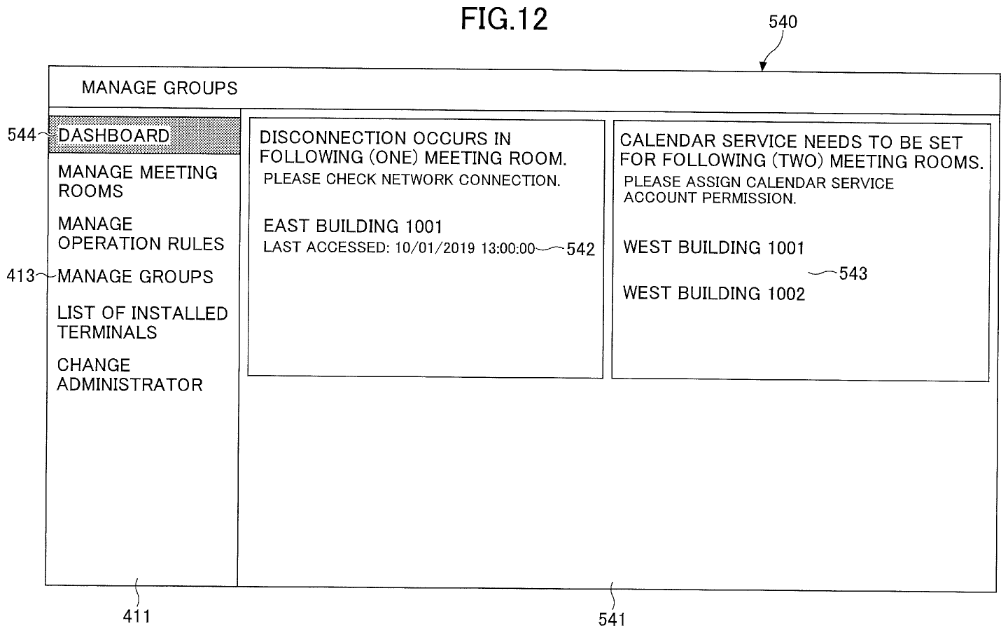

In S4, the operation receiving unit 52 of the registration terminal 50 receives the authentication information, and the communication unit 51 transmits a login request to the meeting management server 30 by specifying the authentication information. The authentication unit 40 of the meeting management server 30 authenticates the administrator based on the login password and the user ID stored in the login information DB 499. In this example, the authentication is assumed to be successful. As a result, the registration terminal 50 displays an initial screen. FIG. 12 is a diagram illustrating an example of an initial screen 540.

In S5, next, the administrator performs an operation to display a list of groups on the registration terminal 50. Displaying a list of groups means displaying a list of groups registered in the meeting management server 30.

In S6, the operation receiving unit 52 of the registration terminal 50 receives the operation, and the communication unit 51 transmits a request to display a list of groups to the meeting management server 30.

In S7, the receiving unit 31b of the meeting management server 30 receives the request to display a list of groups, and the setting screen generating unit 391 refers to the meeting room setting information DB 498 and generates screen information of a groups list screen.

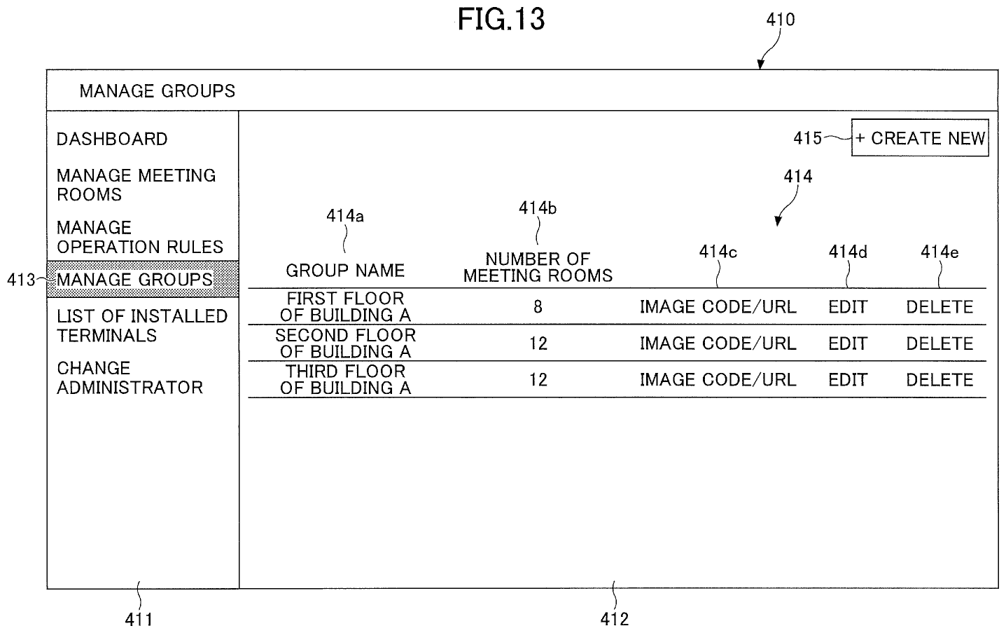

In S8, the transmitting unit 31a of the meeting management server 30 transmits the screen information of the groups list screen to the registration terminal 50. The communication unit 51 of the registration terminal 50 receives the screen information of the groups list screen, and the display control unit 53 displays the groups list screen. FIG. 13 is a diagram illustrating an example of a groups list screen 410.

In S9, the administrator performs an operation to create a new group on the groups list screen 410.

In S10, the operation receiving unit 52 of the registration terminal 50 receives the operation, and the communication unit 51 transmits a request to create a new group to the meeting management server 30.

In S11, the receiving unit 31b of the meeting management server 30 receives the request to create a new group, and the setting screen generating unit 391 generates screen information of a new group creation screen.

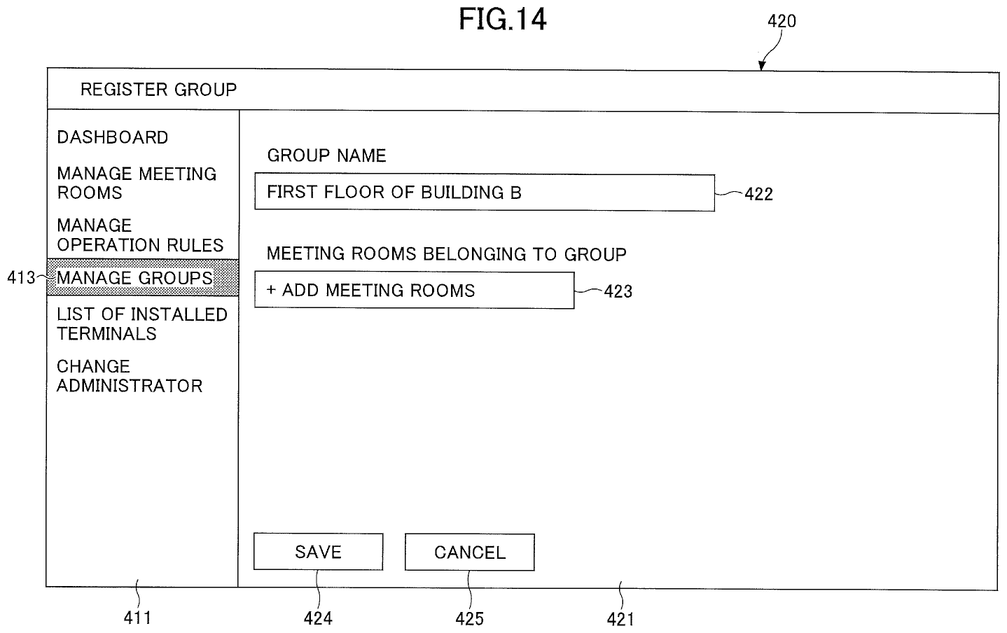

In S12, the transmitting unit 31a of the meeting management server 30 transmits the screen information of the new group creation screen to the registration terminal 50. The communication unit 51 of the registration terminal 50 receives the screen information of the new group creation screen, and the display control unit 53 displays the new group creation screen. FIG. 14 is a diagram illustrating an example of a new group creation screen 420.

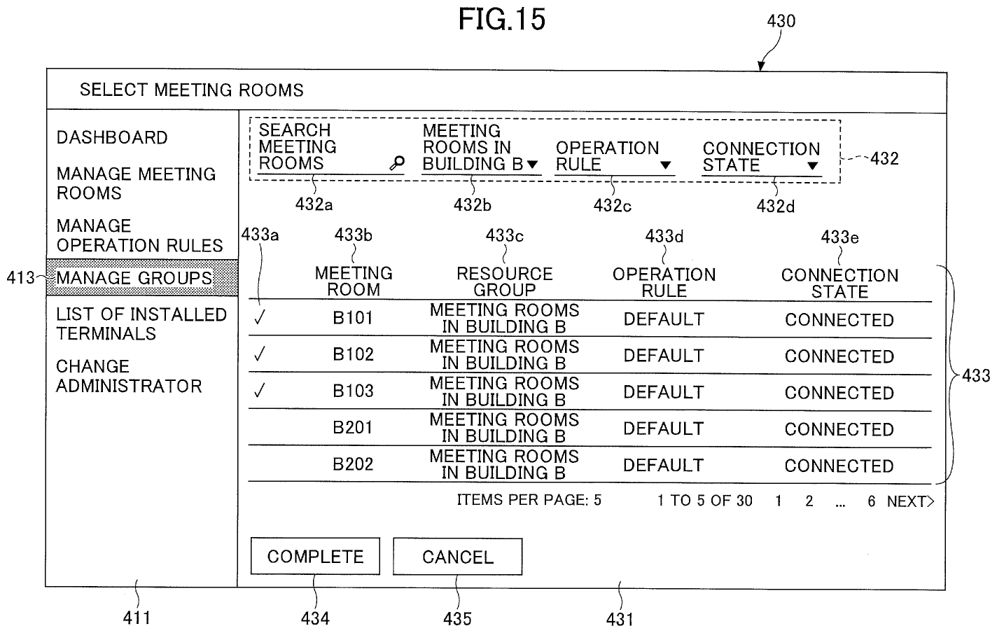

In S13, the administrator inputs a group name on the new group creation screen 420, and performs an operation to select meeting rooms. As a result, the setting screen generating unit 391 refers to the meeting room setting information DB 498 and generates screen information of a meeting rooms list screen, and the registration terminal 50 displays the meeting rooms list screen. FIG. 15 is a diagram illustrating an example of a meeting rooms list screen 430. The administrator performs an operation to select meeting rooms to be grouped together on the meeting rooms list screen 430. That is, a plurality of meeting rooms are grouped.

In S14 and S15, the operation receiving unit 52 of the registration terminal 50 receives the operation, and the communication unit 51 transmits meeting room IDs (target resources) to the meeting management server 30. The receiving unit 31b of the meeting management server 30 receives the meeting room IDs, and the information management unit 395 stores the meeting room IDs. The transmitting unit 31a indicates the completion of storing the meeting room IDs to the registration terminal 50. Steps S13 through S15 may be repeated for each meeting room. Alternatively, the administrator may select a plurality of meeting rooms at once. The registration terminal 50 transmits the group name to the meeting management server 30 during steps S13 through S15.

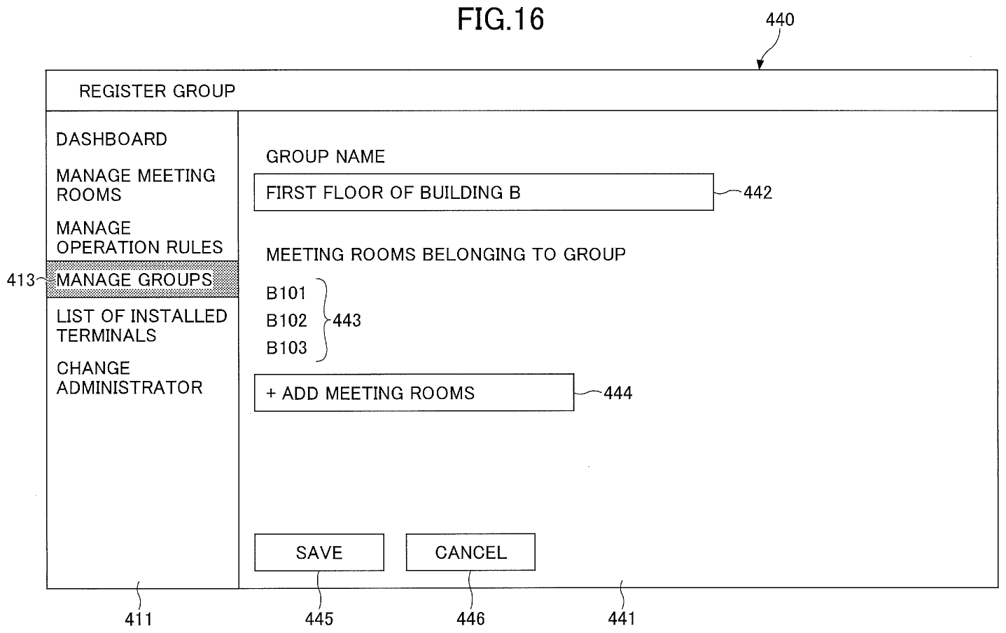

In S16, when the selection of the meeting rooms to be grouped is completed, the administrator presses a Complete button on the meeting rooms list screen 430. As a result, the registration terminal 50 displays a group registration confirmation screen. FIG. 16 is a diagram illustrating an example of a group registration confirmation screen 440. The administrator checks the meeting rooms to be grouped on the group registration confirmation screen 440, and performs an operation to store group information.

In S17, the operation receiving unit 52 of the registration terminal 50 receives the operation, and the communication unit 51 transmits a request to store group information including the group name to the meeting management server 30. Note that the group name may be transmitted to the meeting management server 30 during steps S9 through S17.

In S18, the receiving unit 31b of the meeting management server 30 receives the request to store group information including the group name, and the information management unit 395 stores group information. That is, the information management unit 395 assigns a group ID, associates the group ID and the group name with the meeting room IDs transmitted in steps S13 and S14, and stores the group ID and the group name associated with the meeting room IDs in the meeting room setting information DB 498 as group information. The group information includes the group name, the group ID, and the meeting room IDs. If the administrator selects a meeting room for which an authentication key is not set in the meeting room setting information DB 498, an authentication key is generated.

In S19, the image code generating unit 394 generates an image code including the group ID and the group name. The image code generating unit 394 associates the image code with the group ID. Although not illustrated in FIG. 10, the image code includes authentication keys for the respective meeting rooms and includes one server URL. Alternatively, a common authentication key may be used by the meeting rooms. If the server URL is registered in the reception application, the image code is not required to include the server URL

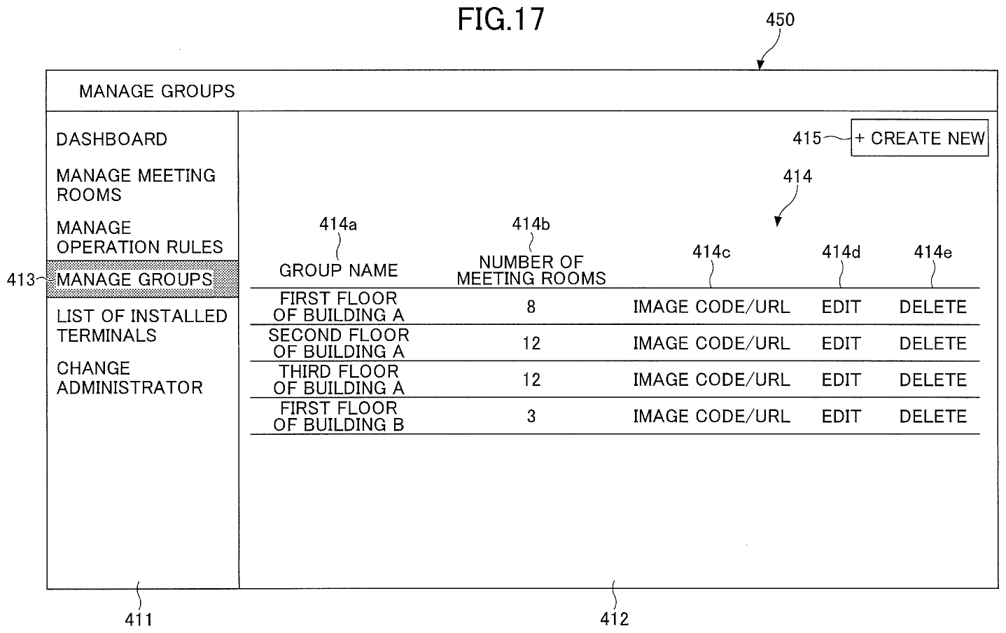

In S20, the transmitting unit 31a of the meeting management server 30 indicates the completion of storing the group information to the registration terminal 50. In addition, the setting screen generating unit 391 refers to the meeting room setting information DB 498 and generates screen information of a groups list screen, and the transmitting unit 31a transmits the screen information of the groups list screen to the registration terminal 50. The registration terminal 50 displays the groups list screen 450 received from the meeting management server 30. FIG. 17 is a diagram illustrating an example of a groups list screen 450.

In S21, the administrator performs an operation to display the image code by specifying the group on the groups list screen 450. Note that an “image code/URL” button displayed on the groups list screen 450 may allow the administrator to press either “image code” or “URL”, or may allow the administrator to press both “image code” and “URL” together. In this example, it is assumed that “image code” and “URL” are pressed together, or only “image code” is pressed.

In S22, the operation receiving unit 52 of the registration terminal 50 receives the operation, and the communication unit 51 transmits a request to display the image code to the meeting management server 30 by specifying the group ID.

In S23, the receiving unit 31b of the meeting management server 30 receives the request to display the image code. The setting screen generating unit 391 generates screen information of an image code display screen that displays the image code associated with the group ID. Note that the image code may be generated by the image code generating unit 394 at this timing. In this case, if the group name or the meeting rooms are changed, the image code can be created by using the changed group name or the changed meeting rooms.

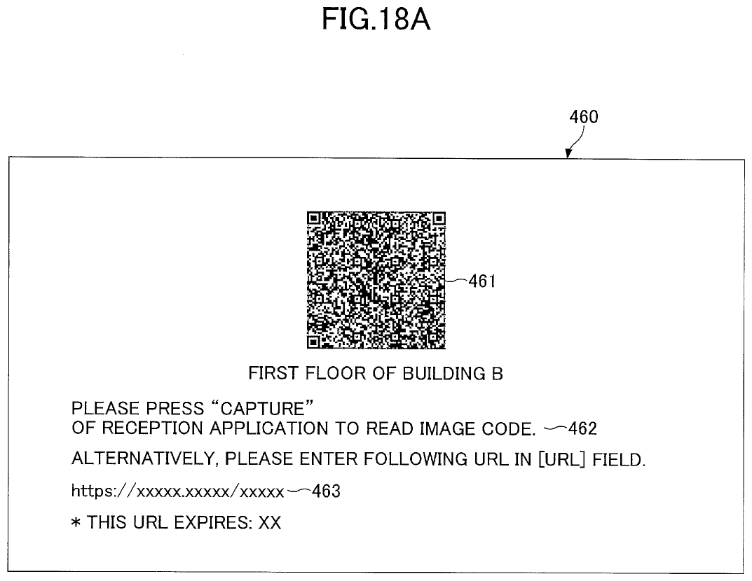

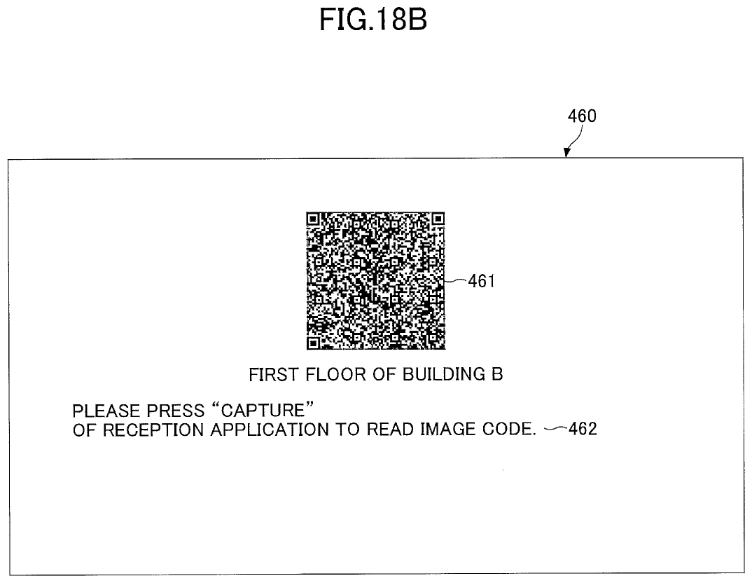

In S24, the transmitting unit 31a of the meeting management server 30 transmits the screen information of the image code display screen to the registration terminal 50. The communication unit 51 of the registration terminal 50 receives the screen information of the image code display screen, and the display control unit 53 displays the image code display screen. FIGS. 18A and 18B are diagrams illustrating examples of image code display screens 460.

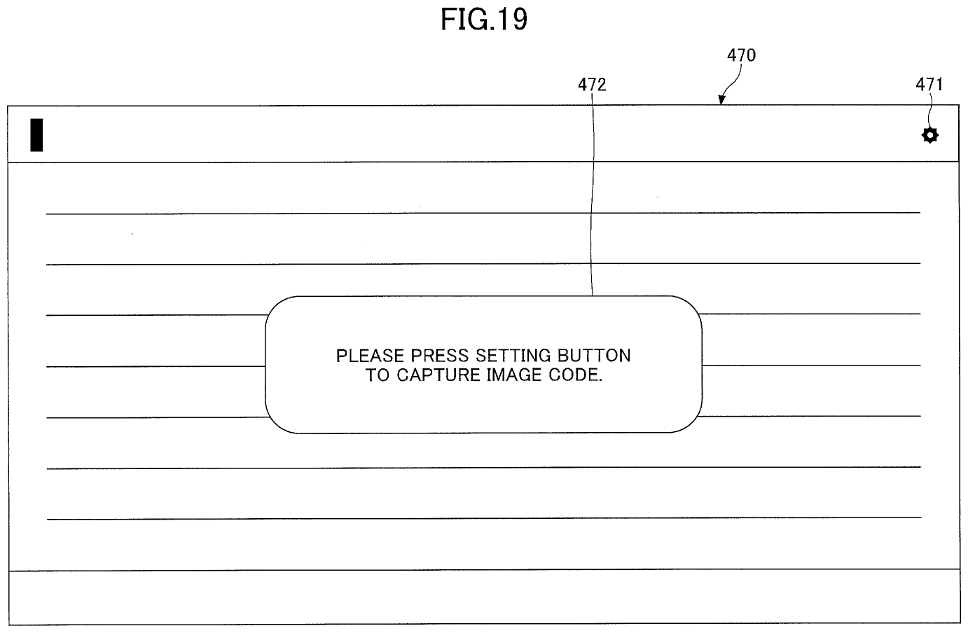

In S25, next, in order to connect the reception terminal 7 to the server URL, the administrator operates the reception terminal 7 and starts the reception application (if the reception application is not started). The administrator is not required to log in to the reception terminal 7 because the administrator is already authenticated by the meeting management server 30. However, the administrator may be authenticated with the administrator password. FIG. 19 is a diagram illustrating an example of a startup screen 470 for the reception application. The administrator operates the reception terminal 7 to start a camera, and causes the reception terminal 7 to capture the image code.

In S26, the camera of the reception terminal 7 is started, and is ready to capture the image code.

In S27, the administrator causes the reception terminal 7 to capture the image code. For example, the administrator operates the registration terminal 50 such that the image code is within the angle of view of the CMOS sensor 713.

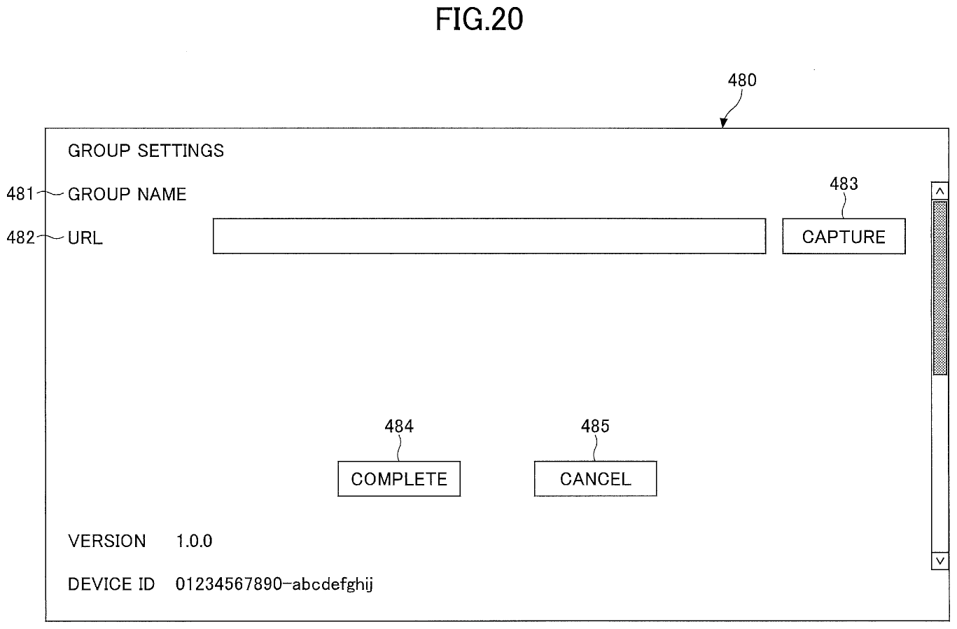

In S28, the imaging unit 97b of the reception terminal 7 captures the image code as a video such that the image code can be automatically detected. The decoding unit 98b decodes the detected image code, and acquires the group ID and the group name (the authentication keys and the server URL may be included). As a result, the display control unit 94b of the reception terminal 7 displays a group settings screen. FIG. 20 is a diagram illustrating an example of a group settings screen 480.

In S29, the setting storage unit 98-2b of the reception terminal 7 stores the group ID, the group name, the authentication keys, and the server URL in the storage unit 99b. Accordingly, the reception terminal 7 can acquire reservation information by identifying the group ID. Note that if a group ID is already stored, the group ID may be overwritten. In this manner, the administrator can newly install the reception terminal 7. Further, if a meeting room ID is already stored, the meeting room ID may be overwritten. In this manner, the meeting room terminal 90 can be used as a reception terminal. The reception terminal 7 may display a dialog asking the user to overwrite the already stored group ID, and determine whether to overwrite the already stored group ID in accordance with the user's response. If a plurality of group IDs are stored, reservation information is acquired on a per group ID basis.

In S30, when the group ID is stored, the reservation information requesting unit 98-3b of the reception terminal 7 transmits a request for reservation information by specifying the group ID and the authentication keys, to the meeting management server 30 specified by the server URL. Thereafter, the reservation information requesting unit 98-3b repeatedly requests the reservation information.

In S31, when the receiving unit 31b of the meeting management server 30 receives the request for reservation information, the authentication key verifying unit 41 verifies the authentication keys. That is, the authentication key verifying unit 41 acquires authentication keys identified by the meeting room IDs from the meeting room setting information DB 498, and determines whether the authentication keys acquired from the meeting room setting information DB 498 match the authentication keys transmitted from the reception terminal 7. When it is determined that the authentication keys acquired from the meeting room setting information DB 498 match the authentication keys transmitted from the reception terminal 7, the initial setting unit 39 changes the connection states to “connected” in the meeting room setting information DB 498. Next, when the management start flags are set to “true”, the reservation information transmitting unit 44 acquires the meeting room IDs associated with the group ID from the meeting room setting information DB 498, and acquires reservation information associated with the meeting room IDs from the meeting management information DB 493. The transmitting unit 31a of the meeting management server 30 transmits the reservation information to the reception terminal 7.

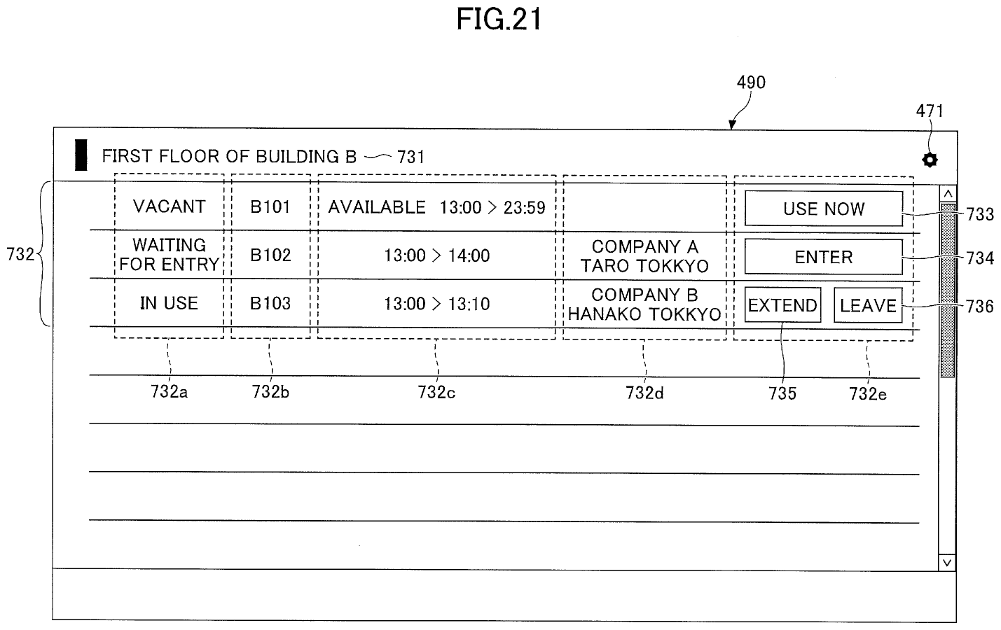

In S32, the server communication unit 91b of the reception terminal 7 receives the reservation information, and the display control unit 94b displays the reservation information on a standby screen. FIG. 21 is a diagram illustrating an example of a standby screen 490.

In S33, when a status field 732a of a meeting room indicates “waiting for entry” on the standby screen 490, the user can perform an operation to start using (check in to) the meeting room by specifying the meeting room on the reception terminal 7. The operation receiving unit 93b of the reception terminal 7 receives the operation. For example, when the user presses an “Enter” button of a meeting room reserved by the user, the reception terminal 7 displays an input screen. The user inputs meeting identification information on the input screen.

In S34, the operation receiving unit 93b of the reception terminal 7 receives the meeting identification information, and the server communication unit 91b transmits a request to use the meeting room to the meeting management server 30 by specifying the meeting room ID and the meeting identification information.

In S35, the receiving unit 31b of the meeting management server 30 receives the request to use the meeting room. If the meeting room ID and the meeting identification information transmitted from the reception terminal 7 are registered in the meeting identification information DB 494, the check-in management unit 38 permits the use of the meeting room. The check-in management unit 38 changes the status of the meeting room to “checked-in” in the meeting management information DB 493. Further, the check-in management unit 38 removes an automatic cancellation task. The transmitting unit 31a transmits the updated reservation information to the reception terminal 7.

In 36, the server communication unit 91b of the reception terminal 7 receives the updated reservation information in which the status is changed to “checked-in”. The display control unit 94b changes the status field 732a to “in use”. The status “in use” means that meeting room is currently used.

As described above, the administrator groups a plurality of meeting rooms together, and the reception terminal 7 stores a group ID and acquires reservation information based on the group ID. Accordingly, the one reception terminal 7 can receive operations for starting the use of (checking in to) and ending the use of (checking out of) the plurality of meeting rooms.

### <<Example Screens>>

FIG. 11 depicts an example of the login screen 530 displayed by the registration terminal 50. The login screen 530 includes an email address field 531 and a “next” button 532. The administrator inputs an email address (corresponding to a user ID) in the email address field 531, and presses the “next” button 532. As a result, a password input screen is displayed. By inputting the correct password, the administrator can log in to the meeting management server 30. When the administrator successfully logs in, an initial screen 540 of FIG. 12 is displayed.

FIG. 12 depicts an example of the initial screen 540 displayed by the registration terminal 50. The initial screen 540 includes a menu field 411 and a status field 541. The menu field 411 includes a number of buttons. The initial screen 540 is displayed with a dashboard 544 being selected. While the “dashboard” originally refers to an automotive instrument panel, in the present embodiment, the “dashboard 544” refers to a list of important information. For example, the status field 541 displays information 542 indicating a meeting room where disconnection occurs, and information 543 indicating meeting rooms for which permission (license) to acquire reservation information needs to be set. When a “manage groups” button 413 in the menu field 411 is pressed, the groups list screen 410 of FIG. 13 is displayed.

FIG. 13 depicts an example of the groups list screen 410 displayed by the registration terminal 50. The groups list screen 410 includes a menu field 411, a group display field 412, and a “create new” button 415. When the “manage groups” button 413 is pressed, a list of groups is displayed in the group display field 412. The group display field 412 displays a list of groups 414 already registered in the meeting room setting information DB 498 of the meeting management server 30.

The list of groups 414 includes items such as a group name 414a, the number of meeting rooms 414b, an “image code/URL” button 414c, an “edit” button 414d, and a “delete” button 414e. The group name 414a and the number of meeting rooms 414b (the number of meeting rooms associated with the same group ID) are transmitted from the meeting management server 30. The image code/URL 414c button is a button allowing the administrator to select “image code” or “URL” to acquire the group ID. The “edit” button 414d is a button allowing the administrator to delete or add a meeting room from or to an already created group. The “delete” button 414e is a button allowing the administrator to delete a group.

When the administrator presses the create new button 415, the groups list screen 410 transitions to the new group creation screen 420 of FIG. 14.

FIG. 14 depicts an example of the new group creation screen 420 displayed by the registration terminal 50. The new group creation screen 420 includes a menu field 411 and a group name field 421. The group name field 421 includes a group name input field 422, an “add meeting rooms” button 423 a “save” button 424, and a “cancel” button 425. The group name input field 422 is a field in which the administrator inputs a group name of a group. The “add meeting rooms” button 423 is a button allowing the administrator to add meeting rooms to the group. The “save” button 424 is a button allowing the administrator to save group information. The “cancel” button 425 is a button allowing the administrator to cancel the creation of the group.

When the administrator presses the “add meeting rooms” button 423, the new group creation screen 420 transitions to the meeting rooms list screen 430 of FIG. 15.

FIG. 15 depicts an example of the meeting rooms list screen 430 displayed by the registration terminal 50. The meeting rooms list screen 430 includes a menu field 411 and a meeting rooms list field 431. The meeting rooms list field 431 includes a filter 432, a meeting rooms list table 433, a “complete” button 434 and a “cancel” button 735. The filter 432 receives settings for filtering meeting rooms to be displayed in the meeting rooms list table 433. The filter 432 includes a search field 432a, a resource group field 432b, an operation rule field 432c, and a connection state field 432e. The administrator can use these field to narrow down meeting rooms to be displayed in the meeting rooms list table 433. The filter settings correspond to the items of the meeting room setting information DB 498.

The meeting rooms list table 433 includes items such as a checkbox 433a, a meeting room 433b, a resource group 433c, an operation rule 433d, and a connection state 433e. In the checkbox 433a, the administrator selects meeting rooms to be included in the group. Information displayed in the other items is information registered in the meeting room setting information DB 498. Specifically, the connection state 433e displays connection states registered in the meeting room setting information DB 498. If the connection state of a meeting room indicates “connected”, the initial settings are completed (the meeting room terminal 90 is installed in the meeting room or the meeting room belongs to another group), but this does not pose a problem.

The “complete” button 434 is a button allowing the administrator to complete the selection of meeting rooms. The “cancel” button 735 is a button allowing the administrator to cancel the selection of meeting rooms and return to the new group creation screen 420.

When the administrator presses the “complete” button 434, the new group creation screen 420 transitions to the group registration confirmation screen 440 of FIG. 16.

FIG. 16 depicts an example of the group registration confirmation screen 440 displayed by the registration terminal 50. The group registration confirmation screen 440 includes a menu field 411 and a selected meeting room display field 441. The selected meeting room display field 441 includes a group name input field 442, a meeting rooms list 443, an “add meeting rooms” button 444, a “save” button 455, and a “cancel” button 446. The group name input field 442, the “add meeting rooms” button 444, the “save” button 455, and the “cancel” button 446 are same as those of the new group creation screen 420 of FIG. 14. The meeting rooms list 443 displays the meeting rooms (meeting room names or meeting room IDs) selected on the new group creation screen 420 of FIG. 15.

When the administrator presses the “save” button 455, the group registration confirmation screen 440 transitions to the groups list screen 450 of FIG. 17.

FIG. 17 depicts an example of the groups list screen 450 displayed by the registration terminal 50. The configuration of the groups list screen 450 of FIG. 17 is the same as that of the groups list screen 410 of FIG. 13, except that the group name entered in the group name input field 422 is displayed in the group name 414a. In this manner, the administrator can register the group.

When the administrator presses the “image code/URL” button 414c, the groups list screen 450 transitions to the image code display screen 460 of FIG. 18A or FIG. 18B.

FIG. 18A depicts an example of the image code display screen 460 displayed by the registration terminal 50. The image code display screen 460 displays a URL 463, and a message 462, “please press the capture button of the reception application and read the image code”. As described above, the image code 461 includes the group ID and the group name (the authentication keys of the respective meeting rooms and the server URL may be included). Further, the URL 463 is a connection destination (address) used by the meeting management server 30 to identify the group ID when the reception terminal 7 connects to the meeting management server 30. For example, the group ID is included as a URL query parameter. Alternatively, the meeting management server 30 may retain the URL associated with the group ID. When the reception terminal 7 connects to the meeting management server 30 by specifying the URL, the reception terminal 7 can acquire the authentication keys and the server URL associated with the group ID from the meeting management server 30. By including the URL 463, the administrator can configure the initial settings for the reception terminal 7 even when the reception terminal 7 does not have a camera.

FIG. 18B depicts another example of the image code display screen 460 displayed by the registration terminal 50. In FIG. 18B, only the image code 461 is displayed. For example, if the administrator explicitly requests for the image code only (“image code” of the “image code/URL” button 414c is pressed), the registration terminal 50 can display the image code only.

FIG. 19 depicts an example of the startup screen 470 displayed by the reception terminal 7. The startup screen 470 includes a setting button 471, and displays a message 472 “please press the setting button to capture the image code”. If the group ID is not stored in the storage unit 99b, the display control unit 94b of the reception terminal 7 displays the message 472. With the message 472, the administrator is prompted to capture the image code. If the group ID is stored in the storage unit 99b, the display control unit 94b displays a message, “if you want to add or set the group, please press the setting button to capture the image code”. With the message, the administrator is prompted to capture the image code.

When the administrator presses the setting button 471, the startup screen 470 transitions to the group settings screen 480 of FIG. 20.

FIG. 20 depicts an example of the group settings screen 480 displayed by the reception terminal 7. The group settings screen 480 includes a group name field 481, a URL field 482, a “capture” button 483, a “complete” button 484, and a “cancel” button 485. The group name field 481 is blank immediately after the group settings screen 480 is displayed. After the image code is captured, the decoded group name is displayed in the group name field 481. The URL field 482 is a field in which the administrator inputs a URL. The “capture” button 483 is a button allowing the reception terminal 7 to capture the image code. The “complete” button 484 is a button allowing the reception terminal 7 to store the group ID and other information in the storage unit 99b. The “cancel” button 485 is a button for returning to the startup screen 470.

When the administrator presses the “complete” button 484, the reception terminal 7 stores the group ID and other information in the storage unit 99b. Then, the reception terminal 7 acquires reservation information of the meeting rooms associated with the group ID by specifying the group ID. Aa a result, the standby screen 490 of FIG. 21 is displayed.

FIG. 21 depicts an example of the standby screen 490 displayed by the reception terminal 7. The standby screen 490 includes a group name field 731 and a reservation information field 732. The group name displayed in the group name field 731 is stored in the storage unit 99b. The reservation information field 732 displays the reservation information of the respective meeting rooms. The reservation information is transmitted from the meeting management server 30. One row in the reservation information field 732 displays reservation information of one meeting room. The reservation information field 732 includes items such as a status field 732a, a meeting room name field 732b, a reservation time field 732c, a user name field 732d, and an operation button field 732e. The user name field 732d displays the name of a user who made a reservation. The status field 732a displays “vacant”, “waiting for entry”, or “in use” in accordance with the status in the management information DB 493. The display control unit 94b of the reception terminal 7 updates the status field 732a in accordance with the status in the management information DB 493. The status “vacant” is a status that is not either “waiting for entry” or “in use”. The status “waiting for entry” indicates that a check-in is possible (for a period of time before a start time until an automatic cancellation time). The status “in use” indicates that a user is already checked in, and is not yet checked out.

Information displayed in the meeting room name field 732b, the reservation time (start time/end time) field 732c, and the user name field 732d is included in the reservation information. The operation button field 732e displays buttons in accordance with the status field 732a. For “vacant”, the display control unit 94b displays a “use now” button 733. For “waiting for entry”, the display control unit 94b displays an “enter” button 734. For “in use”, the display control unit 94b displays an “extend” button 735 and a “leave” button 736. If extending a meeting is not possible (if a period of time less than a predetermined period of time remains before the start time of the next reservation), the “extend” button 735 is not displayed. When the “use now” button 733 is pressed, the reception terminal 7 indicates that the “use now” button 733 is pressed to the meeting management server 30. Then, the meeting management server 30 communicates with the reservation management server 20, and reserves a corresponding meeting room for a certain period of time with the meeting management server authority. The meeting room is supposed to be available for the certain period of time based on the reservation information. Thus, the reservation management server 20 indicates the completion of the reservation to the meeting management server 30. The meeting management server 30 transmits the “checked in” status to the reception terminal 7, together with the meeting room ID. Then, the reception terminal 7 displays the “in use” in the status field 732a. When the “enter” button 734 is pressed, a meeting identification information input field is displayed. The meeting identification information is notified to the user who made the reservation.

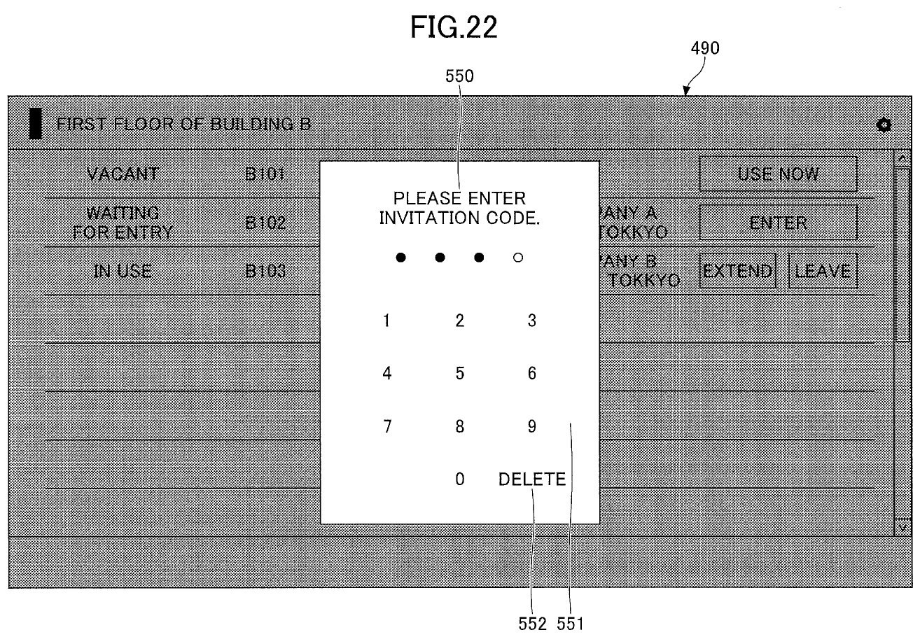

FIG. 22 is a diagram illustrating an example of the standby screen 490 on which a meeting identification information input field 550 is displayed. The meeting identification information input field 550 includes a numeric keypad 551. The user operates the numeric keypad 551 to input meeting identification information. When the user inputs incorrect meeting identification information, the user can use a “delete” button 552 to correct the meeting identification information. Before the user inputs meeting identification information, a cancel button is being displayed instead of the “delete” button 552. For example, the meeting identification information may include 4 digits. When the user completes the input of the meeting identification information, the meeting room ID and the meeting identification information are transmitted to the meeting management server 30.

When the meeting identification information and the meeting room ID are successfully verified, the status in the meeting management information DB 493 is changed to “checked in”. As a result, the status “waiting for entry” is changed to the status “in use” in the status field 732a. In this manner, the user can be prevented from entering a wrong meeting room.

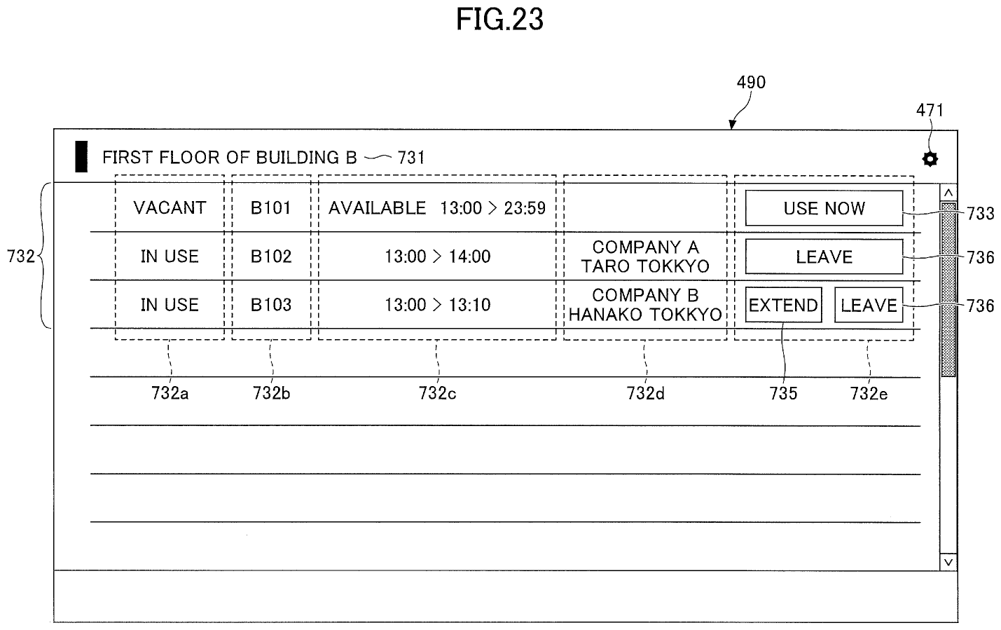

FIG. 23 is a diagram illustrating an example of the standby screen 490 on which the status of a meeting room B102 is changed to “in use” in the status field 732a. In addition, the “leave” button 736 is displayed.

When the “extend” button 735 is pressed in FIG. 21, a corresponding meeting room is reserved for a certain period of time, similar to the “use now” button 733. When the “leave” button 736 is pressed, the reception terminal 7 transmits a check-out request to the meeting management server 30. As a result, the status in the meeting management information DB 493 is changed to “checked out.” The “checked out” status is transmitted to the reception terminal 7, together with the meeting room ID. Therefore, the reception terminal 7 displays “vacant” or “waiting for entry” in the status field 732a. It may be preferable for the reception terminal 7 to display a confirmation screen when the “leave” button 736 is pressed. Accordingly, the user can be prevented from mistakenly pressing the “leave” button 736 of another meeting room. For example, an input screen for meeting identification information may be displayed.

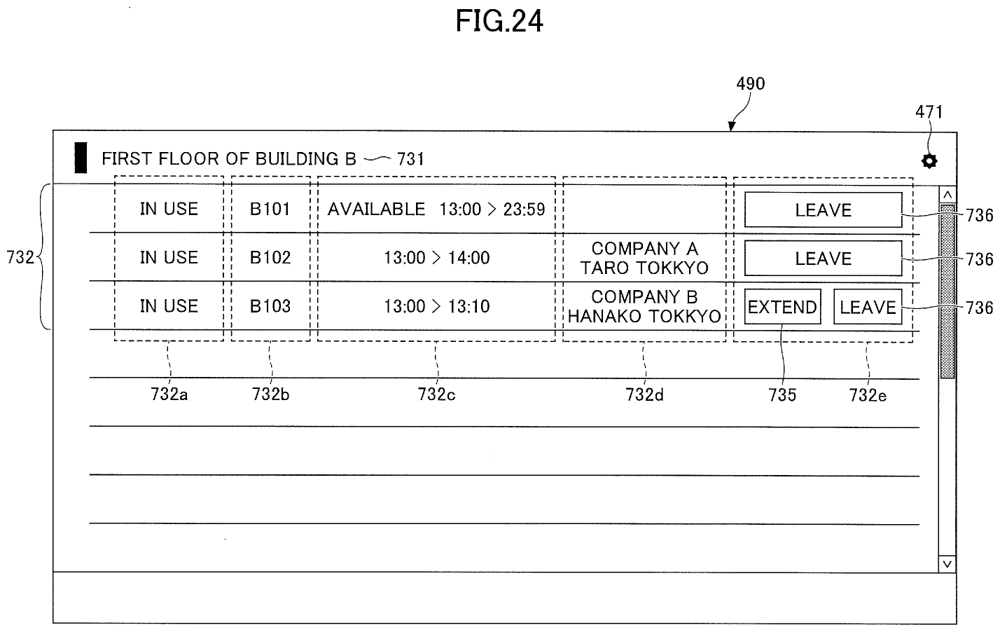

FIG. 24 through FIG. 27 are diagrams illustrating screen transitions. FIG. 24 depicts the standby screen 490 displayed when the user presses the “use now” button of a vacant meeting room “B101” illustrated in FIG. 23. When the user presses the “use now” button of the vacant meeting room “B101” illustrated in FIG. 23, the “in use” status is displayed in the status field 732a, and the user can use the meeting room “B101”.

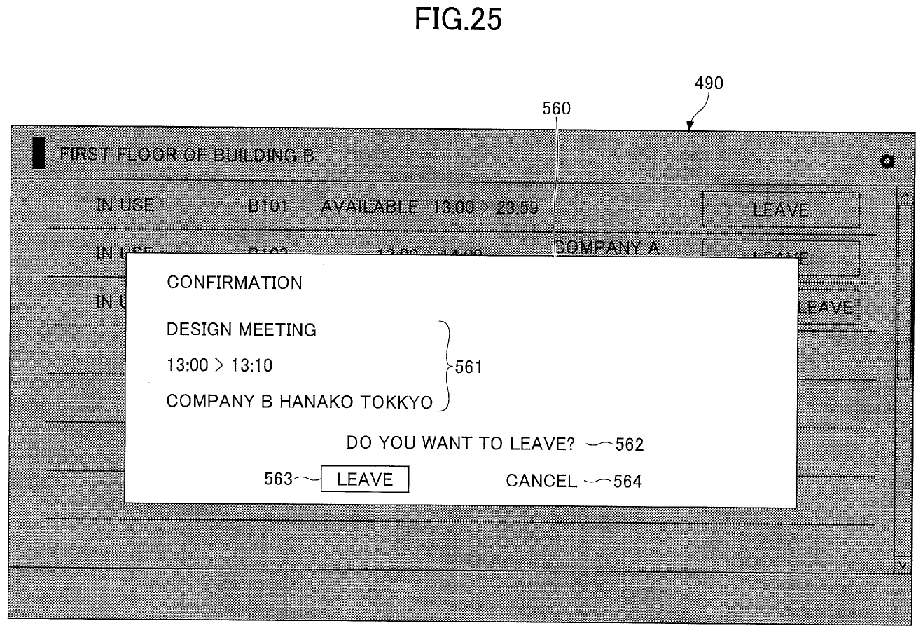

FIG. 25 is a diagram illustrating an example of a confirmation screen 560 displayed when the “leave” button 736 illustrated in FIG. 24 is pressed. The confirmation screen 560 includes reservation information 561, a message “do you want to leave this meeting room?”, a “leave” button 563, and a “cancel” button 564. The user determines whether to leave the meeting room by looking at the reservation information 561, and presses either the “leave” button 563 or the “cancel” button 564. When the “cancel” button 564 is pressed, the screen returns to the original standby screen without any change in the status field 732a. When the “leave” button 563 is pressed, a meeting identification information input field may be displayed.

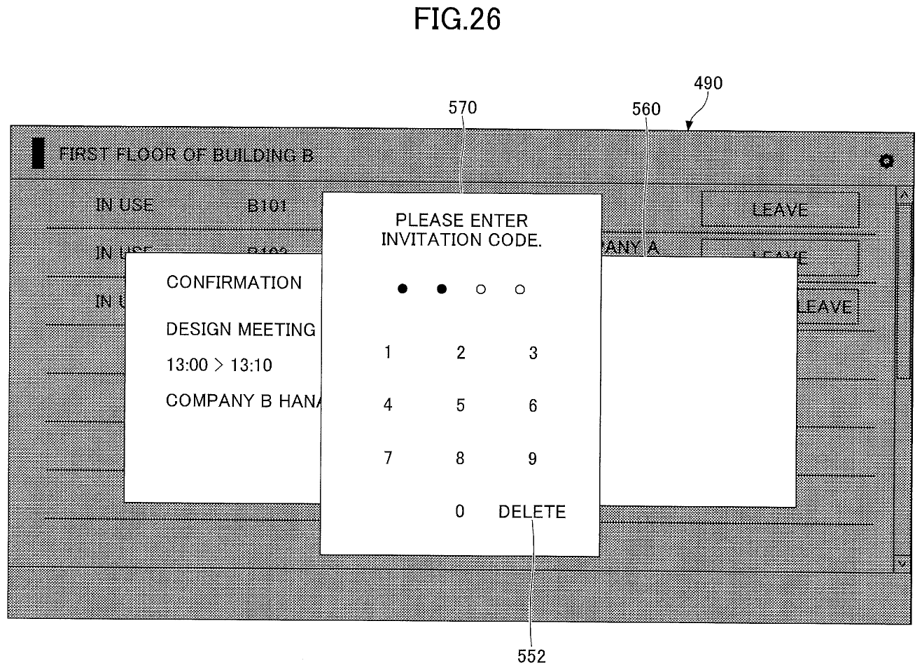

FIG. 26 is an example of the confirmation screen 560 on which a meeting identification information input field 570 is displayed. When the user leaves the meeting room, the reception terminal 7 requests the user to input meeting identification information (authentication information) in this input field 570. Accordingly, when the user mistakenly presses the “leave” button 563 of another meeting, the meeting management server 30 is prevented from performing a leaving process.

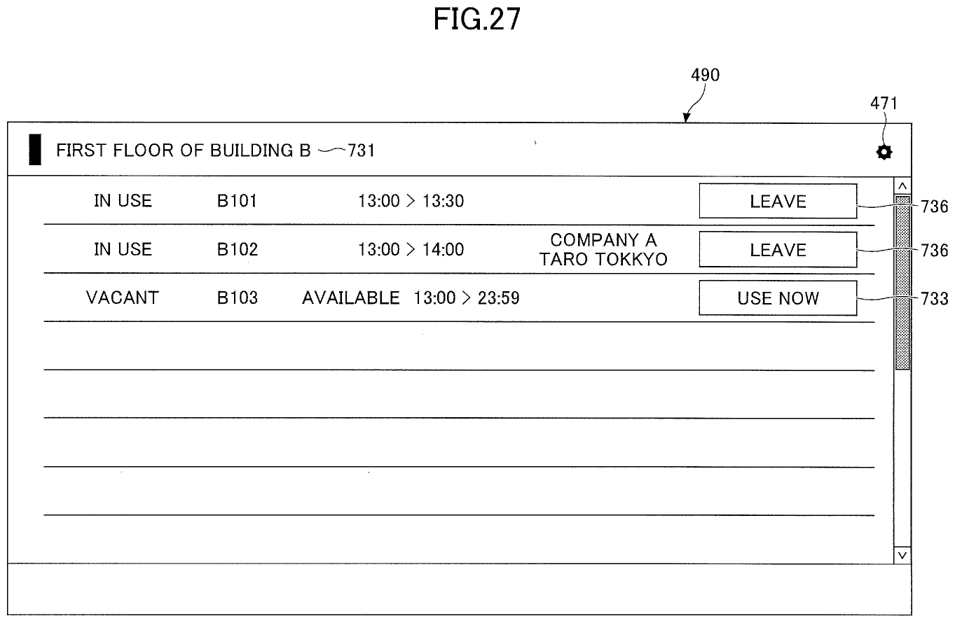

FIG. 27 is a diagram illustrating an example of the standby screen 490 after the leaving process is performed. In the status field 732a, the “in use” status of a meeting room B103 in FIG. 24 is changed to “vacant” in FIG. 27. In addition, the “use now” button 733 is displayed, thus allowing another user to use the meeting room B103.

### <When Administrator Inputs URL on Screen Displayed by Reception Terminal and Stores Group ID>

An example in which the administrator causes the reception terminal 7 to capture the image code has been described with reference to FIG. 10. In the following, an example in which the administrator inputs a URL on a screen displayed by the reception terminal 7 and stores a group ID will be described. This method is effective when the reception terminal 7 does not have a camera.

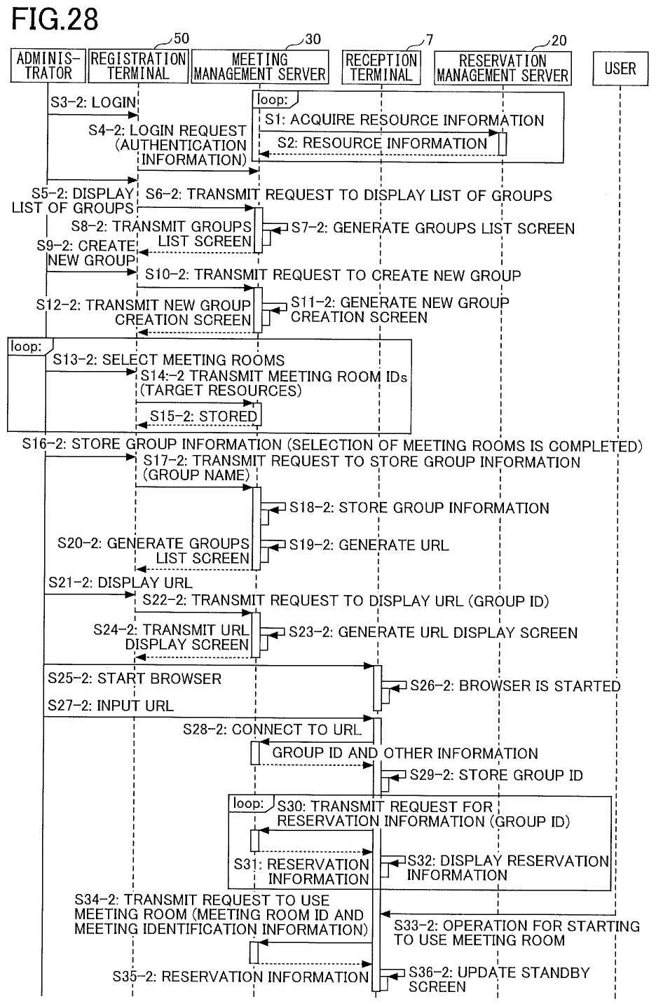

FIG. 28 is a sequence diagram illustrating an example of a process for storing a group ID by the reception terminal 7. In the description of FIG. 28, differences from the process of FIG. 10 will be mainly described. First, steps S1 through S18-2 are similar to steps S1 through S18 of FIG. 10.

In S19-2, the URL generating unit 396 creates a URL including the group ID or creates a URL associated with the group ID. Therefore, the meeting management server 30 can identify the group ID when the reception terminal 7 connects to the URL.

In S20-2, the transmitting unit 31a indicates the completion of storing the group information to the registration terminal 50. In addition, the setting screen generating unit 391 refers to the meeting room setting information DB 498 and generates screen information of a groups list screen, and the transmitting unit 31a transmits the screen information of the groups list screen to the registration terminal 50. The registration terminal 50 displays the groups list screen 450 received from the meeting management server 30 (FIG. 17).

In 21-2, administrator performs an operation to display the URL by specifying the group on the groups list screen 450. For example, the administrator presses “URL” of the “image code/URL” button on the groups list screen 450 of FIG. 17.

In S22-2, the operation receiving unit 52 of the registration terminal 50 receives the operation, and the communication unit 51 transmits a request to display the URL to the meeting management server 30 by specifying the group ID.

In S23-2, the receiving unit 31b of the meeting management server 30 receives the request to display the URL. The setting screen generating unit 391 generates screen information of a URL display screen that displays the URL associated with the group ID. Note that the URL may be generated by the URL generating unit 396 at this timing. In this case, if the group name or the meeting rooms are changed, the URL can be created by using the changed group name or the changed meeting rooms.

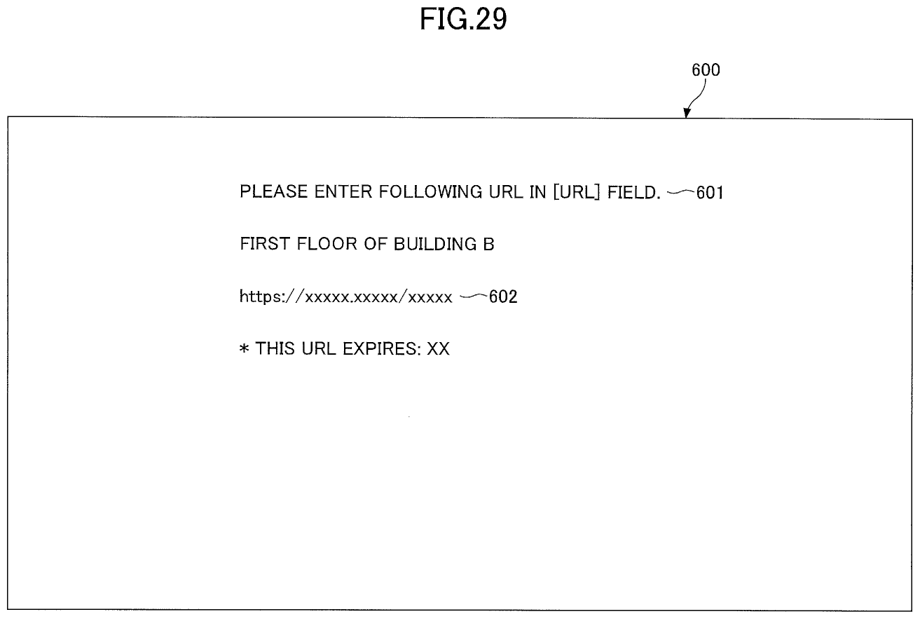

In S24-2, the transmitting unit 31a of the meeting management server 30 transmits the screen information of the URL display screen to the registration terminal 50. The communication unit 51 of the registration terminal 50 receives the screen information of the URL display screen, and the display control unit 53 displays the URL display screen. FIG. 29 is a diagram illustrating an example of an URL display screen 600.

In S25-2, next, in order to connect the reception terminal 7 to the server URL, the administrator operates the reception terminal 7 and starts the reception application (if the reception application is not started). The administrator is not required to log in to the reception terminal 7 because the administrator is already authenticated by the meeting management server 30. However, the administrator may be authenticated with the administrator password. In addition, the administrator starts the browser of the reception terminal 7.

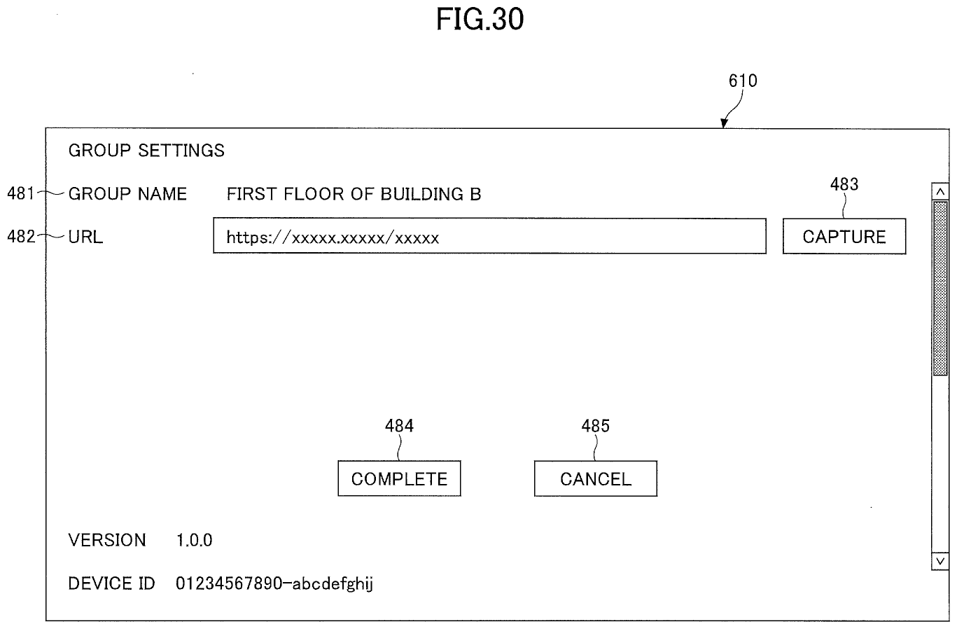

In S26-2, the reception terminal 7 displays a startup screen. The startup screen of the reception application may be similar to that of FIG. 19. The administrator operates the reception application to display a URL input screen. FIG. 30 is a diagram illustrating an example of a URL input screen 610.

In S27-2, the administrator inputs the URL on the URL input screen 610 displayed by the reception terminal 7.

In S28-2, the server communication unit 91b of the reception terminal 7 connects to the meeting management server 30 with the URL as a destination. The URL generating unit 396 of the meeting management server 30 identifies the group ID based on the URL. The transmitting unit 31a of the meeting management server 30 transmits the group ID and the group name registered in the meeting room setting information DB 498 to the reception terminal (the authentication keys and the URL of the meeting management server may also be transmitted).

In S29-2, the server communication unit 91b of the reception terminal 7 receives the group ID and the group name (the authentication keys and the URL of the meeting management server), and the setting storage unit 98-2b stores the group ID and the group name (the authentication keys and the URL of the meeting management server) in the storage unit 99b. Accordingly, the display control unit 94b of the reception terminal 7 displays the group name on the URL input screen 610. Subsequent step are similar to those of FIG. 10.

As described above, even when the reception terminal 7 does not have a camera, the administrator can group a plurality of meeting rooms together, and the reception terminal 7 can store a group ID of the meeting rooms and acquire reservation information based on the group ID. Accordingly, the one reception terminal 7 can receive operations for starting the use of (checking in to) and ending the use of (checking out of) the plurality of meeting rooms. Note that the URL may be used to store the group ID even when the reception terminal 7 has a camera.

### <Example of Screen Transitions>

FIG. 29 is a diagram illustrating an example of the URL display screen 600 displayed by the registration terminal 50. The URL display screen 600 includes a message 601, “please enter the following URL into a URL field”, and a URL 602. When the message 601 is displayed, the administrator can input the URL 602 into the URL field of the reception terminal 7.

FIG. 30 is a diagram illustrating an example of the URL input screen 610 displayed by the reception terminal 7. The configuration of the URL input screen 610 is the same as that of the group settings screen 480 of FIG. 20. The URL input screen 610 includes a group name field 481, a URL field 482, a “capture” button 483, a “complete” button 484, and a “cancel” button 485. The group name field 481 is blank immediately after the URL input screen 610 is displayed. After the reception terminal 7 is connected to the URL input into the URL field 482, the group name transmitted from the meeting management server 30 is displayed in the group name field 481. The URL field 482 is a field in which the administrator inputs the URL. The “capture” button 483 is a button allowing the reception terminal 7 to capture an image code. Therefore, the reception terminal 7 can also capture an image code. The “complete” button 484 is a button allowing the reception terminal 7 to store the group ID and other information in the storage unit 99b. The “cancel” button 485 is a button for returning to the startup screen.

### <Effects>

As described above, in the resource reservation system 100 according to the present embodiment, a general-purpose information processing apparatus can be used as the reception terminal 7. Further, the administrator can use an image code or a URL to readily configure the initial settings. Further, the reception terminal 7 can be shared by a plurality of meeting rooms. The reception terminal 7 can display reservation information of the plurality of meeting rooms, and users can use the one reception terminal 7 to check in to and check out of the meeting rooms.

### Second Embodiment

In the first embodiment, the meeting management server 30 associates meeting rooms with a group ID and manages the meeting rooms. In the resource reservation system 100 according to the second embodiment, the reception terminal 7 can display reservation information of a plurality of meeting rooms and receive operations for checking in to and checking out of the meeting rooms, without the meeting management server 30 associating the meeting rooms with a group ID.

The hardware configurations of FIG. 5 and FIG. 6 and functional block diagrams of FIG. 7 through FIG. 9 according to the first embodiment can be employed in the second embodiment, and differences between the first embodiment and the second embodiment will be mainly described.

### <Functions>

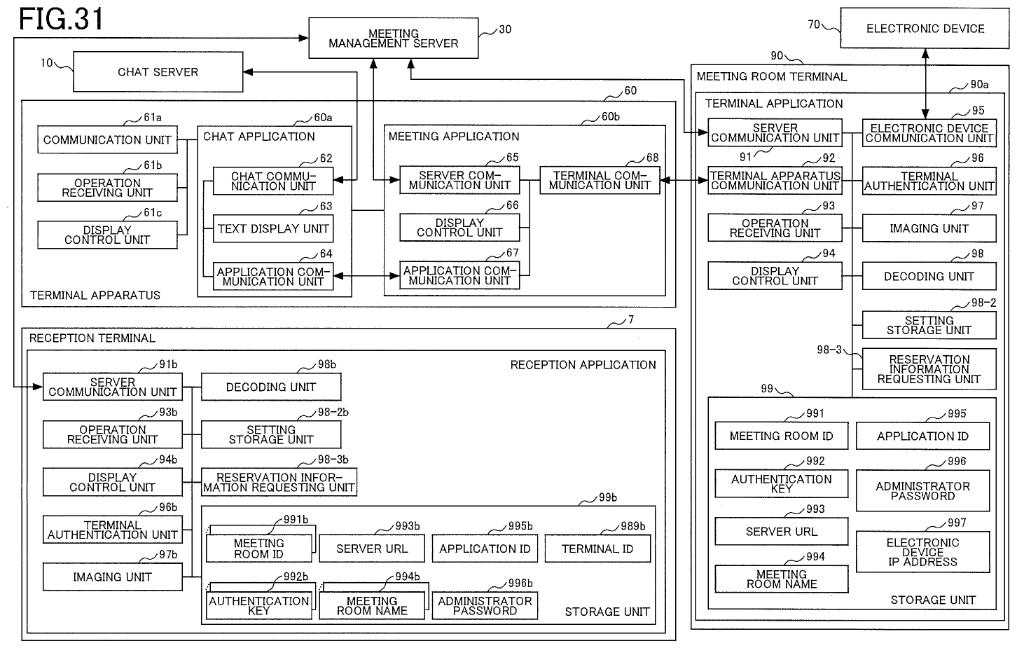

FIG. 31 is a functional block diagram illustrating functions of the terminal apparatus 60, the meeting room terminal 90, and the reception terminal 7. The functions of the electronic device 70 will be described as necessary. The same elements are denoted by the same reference numerals in FIG. 8 and FIG. 31. Thus, only the main elements of the present embodiment may be described.

In the present embodiment, information stored in the storage unit 99b of the reception terminal 7 differs from that of the first embodiment. That is, the storage unit 99b stores one or more meeting room IDs 991b, a server URL 993b, an administrator password 996b, authentication keys 992b for respective meeting rooms, and an application ID 995b, meeting room names 994b of the respective meeting rooms, and a terminal name 989b. That is, there is no concept of a “group”. the storage unit 99b stores information on a per meeting room basis. The terminal name 989b is the name of the reception terminal 7.

Therefore, information stored in the meeting room setting information DB 498 of the meeting management server 30 differs from that of the first embodiment. Table 11 indicates information stored in the meeting room setting information DB 498.

TABLE 11

| CUS- | MEETING | MEETING | CONNEC- | AUTHEN- | MANAGEMENT | RE- | OPER- |
|---|---|---|---|---|---|---|---|
| TOMER | ROOM | ROOM | TION | TICATION | START | SOURCE | ATION |
| ID | NAME | ID | STATE | KEY | FLAG | GROUP | RULE |
| G-001 | A-1 | A101 | CONNECTED | ***** | TRUE | MEETING | DEFAULT |
| | | | | | | ROOM IN | |
| | | | | | | BUILDING A | |
| | A-2 | A102 | CONNECTED | ***** | FALSE | MEETING | DEFAULT |
| | | | | | | ROOM IN | |
| | | | | | | BUILDING A | |
| | A-3 | A103 | BEFORE | ***** | FALSE | MEETING | GUEST |
| | | | SETUP | | | ROOM IN | |
| | | | | | | BUILDING A | |
| | A-4 | A104 | DIS- | ***** | TRUE | MEETING | EXECUTIVE |
| | | | CONNECTED | | | ROOM IN | |
| | | | | | | BUILDING A | |
| | B-1 | B101 | CONNECTED | **** | FALSE | MEETING | DEFAULT |
| | | | | | | ROOM IN | |
| | | | | | | BUILDING B | |
| | B-2 | B102 | CONNECTED | **** | FALSE | MEETING | DEFAULT |
| | | | | | | ROOM IN | |
| | | | | | | BUILDING B | |
| | B-3 | B103 | CONNECTED | **** | FALSE | MEETING | DEFAULT |
| | | | | | | ROOM IN | |
| | | | | | | BUILDING B | |
| | B-4 | B104 | CONNECTED | **** | FALSE | MEETING | DEFAULT |
| | | | | | | ROOM IN | |
| | | | | | | BUILDING B | |

As indicated in Table 11, there are no items “group ID” and “group name” in the present embodiment. The reservation information transmitting unit 44 of the meeting management server 30 returns reservation information of requested meeting rooms.

### <Screen Transitions and Process for Storing One or More Meeting Room IDs by Reception Terminal>

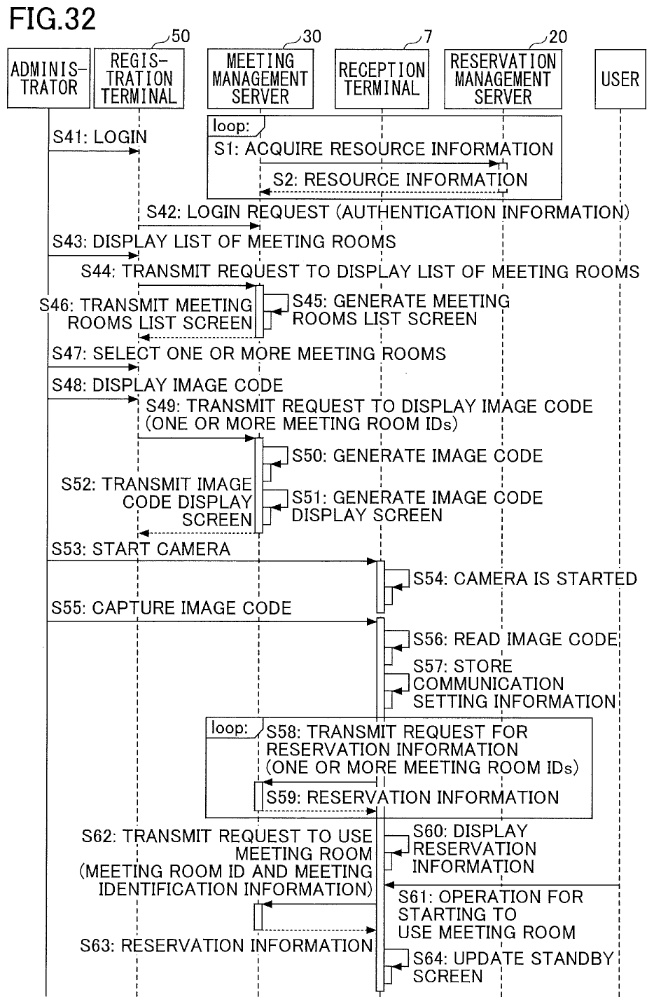

Next, screen transitions and a process for storing one or more meeting room IDs by the reception terminal 7 will be described with reference to FIG. 32 through FIG. 40. FIG. 32 is a sequence diagram illustrating an example of a process for storing one or more meeting room IDs by the reception terminal 7.

Steps S1 and S2 may be the same as those of FIG. 10.

In S41, the administrator who configures the initial settings for the reception terminal 7 starts the browser of the registration terminal 50 (or the administrator may start a dedicated application), and performs an operation to log in to the meeting management server 30. For example, the administrator inputs a user ID and a password as authentication information.

In S42, the operation receiving unit 52 of the registration terminal 50 receives the authentication information, and the communication unit 51 transmits a login request to the meeting management server 30 by specifying the authentication information. The authentication unit 40 of the meeting management server 30 authenticates the administrator based on the login password and the user ID stored in the login information DB 499. As a result, the registration terminal 50 displays the initial screen (FIG. 12).

In S43, next, the administrator performs an operation to display a list of meeting rooms on the registration terminal 50. Displaying a list of meeting rooms refers to displaying a list of meeting rooms registered in the meeting room setting information DB 498 of the meeting management server 30.

In S44, the operation receiving unit 52 of the registration terminal 50 receives the operation, and the communication unit 51 transmits a request to display a list of meeting rooms to the meeting management server 30.

In S45, the receiving unit 31b of the meeting management server 30 receives the request to display a list of meeting rooms, and the setting screen generating unit 391 refers to the meeting room setting information DB 498 and generates screen information of a meeting rooms list screen.

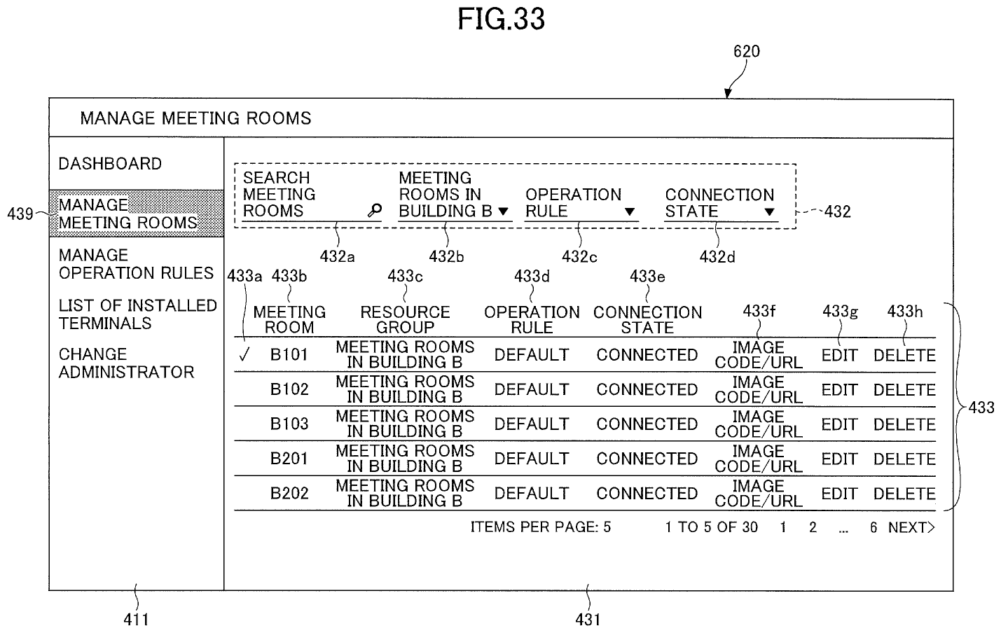

In S46, the transmitting unit 31a of the meeting management server 30 transmits the screen information of the meeting rooms list screen to the registration terminal 50. The communication unit 51 of the registration terminal 50 receives the screen information of the meeting rooms list screen, and the display control unit 53 displays the meeting rooms list screen. FIG. 33 is a diagram illustrating an example of a meeting rooms list screen 620.

In S47, on the meeting rooms list screen 620, the administrator selects one or more meeting rooms to be registered in the reception terminal 7. The administrator can select one meeting room or a plurality of meeting rooms at once.

In S48, after selecting the one or more meeting rooms, the administrator performs an operation to display an image code on the meeting rooms list screen 620. Note that an “image code/URL” button 433f on the meeting rooms list screen 620 may allow the administrator to press either “image code” or “URL”, or may allow the administrator to press both “image code” and “URL” together. In this example, it is assumed that both “image code” and “URL” are pressed together, or only “image code” is pressed.

In S49, the operation receiving unit 52 of the registration terminal 50 receives the operation, and the communication unit 51 transmits a request to display an image code to the meeting management server 30 by specifying one or more meeting room IDs.

In S50, the receiving unit 31b of the meeting management server 30 receives the request to display an image code. The image code generating unit 394 generates an image code that includes communication setting information including the one or more meeting room IDs (and one or more authentication keys, a server URL, and one or more meeting room names). Note that communication setting information is generated on a per meeting room basis.

In S51, next, the setting screen generating unit 391 generates screen information of an image code display screen that displays the image code.

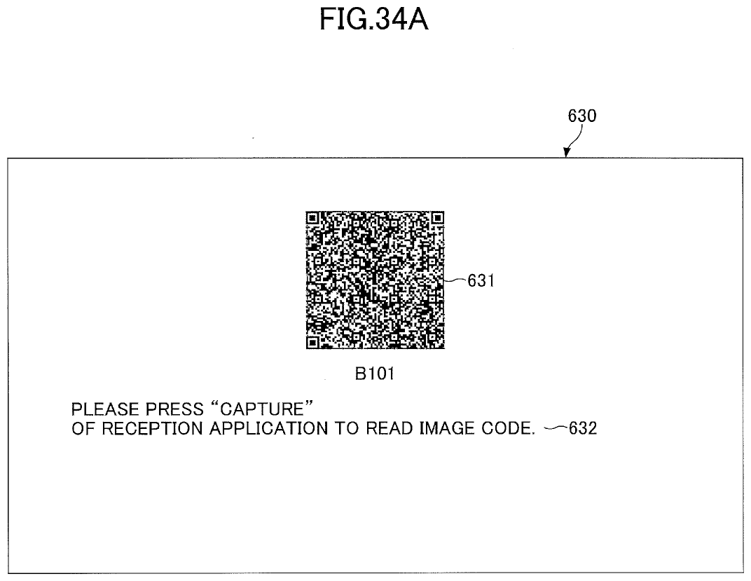

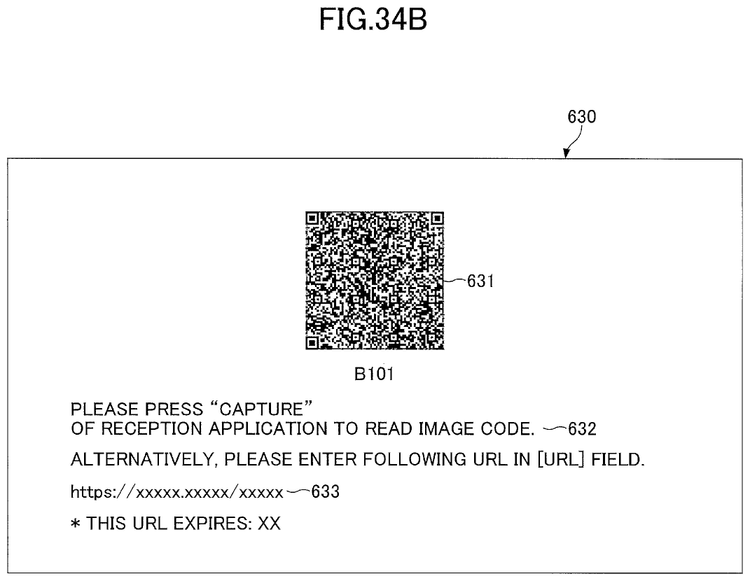

In S52, the transmitting unit 31a of the meeting management server 30 transmits the screen information of the image code display screen to the registration terminal 50. The communication unit 51 of the registration terminal 50 receives the screen information of the image code display screen, and the display control unit 53 displays the image code display screen. FIGS. 34A and 34B are diagrams illustrating examples of image code display screens 630.

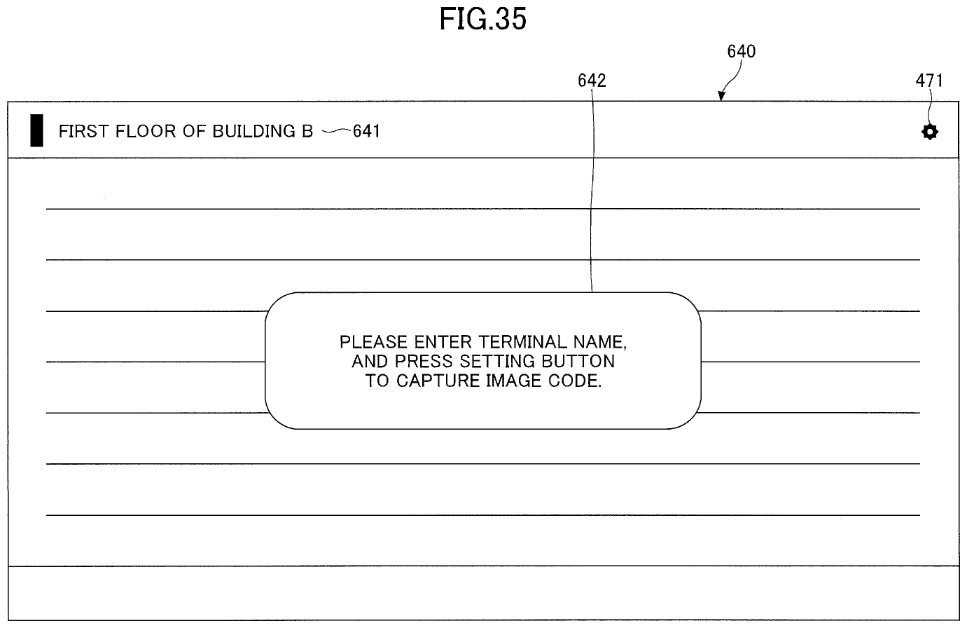

In S53, next, in order to connect the reception terminal 7 to the server URL, the administrator operates the reception terminal 7 and starts the reception application (if the reception application is not started). The administrator is not required to log in to the reception terminal 7 because the administrator is already authenticated by the meeting management server 30. However, the administrator may be authenticated with the administrator password. FIG. 35 is a diagram illustrating an example of a startup screen 640 for the reception application. The administrator operates the reception terminal 7 to start a camera, and causes the reception terminal 7 to capture the image code.

In S54, the camera of the reception terminal 7 is started, and is ready to capture the image code.

In S55, the administrator causes the reception terminal 7 to capture the image code. For example, the administrator operates the registration terminal 50 such that the image code is within the angle of view of the CMOS sensor 713.

In S56, the imaging unit 97b of the reception terminal 7 captures the image code as a video such that the image code can be automatically detected. The decoding unit 98b decodes the detected image code, and acquires the communication setting information.

In S57, the setting storage unit 98-2b of the reception terminal 7 stores the communication setting information in the storage unit 99b. Accordingly, the reception terminal 7 can acquire reservation information by specifying the one or more meeting room IDs. Note that if a meeting room ID is already stored, the decoding unit 98b determines whether to add or overwrite with a new meeting room ID. This determination process by the decoding unit 98b will be described later.

In S58, when the one or more meeting room IDs are stored, the reservation information requesting unit 98-3b of the reception terminal 7 transmits a request for reservation information by specifying the one or more meeting room IDs and the authentication keys, to the meeting management server 30 specified by the server URL. Thereafter, the reservation information requesting unit 98-3b repeatedly requests the reservation information. Note that the reservation information requesting unit 98-3b can request reservation information by specifying one meeting room ID at once or request reservation information by specifying a plurality of meeting room IDs at once. That is, a plurality of meeting room IDs can be included in one HTTP request. Therefore, the volume of communication can be reduced by minimizing communication overhead. In this case, the meeting management server 30 includes an application interface (AIP) supporting a plurality of meeting room IDs.

In S59, the receiving unit 31b of the meeting management server 30 receives the request for reservation information. If the authentication keys are successfully verified, and the management start flag associated with each of the one or more meeting room IDs in the meeting room setting information DB 498 is set to “true”, the receiving unit 31b of the meeting management server 30 acquires reservation information associated with the one or more meeting room IDs from the meeting management information DB 493. The transmitting unit 31a of the meeting management server 30 transmits the reservation information of the one or more meeting room IDs to the reception terminal 7.

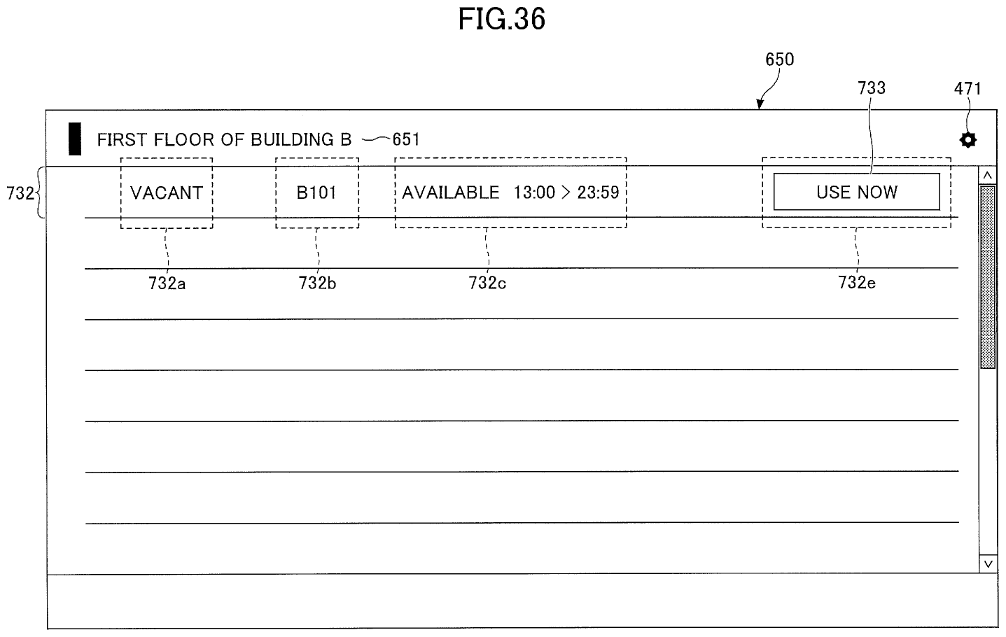

In S60, the server communication unit 91b of the reception terminal 7 receives the reservation information, and the display control unit 94b displays the reservation information on a standby screen. FIG. 36 is a diagram illustrating an example of a standby screen 650. Subsequent step are similar to those of FIG. 10.

Accordingly, the administrator can acquire the reservation information of the meeting rooms by specifying the respective meeting room IDs, without grouping the meeting rooms together. Thus, the one reception terminal 7 can receive operations for starting the use of (checking in to) and ending the use of (checking out of) the meeting rooms.

### <<Example Screens>>

FIG. 33 depicts an example of the meeting rooms list screen 620 displayed by the registration terminal 50. The meeting rooms list screen 620 includes a menu field 411 and a meeting rooms list field 431. When a “manage meeting rooms” button in the menu field 411 is pressed, the meeting rooms list field 431 is displayed. The meeting rooms list field 431 includes a filter 432 and a meeting rooms list table 433. The filter 432 may be similar to that of the meeting rooms list screen 430 of FIG. 15. The meeting rooms list table 433 includes items such as a checkbox 433a, a meeting room 433b, a resource group 433c, an operation rule 433d, and a connection state 433e, an “image code/URL” button 433f, an “edit” button 433g, and a “delete” button 433h. In the checkbox 433a, the administrator selects a meeting room for which to generate an image code. Information displayed in the meeting room 433b, the resource group 433c, and the operation rule 433d is information registered in the meeting room setting information DB 498.

The “image code/URL” button 433f is a button allowing the administrator to select “image code” or “URL” to acquire a meeting room ID. The edit button 433g is a button allowing the administrator to edit (delete or add) information related to a corresponding meeting room. The delete button 433h is button for allowing the administrator to delete information related to a corresponding meeting room.

When the administrator presses the “image code/URL” button 433f, the meeting rooms list screen 620 transitions to the image code display screen 630 of FIG. 34A or FIG. 34B.

FIG. 34A depicts an example of the image code display screen 630 displayed by the registration terminal 50. The image code display screen 630 includes an image code 631 and a message 632, “please press the capture button of the reception application and read the image code”. The image code 631 includes communication setting information. A meeting room ID is displayed below the image code 631.

FIG. 34B illustrates another example of the image code display screen 630 displayed by the registration terminal 50. In FIG. 34B, the image code 631 and a URL 633 are displayed. For example, if the administrator explicitly requests for the image code 631 and the URL 633, the registration terminal 50 can display the image code 631 and the URL 633.

FIG. 35 depicts an example of the startup screen 640 displayed by the reception terminal 7. The startup screen 640 includes a terminal name input field 641 and a setting button 471, and displays a message 472, “please input a terminal name, and press the setting button to capture the image code”. Because a terminal name (corresponding to a group name according to the first embodiment) is not registered in the meeting management server 30, the administrator inputs a terminal name in the terminal name input field 641. For example, if the terminal name 989b is not stored in the storage unit 99b, the display control unit 94b of the reception terminal 7 displays the message 642. With the message 642, the administrator is prompted to capture the image code. If the terminal name 989b is stored in the storage unit 99b, the display control unit 94b displays a message, “if you want to add or overwrite with the meeting room, please press the setting button to capture the image code”. With the message, the administrator is prompted to capture the image code.

When the administrator presses the setting button 471 to capture the image code, the reception terminal 7 stores the terminal name and the communication setting information. The reception terminal 7 displays reservation information acquired from the meeting management server 30.

FIG. 36 depicts an example of the standby screen 650 displayed by the reception terminal 7. The standby screen 650 includes a terminal name 651 and a reservation information field 732 of each meeting room. The terminal name 651 is stored in the storage unit 99b. The reservation information field 732 may be similar to that of FIG. 21.

<Determining Whether to Add or Overwrite with Meeting Room ID>

A general-purpose information processing terminal may be used as the meeting room terminal 90, or may be used as the reception terminal 7. However, the meeting room terminal 90 is dedicated to one meeting room. Thus, it is preferable for the meeting room terminal 90 to store one meeting room ID only. Conversely, the reception terminal 7 is shared by a plurality of meeting rooms. Thus, the reception terminal 7 is required to store a plurality of meeting room IDs. In view of the above, in the present embodiment, it is determined whether an information processing terminal is the reception terminal 7 or the meeting room terminal 90 based on whether an application running on the information processing terminal is the reception application or the terminal application.

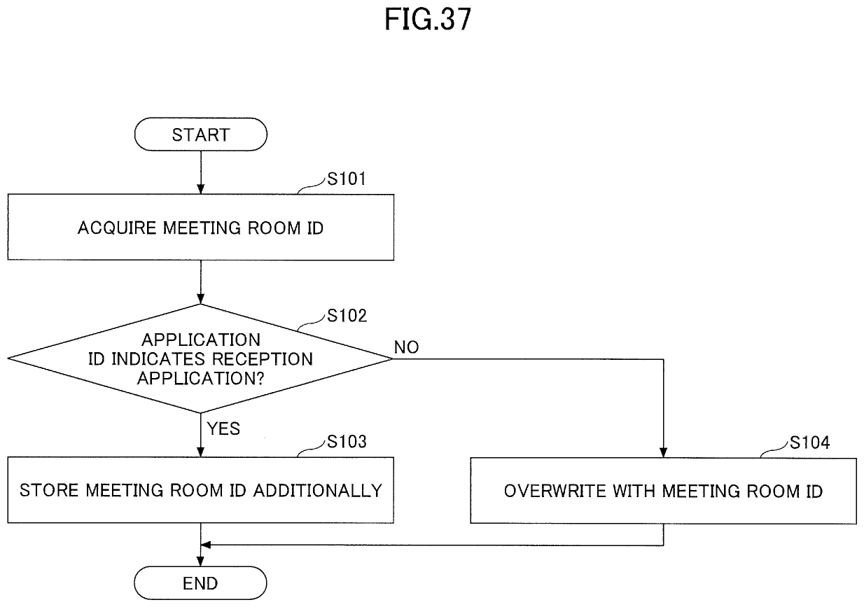

FIG. 37 is a flowchart illustrating an example of a process for storing a meeting room ID by the reception terminal 7. The process of FIG. 37 is performed in step S56 of FIG. 32.

The decoding unit 98b of the reception terminal 7 acquires a meeting room ID by decoding an image code (S101). The meeting room ID may be acquired from the meeting management server 30 based on a URL.

The decoding unit 98b determines whether the reception application is installed based on the application ID 995b stored in the storage unit 99b (S102). If the first or last one or more characters of the application ID 995b include predetermined numbers or alphabets, the decoding unit 98b determines that the reception application is installed. Otherwise, the decoding unit 98b determines that the terminal application is installed. Alternatively, instead of the application ID, the decoding unit 98b may use a name or a flag indicating the reception application or the terminal application to determine whether the reception application or the terminal application is installed.

If the reception application is installed on the reception terminal 7, the decoding unit 98b additionally store the meeting room ID in the storage unit 99b (S103).

If the terminal application is installed on the meeting room terminal 90, the decoding unit 98b overwrites with the meeting room ID (S104).

With the above-described process, the meeting room terminal 90 can store one meeting room ID only, while the reception terminal 7 can store a plurality of meeting room IDs.

<Screen Transitions when Meeting Room ID is Added>

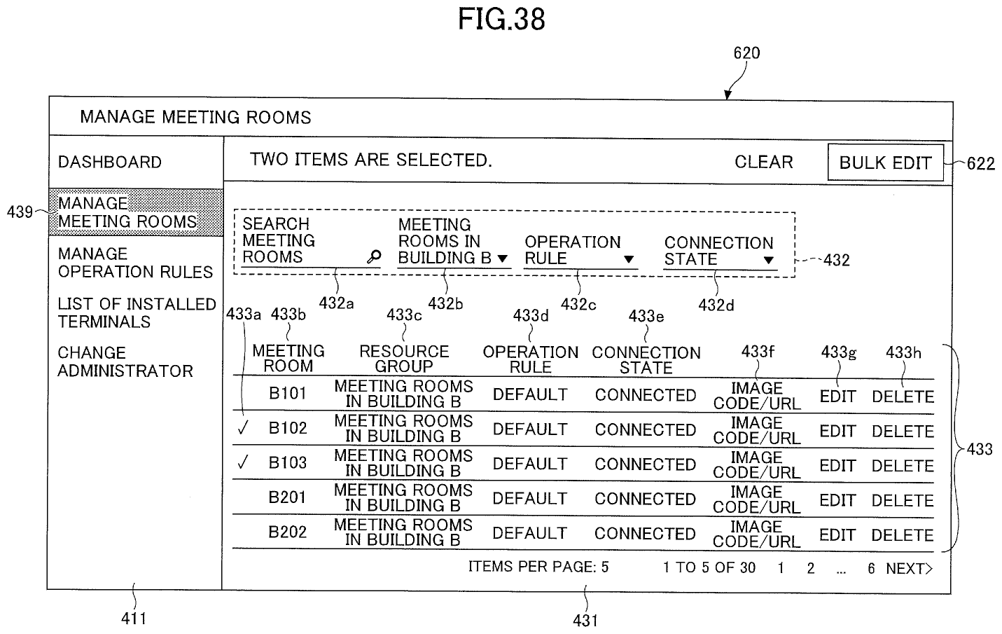

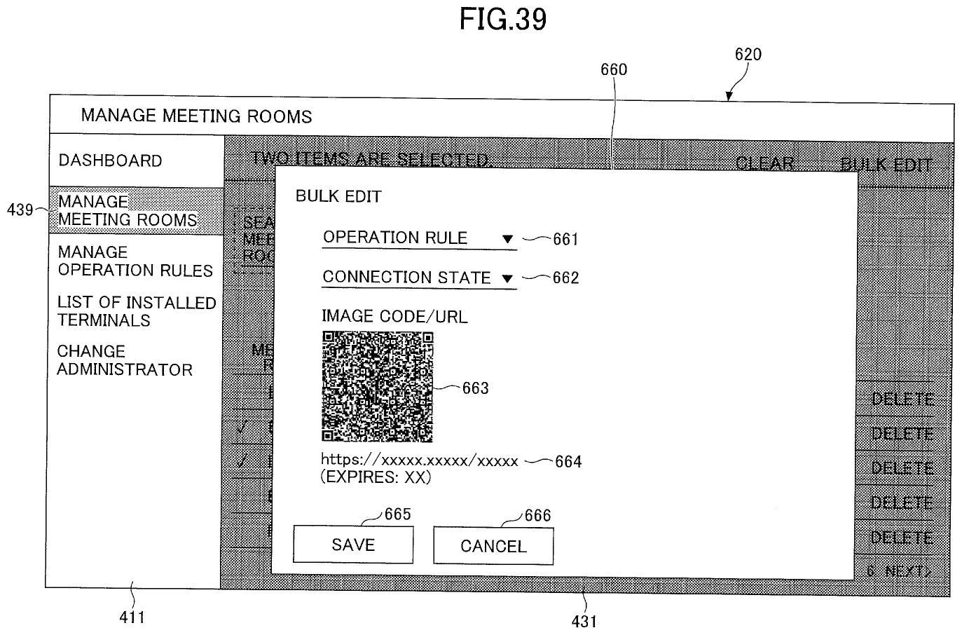

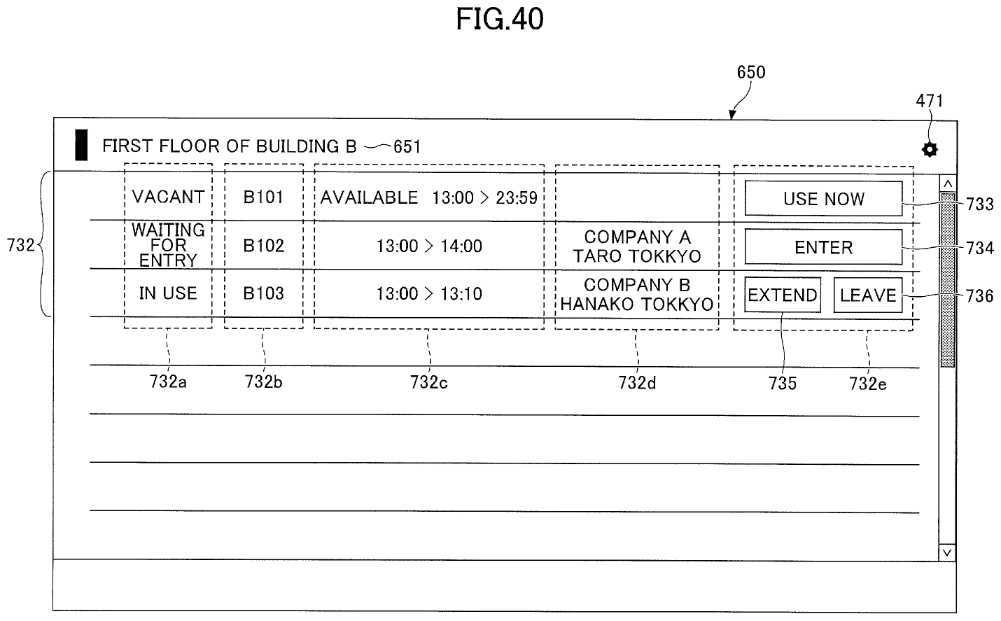

Referring to FIG. 38 through FIG. 40, example screen transitions when a meeting room ID is added will be described. FIG. 38 is a diagram illustrating an example of the meeting rooms list screen 620. FIG. 39 is a diagram illustrating an example of a bulk edit screen 660. FIG. 40 is a diagram illustrating an example of the standby screen 650.

The meeting rooms list screen 620 of FIG. 38 is similar to that of FIG. 33. Thus, differences between the meeting rooms list screen 620 of FIG. 38 and the meeting rooms list screen 620 of FIG. 33 are described. When the administrator selects a plurality of meeting rooms on the meeting rooms list screen 620, the display control unit 94b displays a “bulk edit” button 622. In FIG. 38, two meeting rooms are selected. The “bulk edit” button 622 is a button allowing the administrator to edit settings for a plurality of meeting rooms at once. When the “bulk edit” button 622 is pressed, the bulk edit screen 660 is displayed.

The bulk edit screen 660 of FIG. 39 includes an operation rule 661, a connection state 662, an image code 663, a URL 664, a “save” button 665, and a “cancel” button 666. The operation rule 661 is an item for changing operations rules associated with the selected meeting rooms at once. The image code 663 is generated by the meeting management server 30. The image code includes communication setting information of the respective meeting rooms. The URL 664 is transmitted from the meeting management server 30, and is associated with a plurality of meeting room IDs in the meeting management server 30, as will be described later. The “save” button 665 is a button for storing the communication setting information in the storage unit 99b. The “cancel” button 666 is a button for returning to the meeting rooms list screen 620. When the “save” button 665 is pressed, and the reception terminal 7 receives reservation information of the respective meeting rooms, the reception terminal 7 can display the standby screen 650 of FIG. 40.

The standby screen 650 of FIG. 40 has a similar configuration to that of FIG. 36, except that the two meeting rooms are added to the standby screen 650 of FIG. 40. According to the present embodiment, the reception terminal 7 can additionally register a plurality of meeting rooms, and acquire reservation information of the plurality of meeting rooms.

### <When Administrator Inputs URL on Screen Displayed by Reception Terminal 7 and Stores One or More Meeting Room IDs>

In FIG. 28, an example in which the administrator causes the reception terminal 7 to capture the image code has been mainly described. In the following, an example in which the administrator inputs a URL on a screen displayed by the reception terminal 7, and the reception terminal 7 stores one or more meeting room IDs will be described. This method is effective when the reception terminal 7 does not have a camera.

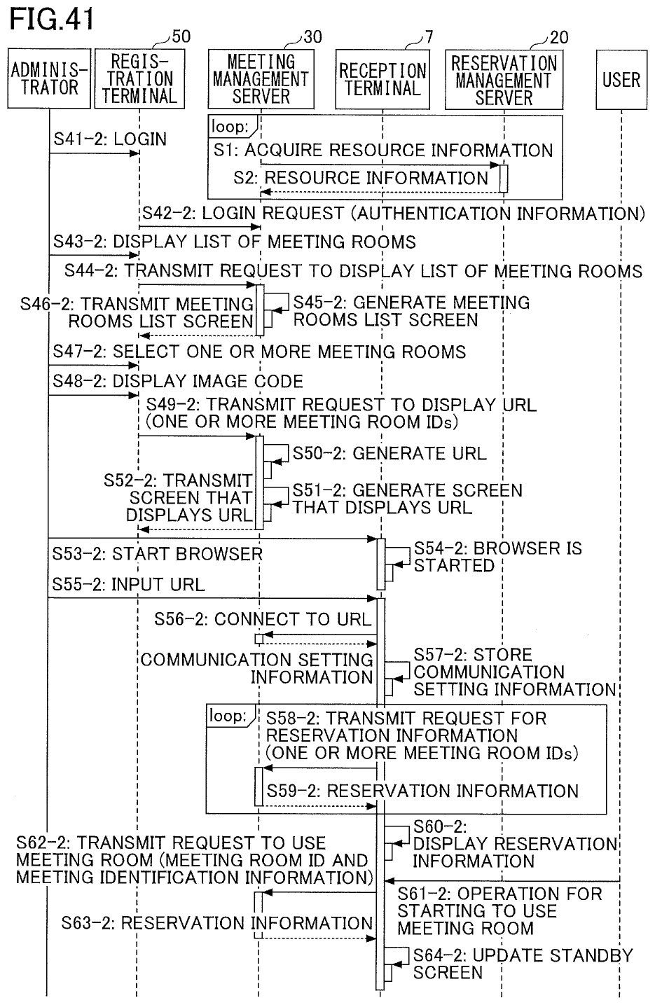

FIG. 41 is a sequence diagram illustrating an example of a process for storing one or more meeting room IDs by the reception terminal 7. In the description of FIG. 28, differences from the process of FIG. 32 will be mainly described.

Steps S1 and S2 are similar to those of FIG. 32. Further, steps S41-2 through S47-2 are similar to steps S41 through S47 of FIG. 32.

In S48-2, after selecting the meeting rooms, the administrator performs an operation to display an image code on the meeting rooms list screen 620 (for example, the administrator presses the “bulk edit” button 622). In this example, it is assumed that a URL is specified.

In S49-2, the operation receiving unit 52 of the registration terminal 50 receives the operation, and the communication unit 51 transmits a request to display a URL to the meeting management server 30 by specifying the one or more meeting room IDs.

In S50-2, the receiving unit 31b of the meeting management server 30 receives the request to display a URL. The URL generating unit 396 temporarily groups the one or more meeting room IDs together, assigns a temporary group ID, and associates the temporary group ID with the one or more meeting room IDs. In addition, the URL generating unit 396 generates a URL, and associates the temporary group ID with the URL or includes the temporary group ID in the URL.

In S51-2, next, the setting screen generating unit 391 generates screen information of the bulk edit screen 660 (FIG. 39) that displays the URL.

In S52-2, the transmitting unit 31a of the meeting management server 30 transmits the screen information of the bulk edit screen 660 to the registration terminal 50. The communication unit 51 of the registration terminal 50 receives the screen information of the bulk edit screen 660, and the display control unit 53 displays the bulk edit screen 660.

In S53-2 and S54-2, the administrator starts the browser of the reception terminal 7. The administrator inputs a terminal name on the startup screen.

In S55-2, next, the administrator operates the reception application to display the URL input screen 610 as illustrated in FIG. 30, and inputs the URL on the URL input screen 610.

In S56-2, the server communication unit 91b of the reception terminal 7 connects to the meeting management server 30 with the URL as a destination, and the meeting management server 30 identifies the temporary group ID based on the URL. The transmitting unit 31a of the meeting management server 30 transmits communication setting information of the one or more meeting room IDs associated with the temporary group ID to the reception terminal 7. The URL generating unit 396 removes the temporary group ID, which is no longer necessary.

In S57-2, the server communication unit 91b of the reception terminal 7 receives the communication setting information. The setting storage unit 98-2b stores the communication setting information in the storage unit 99b, as described in FIG. 37. Subsequent steps are similar to those of FIG. 32.

### <Effects>

As described above, the administrator can acquire reservation information of a plurality of respective meeting rooms by specifying meeting room IDs without grouping the meeting rooms together. Thus, the one reception terminal 7 can receive operations for starting the use of (checking in to) and ending the use of (checking out of) the plurality of meeting rooms.

### Third Embodiment

In the first embodiment and the second embodiment, the administrator K operates the registration terminal 50 to configure the initial settings for the reception terminal 7. In the third embodiment, the administrator K operates the reception terminal 7 instead of the registration terminal 50, and configures the initial settings for the reception terminal 7. That is, the reception terminal 7 is used as a reception terminal after the initial settings. According to the present embodiment, the registration terminal 50 is not necessary.

The hardware configurations of FIG. 5 and FIG. 6 and functional block diagrams of FIG. 7 through FIG. 9 according to the above-described embodiment can be employed in the third embodiment, and differences from the above-described embodiment will be mainly described.

### <Functions>

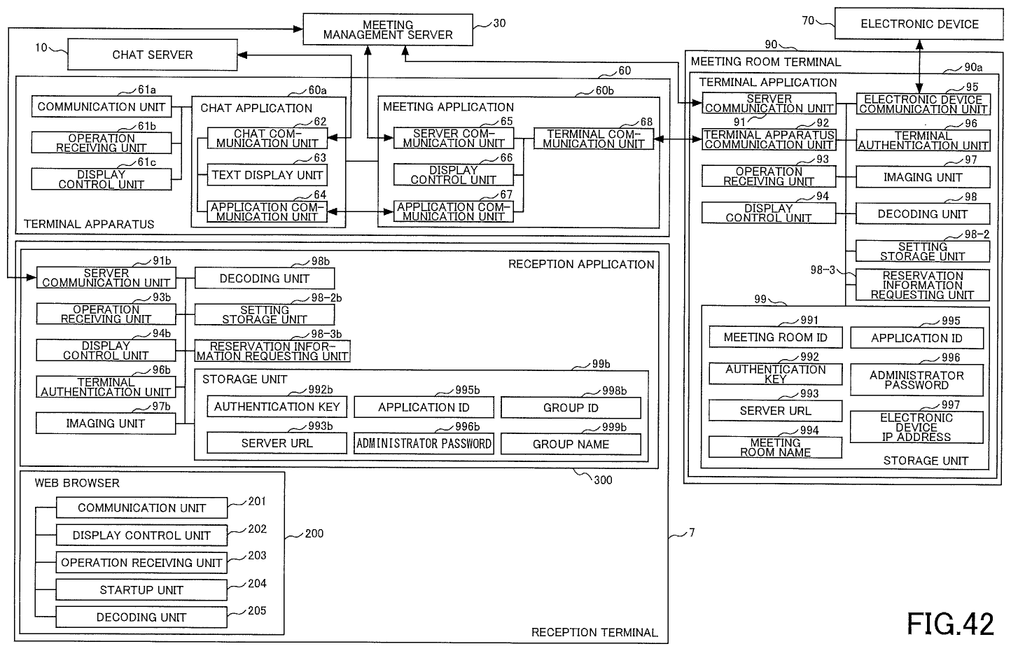

FIG. 42 is a functional block diagram illustrating functions of the terminal apparatus 60, the meeting room terminal 90, and the reception terminal 7. The functions of the electronic device 70 will be described as necessary. The same elements are denoted by the same reference numerals in FIG. 8 and FIG. 42. Thus, only the main elements of the present embodiment may be described.

The reception terminal 7 according to the present embodiment includes a web browser 200, separately from a reception application 300. The web browser 200 is software that displays a web page by analyzing screen information created by HTML, XML, cascade style sheet (CSS), or JavaScript (registered trademark), and executes a program described in JavaScript (registered trademark). An application executed by the web browser 200 is referred to as a web application. The web browser 200 of the reception terminal 7 is used to communicate with the meeting management server 30 instead of the registration terminal 50. Therefore, in FIG. 7, the registration terminal 50 is not necessary.

The web browser 200 includes a communication unit 201, a display control unit 202, an operation receiving unit 203, a startup unit 204, and a decoding unit 205. The communication unit 201 communicates with the meeting management server 30, and transmits and receives information necessary for the initial settings described in the first embodiment to and from the meeting management server 30. The display control unit 202 analyzes screen information of various screens (web pages) transmitted from the meeting management server 30, and displays the screens. The operation receiving unit 203 receives a user's operations and inputs performed on the screens. The startup unit 204 starts the reception application 300, and indicates information necessary for the initial settings. The decoding unit 205 decodes an image code to acquire coded information.

### <Process for Storing Group ID by Reception Terminal>

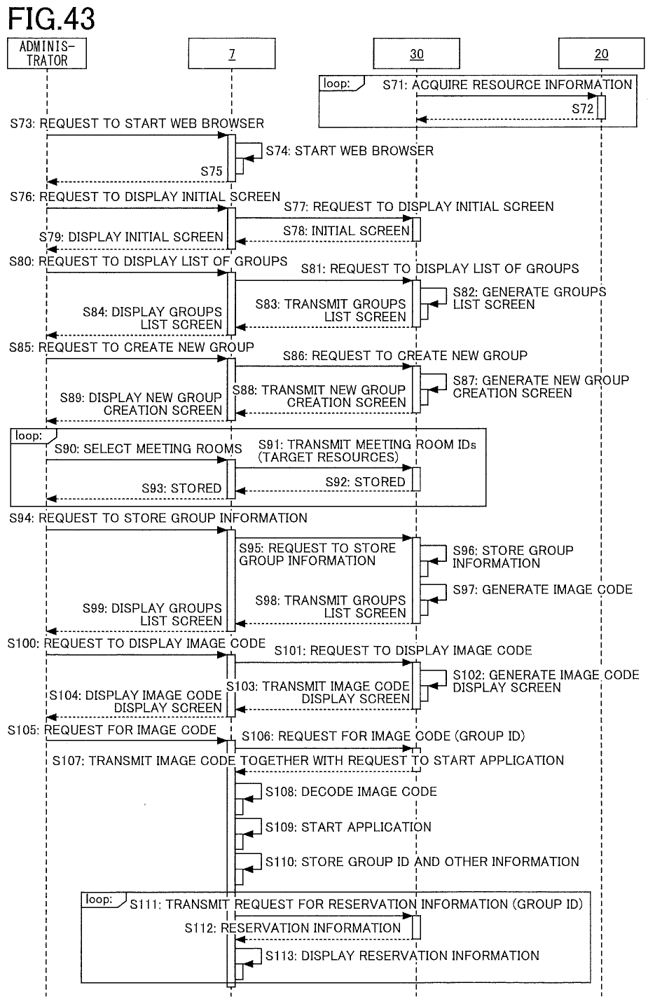

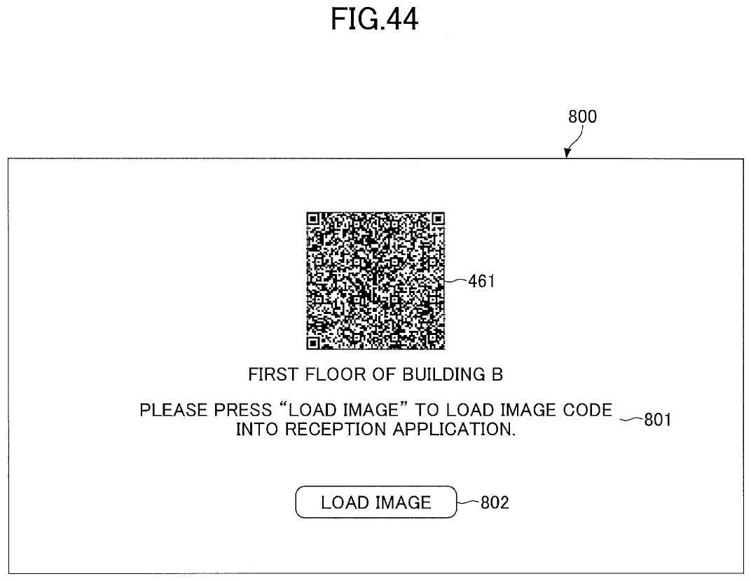

Next, a process for storing a group ID by the reception terminal 7 will be described with reference to FIG. 43 and FIG. 44. In the present embodiment, a group ID can be stored by a method (1) or a method (2). In the method (1), the reception terminal 7 displays a “load image” button, which will be described later, and receives an image code or a URL that specifies the storage location of the image code in response to the “load image” button being pressed. In the method (2), the reception terminal 7 displays a “download” button, which will be described later, and receives a group ID and a group name in response to the “download” button being pressed.

First, the method (1) will be described with reference to FIG. 43. FIG. 43 is a sequence diagram illustrating a process for storing a group ID by the reception terminal V.

Steps S71 and S72 may be similar to steps S1 and S2 of FIG. 10.

In S73 and S74, the administrator who configures the initial settings for the reception terminal 7 starts the web browser 200.

In S75 through S79, when the web browser 200 connects to the meeting management server 30, the display control unit 202 displays a login screen. The administrator performs an operation to log in to the meeting management server 30. An example of the login screen is depicted in FIG. 11. For example, the administrator inputs a user ID and a password as authentication information. The operation receiving unit 203 of the web browser 200 receives the authentication information, and the communication unit 201 transmits a login request to the meeting management server 30 by specifying the authentication information. The authentication unit 40 of the meeting management server 30 authenticates the administrator based on the login password and the user ID stored in the login information DB 499. In this example, the authentication is assumed to be successful. As a result, the display control unit 202 of the web browser 200 displays an initial screen. An example of the initial screen is depicted in FIG. 12.

In S80, next, the administrator performs an operation to display a list of groups on the initial screen. Displaying a list of groups means displaying a list of groups registered in the meeting management server 30.

In S81, the operation receiving unit 203 of the web browser 200 receives the operation, and the communication unit 201 transmits a request to display a list of groups to the meeting management server 30.

In S82, the receiving unit 31b of the meeting management server 30 receives the request to display a list of groups, and the setting screen generating unit 391 refers to the meeting room setting information DB 498 and generates screen information of a groups list screen.

In S83, the transmitting unit 31a of the meeting management server 30 transmits the screen information of the groups list screen to the reception terminal 7.

In S84, the communication unit 201 of the web browser 200 receives the screen information of the groups list screen, and the display control unit 202 displays the groups list screen. FIG. 13 depicts an example of the groups list screen 410.

In S85, the administrator performs an operation to create a new group on the groups list screen 410.

In S86, the operation receiving unit 203 of the web browser 200 receives the operation, and the communication unit 201 transmits a request to create a new group to the meeting management server 30.

In S87, the receiving unit 31b of the meeting management server 30 receives the request to create a new group, and the setting screen generating unit 391 generates screen information of a new group creation screen.

In S88, the transmitting unit 31a of the meeting management server 30 transmits the screen information of the new group creation screen to the reception terminal 7.

In S89, the communication unit 201 of the web browser 200 receives the screen information of the new group creation screen, and the display control unit 202 displays the new group creation screen. An example of the new group creation screen 420 is depicted in FIG. 14.

In S90, the administrator inputs a group name on the new group creation screen 420, and performs an operation to select meeting rooms. As a result, the setting screen generating unit 391 refers to the meeting room setting information DB 498 and generates screen information of a meeting rooms list screen, and the display control unit 202 of the web browser 200 displays the meeting rooms list screen. An example of the meeting rooms list screen 430 is depicted in FIG. 15. The administrator inputs an operation to select meeting rooms to be grouped on the meeting rooms list screen 430. That is, a plurality of meeting rooms

In S91, the operation receiving unit 203 of the web browser 200 receives the operation, and the communication unit 201 transmits meeting room IDs (target resources) to the meeting management server 30. The receiving unit 31b of the meeting management server 30 receives the meeting room IDs, and the information management unit 395 stores the meeting room IDs.

In S92, the transmitting unit 31a of the meeting management server 30 transmits a message indicating that the meeting room IDs are stored, to the reception terminal 7.

In S93, the communication unit 201 of the web browser 200 receives the message indicated that the meeting room IDs are stored, and the display control unit 202 displays the message indicated that the meeting room IDs are stored. Steps S90 through S93 may be repeated for each meeting room. Alternatively, the administrator may select a plurality of meeting rooms at once. The reception terminal 7 transmits the group name to the meeting management server 30 during steps S90 through S93.

In S94, when the selection of the meeting rooms to be grouped is completed, the administrator presses the Complete button on the meeting rooms list screen 430. As a result, the display control unit 202 of the web browser 200 displays a group registration confirmation screen. FIG. 16 depicts an example of the group registration confirmation screen 440. The administrator checks the meeting rooms to be grouped on the group registration confirmation screen 440, and performs an operation to store group information.

In S95, the operation receiving unit 203 of the web browser 200 receives the operation, and the communication unit 201 transmits a request to store group information including the group name to the meeting management server 30. Note that the group name may be transmitted to the meeting management server 30 after the group name is input.

In S96, the receiving unit 31b of the meeting management server 30 receives the request to store group information including the group name, and the information management unit 395 stores group information. That is, the information management unit 395 assigns a group ID, associates the group ID and the group name with the meeting room IDs transmitted in step S95, and stores the group ID and the group name associated with the meeting room IDs in the meeting room setting information DB 498 as group information. The group information includes the group name, the group ID, and the meeting room IDs. If the administrator selects a meeting room for which an authentication key is not set in the meeting room setting information DB 498, an authentication key is generated.

In S97, the image code generating unit 394 generates an image code including the group ID and the group name. The image code generating unit 394 associates the image code with the group ID. Although not illustrated in FIG. 43, the image code includes authentication keys for the respective meeting rooms and includes one server URL. Alternatively, a common authentication key may be used by the meeting rooms. If the server URL is registered in the reception application, the image code is not required to include the server URL.

In S98, the transmitting unit 31a of the meeting management server 30 indicates the completion of storing the group information to the reception terminal 7. In addition, the setting screen generating unit 391 refers to the meeting room setting information DB 498 and generates screen information of a groups list screen, and the transmitting unit 31a transmits the screen information of the groups list screen to the reception terminal 7.

In S99, the communication unit 201 of the web browser 200 receives the completion of storing the group information and the screen information of the groups list screen. The display control unit 202 displays the groups list screen received from the meeting management server 30. An example of the groups list screen 450 is depicted in FIG. 17.

In S100, the administrator performs an operation to display the image code by specifying the group on the groups list screen 450. Note that the “image code/URL” button 414c on the groups list screen 450 may allow the administrator to press either “image code” or “URL”, or may allow the administrator to press both “image code” and “URL” together. In this example, it is assumed that “image code” and “URL” are pressed together, or only “image code” is pressed.

In S101, the operation receiving unit 203 of the web browser 200 receives the operation, and the communication unit 201 transmits a request to display the image code to the meeting management server 30 by specifying the group ID.

In S102, the receiving unit 31b of the meeting management server 30 receives the request to display the image code. The setting screen generating unit 391 generates screen information of an image code display screen. The image code display screen displays the image code associated with the group ID, and also displays a “load image” button for loading the image code. Note that the image code may be generated by the image code generating unit 394 at this timing. In this case, if the group name or the meeting rooms are changed, the image code can be created by using the changed group name or the changed meeting rooms. The “load image” button includes a URL that specifies the storage location of the image code.

In S103, the transmitting unit 31a of the meeting management server 30 transmits the screen information of the image code display screen (including the group ID specified by the administrator) to the reception terminal 7.

In S104, the communication unit 201 of the web browser 200 receives the screen information of the image code display screen, and the display control unit 202 displays the image code display screen. FIG. 44 is a diagram illustrating an example of an image code display screen 800.

In S105, the administrator presses the “load image” button on the image code display screen 800. The operation receiving unit 203 of the web browser 200 receives the administrator's operation.

In S106, the communication unit 201 of the web browser 200 transmits a request for the image code to the meeting management server 30 by specifying the group ID.

In S107, the receiving unit 31b of the meeting management server 30 receives the request for the image code. The transmitting unit 31a transmits the image code associated with the group ID or the URL that specifies the storage location of the image code to the reception terminal 7, together with a request to start the reception application 300.

In S108, the communication unit 201 of the web browser 200 receives the image code or the URL that specifies the storage location of the image code. If the web browser 200 receives the URL that specifies the storage location of the image code, the communication unit 201 of the web browser 200 connects to the URL that specifies the storage location of the image code, and acquires the image code. If the reception application 300 receives the image code, the image code is acquired without any further action. The decoding unit 205 decodes the image code and acquires the group ID and the group name (the authentication keys and the server URL may be included). Note that the reception application 300 may decode the image code.

In S109, in response to the request to start the reception application 300 from the meeting management server 30, or in response to the “load image” button being pressed, the startup unit 204 of the web browser 200 starts the reception application 300. A method provided by the OS of the reception terminal 7 is used to start the reception application 300 and transmit the information to the reception application 300. Therefore, starting the reception application 300, transmitting the image code, and storing the group ID may be performed in an order different from the order described herein.

Examples of a method for starting the reception application 300 include a custom (Uniform Resource Identifier) URI scheme provided by the OS. The custom URI scheme is URI scheme that is customized. The URI scheme is an initial part of a URI (or a Uniform Resource Locator (URL)) that represents a location of a resource on the Internet, and is a notation representing a means for reaching the resource. Typically, reserved words such as http, file, or mailto is specified as the URI. Conversely, the custom URI schemes can represent the resource with an arbitrary URI.

subapp://filepath?id=/foo/bar/001/groupeid.txt

The initial part “subapp” specifies the reception application, “id=/foo/bar/001/groupeid.txt” following “filepath” specifies that information transmitted to the reception application is included in a variable “filepath” and that a value of the variable is the “/foo/bar/001/groupeid.txt”. Further, “groupeid.txt” specifies the group ID. Other information such as the group name, the authentication keys, and the server URL are transmitted in the same way.

A procedure in which the web browser 200 uses the custom URI scheme to start the reception application 300 and indicate the file path to the reception application 300 is as follows.

(1) The web browser 200 indicates the custom URI scheme to the OS.
(2) The OS searches an application, specified by “subapp” in the custom URI scheme, from application manifests (from a list of applications registered in the OS), and identifies the reception application 300.
(3) In response to identifying the reception application 300, the OS starts the reception application 300 by executing an executable file of the reception application 300.
(4) The reception application 300 performs a process for acquiring the custom URI scheme from the OS at startup.
(5) The reception application 300 continues to acquire the file path (a subsequent portion including “id”) in the custom URI scheme.

In S110, the reception application 300 receives the group ID, the group name, the authentication keys, and the server URL from the OS, and the setting storage unit 98-2b stores the group ID, the group name, the authentication keys, and the server URL in the storage unit 99b. Accordingly, the reception terminal 7 can acquire reservation information by identifying the group ID. Note that if another group ID is already stored, the other group ID may be overwritten. In this manner, the administrator can newly install the reception terminal 7. Further, if a meeting room ID is already stored, the meeting room ID may be overwritten. In this manner, the meeting room terminal 90 can be used as a reception terminal. The reception terminal 7 may display a dialog asking a user to overwrite with the group ID, and determine whether to overwrite with the group ID in accordance with the user's response. If a plurality of group IDs are stored, reservation information is acquired on a per group ID basis.

In S111, when the group ID is stored, the reservation information requesting unit 98-3b of the reception terminal 7 transmits a request for reservation information by specifying the group ID and the authentication keys, to the meeting management server 30 specified by the server URL. Thereafter, the reservation information requesting unit 98-3b repeatedly requests the reservation information.

In S112, when the receiving unit 31b of the meeting management server 30 receives the request for reservation information, the authentication key verifying unit 41 verifies the authentication keys. That is, the authentication key verifying unit 41 acquires authentication keys identified by the meeting room IDs from the meeting room setting information DB 498, and determines whether the authentication keys acquired from the meeting room setting information DB 498 match the authentication keys transmitted from the reception terminal 7. When it is determined that the authentication keys acquired from the meeting room setting information DB 498 match the authentication keys transmitted from the reception terminal 7, the initial setting unit 39 changes the connection states to “connected” in the meeting room setting information DB 498. Next, when the management start flags are set to “true”, the reservation information transmitting unit 44 acquires the meeting room IDs associated with the group ID from the meeting room setting information DB 498, and acquires reservation information associated with the meeting room IDs from the meeting management information DB 493. The transmitting unit 31a of the meeting management server 30 transmits the reservation information to the reception terminal 7.

In S113, the server communication unit 91b of the reception application 300 receives the reservation information, and the display control unit 94b displays the reservation information on a standby screen. An example of the standby screen 490 is depicted in FIG. 21.

As described above, in the present embodiment, instead of the registration terminal 50, the reception terminal 7 can acquire the image code, store the group ID, and acquire the reservation information by specifying the group ID.

### <<Example Screen>>

FIG. 44 depicts an example of the image code display screen 800 displayed by the web browser 200. In FIG. 44, differences from the image code display screen of FIG. 18 will be mainly described. The image code display screen 800 of FIG. 44 includes a message 801 “please press the Load Image button to load the image code into the terminal application”, and a “load image” button 802 for loading the image code. In response to the “load image” button 802 being pressed, the reception terminal 7 acquires the image code or the URL that specifies the storage location of the image code, and the reception application 300 is started. Note that the image code 461 may be pressed, instead of the “load image” button 802.

The image code 461 is not necessarily provided. However, if the registration terminal 50 displays the image code display screen 800 as illustrated in FIG. 44, the administrator can use the image code to configure the initial settings as described in the first embodiment. if the reception terminal 7 displays the image code display screen 800, the administrator can use the image code to configure the initial settings without the registration terminal 50.

### <When Download Button is Displayed by Reception Terminal>

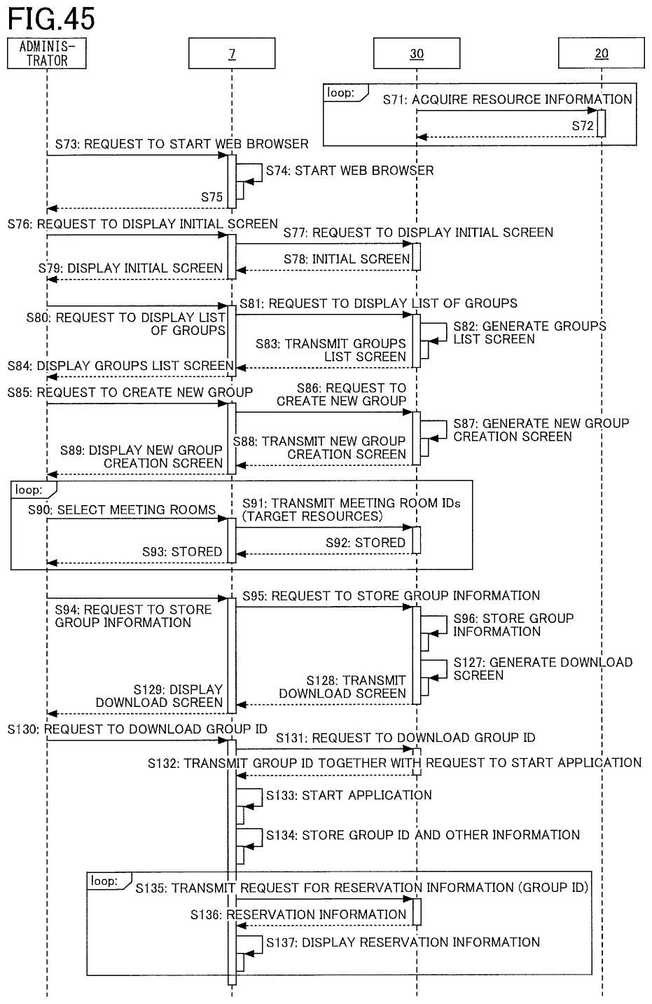

Next, the method (2) will be described with reference to FIG. 45. FIG. 45 is a sequence diagram illustrating a process for storing a group ID by the reception terminal 7. In the description of FIG. 45, differences from FIG. 43 will be mainly described. Steps S71 through S96 of FIG. 45 may be similar to those of FIG. 43.

In S127, the image code generating unit 394 generates screen information of a download screen that allows a group ID to be downloaded for each group. For example, group IDs are associated with respective group names.

In S128, the transmitting unit 31a of the meeting management server 30 transmits the screen information of the download screen to the reception terminal 7.

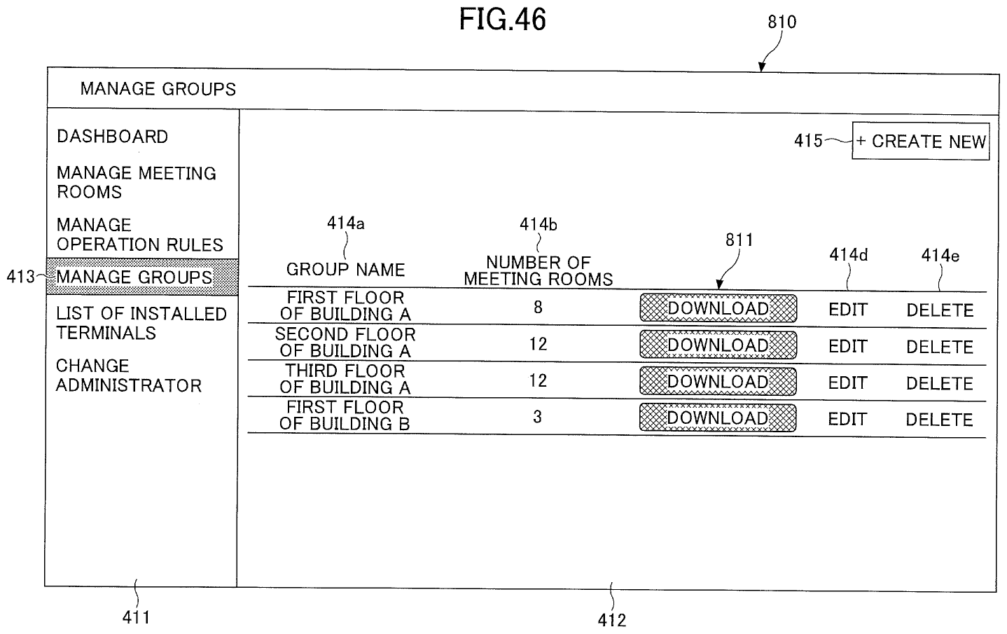

In S129, the communication unit 201 of the web browser 200 receives the screen information of the download screen, and the display control unit 202 displays the download screen. FIG. 46 illustrates an example of the download screen.

In S130, the administrator presses a “download” button for a group on the download screen to download a group ID of the group.

In S131, the operation receiving unit 203 of the web browser 200 receives the administrator's operation, and the communication unit 201 transmits a request to download the group ID, to the meeting management server 30.

In S132, the receiving unit 31b of the meeting management server 30 receives the download request. The information management unit 395 acquires authentication keys and a group name associated with the group ID from the meeting room setting information DB 498 (and also acquires a server URL stored in the login information DB 499). The transmitting unit 31a of the meeting management server 30 transmits the group ID, the group name, the authentication keys, and the server URL to the reception terminal 7, together with a request to start the reception application 300.

In S133, the communication unit 201 of the web browser 200 receives the group ID, the group name, the authentication keys, and the server URL, together with the request to start the reception application 300. The startup unit 204 of the web browser 200 starts the reception application 300 in response to receiving the request or in response to the “download” button being pressed. The reception application 300 may be started in a similar way to the custom URI scheme described with reference to FIG. 43. As a result, the reception application 300 receives the group ID, the group name, the authentication keys, and the server URL from the web browser 200.

In S134, the setting storage unit 98-2b of the reception application 300 stores the group ID, the group name, the authentication keys, and the server URL in the storage unit 99b. Accordingly, the reception terminal 7 can acquire reservation information by specifying the group ID.

Steps S135 through S137 may be similar to steps S111 through S113 of FIG. 42.

As described above, in the present embodiment, instead of the registration terminal 50, the reception terminal 7 can acquire the group ID, store the group ID, and acquire the reservation information by specifying the group ID.

### <<Example Screen>>

FIG. 46 is a diagram illustrating an example of a download screen 810 displayed by the web browser 200. In FIG. 46, differences from the groups list screen 410 of FIG. 13 will be mainly described. The download screen 810 of FIG. 46 includes a “download” button 811 associated with a group name. By pressing the “download” button 811, the reception terminal 7 can acquire a group ID and other information from the meeting management server 30.

### <Effects>

In the resource reservation system 100 according to the present embodiment, the web browser 200 of the reception terminal 7 communicates with the meeting management server 30, and starts the reception application 300. Thus, the registration terminal 50 is not necessary. The user and the administrator can use the reception terminal 7 alone to perform a series of settings, including selecting meeting rooms to be grouped and configuring settings for the reception terminal 7 itself, while looking at the meeting rooms at a location near the meeting rooms such as a meeting room area located away from the registration terminal 50.

### Fourth Embodiment

In the third embodiment, the reception terminal 7 includes the web browser 200 separately from the reception application, and the reception application displays reservation information. In the fourth embodiment, the web browser 200 is used to configure the initial settings for the reception terminal 7, and the web browser 200 displays reservation information. According to the present embodiment, the registration terminal 50 is not necessary.

The hardware configurations of FIG. 5 and FIG. 6 and functional block diagrams of FIG. 7 through FIG. 9 according to the above-described embodiment can be employed in the fourth embodiment, and differences from the above-described embodiment will be mainly described.

### <Functions>

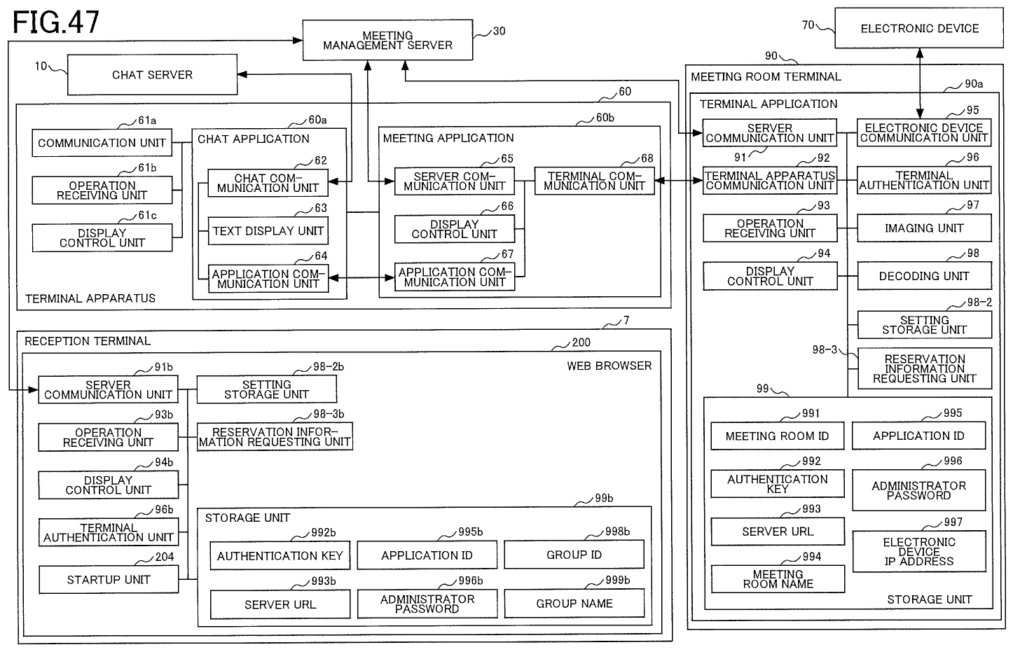

FIG. 47 is a functional block diagram illustrating functions of the terminal apparatus 60, the meeting room terminal 90, and the reception terminal 7. The functions of the electronic device 70 will be described as necessary. The same elements are denoted by the same reference numerals in FIG. 8 and FIG. 47. Thus, only the main elements of the present embodiment may be described.

The reception terminal 7 according to the present embodiment includes the web browser 200, instead of the reception application. Further, the reception terminal 7 according to the present embodiment does not decode an image code. Thus, the decoding unit 98b and the imaging unit 97b are not included. Instead of the registration terminal 50, the web browser 200 of the reception terminal 7 communicates with the meeting management server 30 and displays reservation information.

### <Process for Storing Group ID by Reception Terminal>

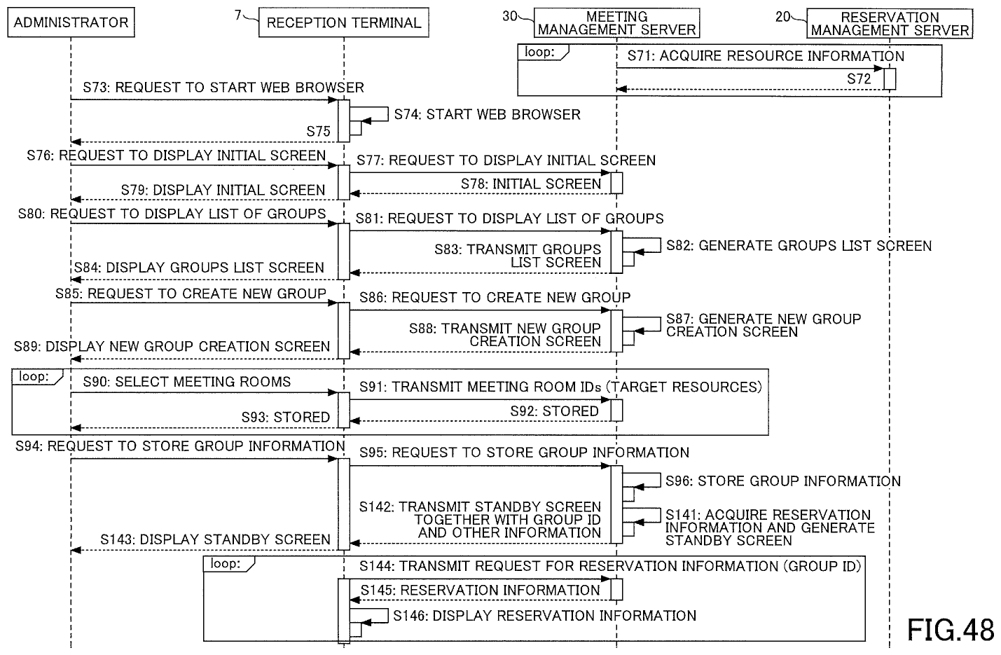

Next, a process for storing a group ID and displaying reservation information by the reception terminal 7 will be described with reference to FIG. 48. FIG. 48 is a sequence diagram illustrating a process for storing a group ID and displaying reservation information by the reception terminal 7. In the description of FIG. 48, differences from FIG. 43 will be mainly described. Steps S71 through S96 of FIG. 48 may be similar to those of FIG. 43.

In S141, the reservation information transmitting unit 44 of the meeting management server 30 acquires reservation information of respective meeting rooms identified by the group ID, from the meeting management information DB 493. Further, the reservation information transmitting unit 44 generates screen information of a standby screen such that the reservation information is displayed as in the case of the standby screen 490 of FIG. 21. In the first embodiment through the third embodiment, the reception application designs and displays the standby screen. However, in the present embodiment, the web browser 200 displays the standby screen. Therefore, the reservation information transmitting unit 44 uses HTML to generate the screen information of the standby screen for displaying the reservation information.

In S142, the transmitting unit 31a of the meeting management server 30 transmits the screen information of the standby screen, together with the group ID, the group name, the authentication keys, and the server URL acquired from the meeting room setting information DB 498 and the login information DB 499, to the reception terminal 7.

In S143, the server communication unit 91b of the web browser 200 receives the screen information of the standby screen, the group ID, and other information. The display control unit 94b displays the standby screen. An example of the standby screen is depicted in FIG. 21. Instead of directly transmitting the screen information of the standby screen, the meeting management server 30 may transmit a URL for displaying the standby screen to the reception terminal 7. In this case, the reception terminal 7 can redirect to the URL to display the standby screen. Alternatively, the standby screen can be displayed on the current page or on a new page by the administrator performing an operation on the web browser 200. If the standby screen is displayed on a new page, the meeting rooms list screen 430 remains displayed by the reception terminal 7. Thus, the reception terminal 7 may delete the current page.

Further, the reception terminal 7 may operate in kiosk mode in order to prevent the user from changing the standby screen to another screen or turning off the screen or the power. The kiosk mode refers to an operation mode in which an information processing terminal operates for a particular purpose.

Further, the setting storage unit 98-2b of the reception terminal 7 stores the group ID, the group name, the authentication keys, and the server URL in the storage unit 99b. The storage unit 99b may be a local storage that is accessible by the web browser 200. Accordingly, the reception terminal 7 can acquire reservation information by specifying the group ID. If a group ID is already stored, the group ID may be overwritten. In this manner, the administrator can newly install the reception terminal 7. In addition, if a meeting room ID is overwritten, the meeting room ID may be overwritten. In this manner, the meeting room terminal 90 can be used as a reception terminal. The reception terminal 7 may display a dialog asking a user to overwrite with the group ID, and determine whether to overwrite with the group ID in accordance with the user's response. If a plurality of group IDs are stored, reservation information is acquired on a per group ID basis.

Steps S144 through S146 may be similar to steps S111 through S113.

### <Effects>

As described above, in the present embodiment, the web browser 200 of the reception terminal 7 can receive and display reservation information.

### <Other Applications>

Although the embodiments have been specifically described above, the present invention is not limited to the above-described embodiments. Variations and modifications may be made to the described subject matter without departing from the scope of the invention as set forth in the accompanying claims.

For example, instead of the registration terminal 50 displaying an image code, a display connected to the meeting management server 30 may display an image code. That is, a terminal that displays an image code is not necessarily the registration terminal 50. Further, an image code may be transmitted to the administrator via email.

For example, in the above-described embodiments, a group ID or communication setting information is encoded into an image code. However, a group ID or communication setting information may be transmitted from the registration terminal 50 to the meeting room terminal 90 via one-to-one near-field communication. For example, a group ID or communication setting information may be transmitted via Bluetooth (registered trademark), near-field communication (NFC), infrared communication, or visible light communication.

There may be a plurality of meeting management servers 30. Alternatively, the functions of the meeting management server 30 may be divided and allocated to a plurality of servers. Further, the reservation management server 20 and the meeting management server 30 may be integrated.

Further, a group of apparatuses described in the embodiments is merely one group of apparatuses in a plurality of computing environments. In a specific embodiment, the meeting management server 30 includes a plurality of computing devices such as server clusters. The plurality of computing devices are configured to communicate with each other via a commutation link such as a network or a shared memory, and perform the processes described herein. Similarly, the reception terminal 7 may include a plurality of computing devices configured to communicate with each other.

The resource reservation system 100 according to the above-described embodiments may also be referred to as a web service. The web service includes a variety of services provided by applying an Internet-related technology. Examples of the web service include a meeting room rental service and other rental services. A system that uses the web service is referred to as a utilization system.

In addition, the functional configuration of the resource reservation system 100 are divided into the functional blocks as illustrated in FIG. 7 through FIG. 9 based on the main functions, in order to facilitate the understanding of processes performed by the resource reservation system 100. However, the present invention is not limited by how processing units are divided or by the names of processing units. The resource reservation system 100 may be divided into more processing units according to the process. Further, one processing unit can be divided to include a larger number of processes.

Each of the functions of the above-described embodiments may be implemented by one or more processing circuits or circuitry. As used herein, the “processing circuit” includes a processor programmed to perform each function by software, such as a processor implemented in electronic circuits, an application specific integrated circuit (ASIC) designed to perform each function as described above, a digital signal processor (DSP), a field programmable gate array (FPGA), or a conventional circuit module.

What is claimed is:

1. A resource reservation system comprising:
an information processing apparatus configured to retain reservation information of resources; and
an information processing terminal, the information processing terminal including a memory and a processor coupled to the memory and configured to
receive reservation information of one or more resources among the resources from the information processing apparatus,
display the reservation information of the one or more resources, and
receive an operation for each of the one or more resources.

2. The resource reservation system according to claim 1, wherein the information processing apparatus associates the one or more resources with group identification information, and transmits the reservation information of the one or more resources associated with the group identification information to the information processing terminal in response to receiving a request for the reservation information of the one or more resources by specifying the group identification information from the information processing terminal.

3. The resource reservation system according to claim 2, further comprising a registration terminal,
wherein the information processing apparatus provides a resources list to the registration terminal,
the registration terminal receives a selection of one or more resources, and transmits identification information of the one or more resources to the information processing apparatus, and
the information processing apparatus receives the identification information of the one or more resources from the registration terminal, and associates the one or more resources with the group identification information.

4. The resource reservation system according to claim 3, wherein the registration terminal receives an input of a group name, and transmits the group name to the information processing apparatus, and
the information processing apparatus receives the group name from the registration terminal, and associates the group name with the group identification information.

5. The resource reservation system according to claim 4, wherein the information processing apparatus transmits an image code that includes the group identification information to the registration terminal,
the registration terminal displays the image code, and
the information processing terminal captures the image code, and stores the group identification information included in the image code.

6. The resource reservation system according to claim 5, wherein the image code includes the group name, and
the information processing terminal captures the image code, and displays the group name included in the image code.

7. The resource reservation system according to claim 4, wherein the information processing apparatus transmits a URL associated with the group identification information to the registration terminal,
the registration terminal displays the URL, and
the information processing terminal connects to the URL in response to receiving an input of the URL, receives the group identification information associated with the URL from the information processing apparatus, and stores the group identification information.

8. The resource reservation system according to claim 7, wherein the information processing terminal connects to the URL in response to receiving the input of the URL, receives the group name from the information processing apparatus, and stores the group name.

9. The resource reservation system according to claim 1, wherein the information processing terminal stores identification information of the one or more resources, and
the information processing apparatus transmits the reservation information of the one or more resources to the information processing terminal in response to receiving a request for the reservation information of the one or more resources by specifying the identification information of the one or more resources from the information processing terminal.

10. The resource reservation system according to claim 9, wherein the information processing apparatus provides a resources list to the registration terminal,
the registration terminal receives a selection of one or more resources, and transmits identification information of the one or more resources to the information processing apparatus,
the information processing apparatus receives the identification information of the one or more resources from the registration terminal, and transmits an image code that includes the identification information of the one or more resources to the registration terminal,
the registration terminal displays the image code, and
the information processing terminal captures the image code, and stores the identification information of the one or more resources included in the image code.

11. The resource reservation system according to claim 9, wherein the information processing apparatus provides a resources list to the registration terminal,
the registration terminal receives a selection of one or more resources, and transmits identification information of the one or more resources to the information processing apparatus,
the information processing apparatus receives the identification information of the one or more resources from the registration terminal, associates the identification information of the one or more resources with a URL, and transmits the URL to the registration terminal,
the registration terminal displays the URL, and
the information processing terminal connects to the URL in response to receiving an input of the URL, and stores the identification information of the one or more resources associated with the URL.

12. The resource reservation system according to claim 10, wherein, in a case where the information processing terminal acquires identification information of a resource among the resources from the information processing apparatus,
the information processing terminal determines whether to store the identification information of the resource in addition to already stored identification information of another resource or overwrites the already stored identification information of the another resource with the identification information of the resource, in accordance with a type of the information processing terminal.

13. The resource reservation system according to claim 2, further comprising a web browser installed on the information processing terminal,
wherein the information processing apparatus provides a resources list to the information processing terminal,
the web browser of the information processing terminal receives a selection of one or more resources, and transmits identification information of the one or more resources to the information processing apparatus,
the information processing apparatus receives the identification information of the one or more resources from the web browser of the information processing terminal, associates the one or more resources with the group identification information, and transmits an image code that includes the group identification information to the information processing terminal,
the web browser of the information processing terminal acquires the group identification information by analyzing the image code and transmits the group identification information to an application that is operated on the information processing terminal, or
the web browser of the information processing terminal transmits the image code to the application, and the application acquires the group identification information by analyzing the image code, and
the application stores the group identification information.

14. The resource reservation system according to claim 2, further comprising a web browser installed on the information processing terminal,
wherein the information processing apparatus provides a resources list to the information processing terminal,
the web browser of the information processing terminal receives a selection of one or more resources, and transmits identification information of the one or more resources to the information processing apparatus,
the information processing apparatus receives the identification information of the one or more resources from the web browser of the information processing terminal, associates the one or more resources with the group identification information, and transmits the group identification information to the information processing terminal,
the web browser of the information processing terminal transmits the group identification information to an application that is operated on the information processing terminal, and
the application stores the group identification information.

15. The resource reservation system according to claim 2, further comprising a web browser installed on the information processing terminal,
wherein the information processing apparatus provides a resources list to the information processing terminal,
the web browser of the information processing terminal receives a selection of one or more resources, and transmits identification information of the one or more resources to the information processing apparatus,
the information processing apparatus receives the identification information of the one or more resources from the web browser of the information processing terminal, associates the one or more resources with the group identification information, and transmits the group identification information to the information processing terminal, and
the web browser of the information processing terminal stores the group identification information.

16. The resource reservation system according to claim 1, wherein the processor of the information processing terminal is further configured to display a status related to use of each of the one or more resources received from the information processing apparatus.

17. The resource reservation system according to claim 16, wherein, in a case where the processor of the information processing terminal receives an operation for a reserved resource while a status indicating that the reserved resource is available is displayed, the processor of the information processing terminal displays a screen for inputting authentication information, indicates that the operation is received for the reserved resource to the information processing apparatus, receives a status indicating that the reserved resource is in use from the information processing apparatus, and updates the status indicating that the reserved resource is available to the status indicating that the reserved resource is in use.

18. The resource reservation system according to claim 16, wherein, in a case where the processor of the information processing terminal receives an operation for an unreserved resource while a status indicating that the unreserved resource is vacant is displayed,
the processor of the information processing terminal indicates that the operation is received for the unreserved resource to the information processing apparatus,
the information processing apparatus makes a reservation for the unreserved resource, and
the processor of the information processing terminal receives completion of the reservation from the information processing apparatus, together with a status indicating that the unreserved resource is in use, and updates the status indicating that the unreserved resource is vacant to the status indicating that the unreserved resource is in use.

19. The resource reservation system according to claim 16, wherein the processor of the information processing terminal displays a confirmation screen in a case where the processor of the information processing terminal receives an operation for ending use of a resource while a status indicating that the resource is in use is displayed.

20. An information display method performed by a resource reservation system including an information processing apparatus configured to retain reservation information of resources, and an information processing terminal, the method comprising:
receiving, by the information processing terminal, reservation information of one or more resources among the resources from the information processing apparatus,
displaying, by the information processing terminal, the reservation information of the one or more resources, and
receiving, by the information processing terminal, an operation for each of the one or more resources.
